(19) United States
(12) Patent Application Publication
(10) Pub. No.: US 2023/0142149 A1
(43) Pub. Date: May 11, 2023

(54) COMMUNICATION DEVICE, COMMUNICATION METHOD, AND COMMUNICATION PROGRAM

(71) Applicant: Sony Group Corporation, Tokyo (JP)

(72) Inventors: Ren SUGAI, Tokyo (JP); Naoki KUSASHIMA, Tokyo (JP); Hiroshi HARADA, Kyoto (JP); Keiichi MIZUTANI, Kyoto (JP); Kyoya TERAMAE, Kyoto (JP)

(73) Assignee: Sony Group Corporation, Tokyo (JP)

(21) Appl. No.: 17/912,860

(22) PCT Filed: Mar. 17, 2021
(86) PCT No.: PCT/JP2021/010749

§ 371 Date: Sep. 20, 2022

(30) Foreign Application Priority Data
Mar. 27, 2020 (JP) 2020-058855

(51) Int. Cl. H04W 52/24; H04W 28/18

(52) U.S. Cl. CPC H04W 52/243; H04W 28/18

(57) ABSTRACT

A communication device includes a transmission unit and a notification unit. The transmission unit transmits a second signal (for example, an URLLC signal) that requires low latency severer than a first signal (for example, an eMBB signal). When the transmission unit transmits the second signal (for example, the URLLC signal), the notification unit notifies another communication device (interfering station) that transmits the first signal (for example, the eMBB signal) of a request signal containing information requesting suppression of transmission power of the first signal (for example, the eMBB signal). As a result, it is possible to satisfy a requirement of a communication mode requiring low latency.

### FIELD

The present disclosure relates to a communication device, a communication method, and a communication program.

### BACKGROUND

In recent years, there has been a growing consensus in 5G that one radio system will support not only a communication mode of enhanced mobile broadband (eMBB) in data communication using existing smartphones but also communication modes such as ultra-reliable and low-latency communication (URLLC), which requires high reliability and low latency in cases such as emergency message transmission used in autonomous driving, for example.

In addition, with a rapid increase in mobile data traffic in recent years, there have been active studies to promote innovative technologies for improving frequency utilization efficiency. The technologies include full-duplex communication.

### CITATION LIST

### Patent Literature

Patent Literature 1: WO 2019/142512 A

### SUMMARY

### Technical Problem

In a radio system, however, in a case of occurrence of a URLLC transmission request requiring low latency during eMBB reception, the URLLC transmission needs to wait until completion of the eMBB reception. This leads to failure to satisfy the quality of service (QoS) of URLLC.

In view of this, the present disclosure proposes a communication device, a communication method, and the like capable of satisfying a requirement of a communication mode that requires low latency.

### Solution to Problem

To solve the problems described above, a communication device according to an embodiment of the present disclosure includes: a transmission unit that transmits a second signal requiring low latency severer than a first signal; and a notification unit that notifies another communication device that transmits the first signal of a request signal containing information requesting suppression of transmission power of the first signal, the notification being made when the transmission unit transmits the second signal.

### BRIEF DESCRIPTION OF DRAWINGS

FIG. 1 is a diagram illustrating an overview of in-band full-duplex communication.

FIG. 2 is a diagram illustrating an example of a communication method of eMBB and URLLC using TDD.

FIG. 3 is a diagram illustrating an example of signal interference in an access uplink and an access downlink.

FIG. 4 is a diagram illustrating a configuration example of a communication system according to an embodiment of the present disclosure.

FIG. 5 is a diagram illustrating a configuration example of a management device according to the embodiment of the present disclosure.

FIG. 6 is a diagram illustrating a configuration example of a base station device according to the embodiment of the present disclosure.

FIG. 7 is a diagram illustrating a configuration example of a relay device according to the embodiment of the present disclosure.

FIG. 8 is a diagram illustrating a configuration example of a terminal device according to the embodiment of the present disclosure.

FIG. 9 is a diagram illustrating a configuration example of an assumed system 1A according to an embodiment of the present disclosure.

FIG. 10 is a diagram illustrating a configuration example of an assumed system 1B according to the embodiment of the present disclosure.

FIG. 11 is a diagram illustrating a configuration example of an assumed system 1C according to the embodiment of the present disclosure.

FIG. 12 is a diagram illustrating a configuration example of an assumed system 1D according to the embodiment of the present disclosure.

FIG. 13 is a diagram illustrating a configuration example of an assumed system 1E according to the embodiment of the present disclosure.

FIG. 14 is a diagram illustrating a configuration example of an assumed system 1F according to the embodiment of the present disclosure.

FIG. 15 is a diagram illustrating a configuration example of an assumed system 1G according to the embodiment of the present disclosure.

FIG. 16 is a diagram illustrating a configuration example of an assumed system 1H according to the embodiment of the present disclosure.

FIG. 17 is a diagram illustrating a configuration example of an assumed system 1J according to an embodiment of the present disclosure.

FIG. 18 is a diagram illustrating a configuration example of an assumed system 1K according to the embodiment of the present disclosure.

FIG. 19 is a diagram illustrating a configuration example of an assumed system 1L according to the embodiment of the present disclosure.

FIG. 20 is a diagram illustrating a configuration example of an assumed system 1M according to the embodiment of the present disclosure.

FIG. 21A is a diagram illustrating an example of a correspondence table of data types and 5G QoS requirement values.

FIG. 21B is a diagram illustrating an example of a correspondence table of data types and 5G QoS requirement values.

FIG. 21C is a diagram illustrating an example of a correspondence table of data types and 5G QoS requirement values.

FIG. 22A is a diagram illustrating an example of a communication sequence at the execution of full-duplex communication.

FIG. 22B is a diagram illustrating an example of a communication sequence at the setting of non-full-duplex communication.

FIG. 23 is a diagram illustrating an example of an in-band full-duplex communication executability determination processing flow.

FIG. 24 is a diagram illustrating an example of URLLC signal protection processing according to a first embodiment of the present disclosure.

FIG. 25 is a diagram illustrating an example of URLLC signal protection processing according to a second embodiment of the present disclosure.

FIG. 26 is a diagram illustrating an example of URLLC signal protection processing according to a third embodiment of the present disclosure.

FIG. 27 is a diagram illustrating an example of URLLC signal protection processing according to a fourth embodiment of the present disclosure.

FIG. 28 is a diagram illustrating an example of URLLC signal protection processing according to a fifth embodiment of the present disclosure.

FIG. 29 is a diagram illustrating an example of URLLC signal protection processing according to a sixth embodiment of the present disclosure.

FIG. 30 is a diagram illustrating an example of URLLC signal protection processing according to a seventh embodiment of the present disclosure.

FIG. 31 is a diagram illustrating an example of URLLC signal protection processing according to an eighth embodiment of the present disclosure.

FIG. 32 is a diagram illustrating an example of URLLC signal protection processing according to a ninth embodiment of the present disclosure.

FIG. 33 is a diagram illustrating an example of URLLC signal protection processing according to a tenth embodiment of the present disclosure.

FIG. 34 is a diagram illustrating an example of URLLC signal protection processing according to an eleventh embodiment of the present disclosure.

FIG. 35 is a diagram illustrating an example of URLLC signal protection processing according to a twelfth embodiment of the present disclosure.

FIG. 36 is a diagram illustrating an example of URLLC signal protection processing according to a thirteenth embodiment of the present disclosure.

FIG. 37 is a diagram illustrating an example of URLLC signal protection processing according to a fourteenth embodiment of the present disclosure.

FIG. 38 is a diagram illustrating an example of URLLC signal protection processing according to a fifteenth embodiment of the present disclosure.

FIG. 39 is a diagram illustrating an example of URLLC signal protection processing according to a sixteenth embodiment of the present disclosure.

FIG. 40 is a diagram illustrating an example of URLLC signal protection processing according to a seventeenth embodiment of the present disclosure.

FIG. 41 is a diagram illustrating an example of URLLC signal protection processing according to an eighteenth embodiment of the present disclosure.

FIG. 42 is a diagram illustrating an example of URLLC signal protection processing according to a nineteenth embodiment of the present disclosure.

FIG. 43 is a diagram illustrating an example of URLLC signal protection processing according to a twentieth embodiment of the present disclosure.

FIG. 44 is a diagram illustrating an example of URLLC signal protection processing according to a twenty-first embodiment of the present disclosure.

FIG. 45 is a diagram illustrating an example of URLLC signal protection processing according to a twenty-second embodiment of the present disclosure.

FIG. 46 is a diagram illustrating an example of URLLC signal protection processing according to a twenty-third embodiment of the present disclosure.

FIG. 47 is a diagram illustrating an example of URLLC signal protection processing according to a twenty-fourth embodiment of the present disclosure.

FIG. 48 is a diagram illustrating an example of URLLC signal protection processing according to a twenty-fifth embodiment of the present disclosure.

FIG. 49 is a diagram illustrating an example of URLLC signal protection processing according to a twenty-sixth embodiment of the present disclosure.

FIG. 50 is a diagram illustrating an example of URLLC signal protection processing according to a twenty-seventh embodiment of the present disclosure.

FIG. 51 is a diagram illustrating an example of URLLC signal protection processing according to a twenty-eighth embodiment of the present disclosure.

FIG. 52 is a diagram illustrating an example of URLLC signal protection processing according to a twenty-ninth embodiment of the present disclosure.

FIG. 53 is a diagram illustrating an example of URLLC signal protection processing according to a thirtieth embodiment of the present disclosure.

FIG. 54 is a diagram illustrating an example of URLLC signal protection processing according to a thirty-first embodiment of the present disclosure.

FIG. 55 is a diagram illustrating an example of URLLC signal protection processing according to a thirty-second embodiment of the present disclosure.

FIG. 56 is a diagram illustrating an example of a configuration of an interference signal in a case where padding is performed in a transmission power suppression portion.

FIG. 57 is a diagram illustrating an example of a configuration of a MAC frame of a request signal.

FIG. 58 is a diagram illustrating an example of a configuration of a MAC frame of a request signal.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

Moreover, in the present specification and the drawings, a plurality of components having substantially the same functional configuration will be distinguished by attaching different numbers after the same reference numerals. For example, a plurality of configurations having substantially the same functional configuration are distinguished as necessary, such as terminal devices 401, 402, and 403. However, when it is not particularly necessary to distinguish between the plurality of components having substantially the same functional configuration, only the same reference numeral is given.

For example, when it is not necessary to distinguish between the terminal devices 401, 402, and 403, the device is simply referred to as the terminal device 40.

The present disclosure will be described in the following order.
1. Introduction
1-1. Overview of In-band full-duplex communication
1-2. Communication method of eMBB and URLLC using TDD
2. Configuration of communication system
2-1. Overall configuration of communication system
2-2. Configuration of management device
2-3. Configuration of base station device
2-4. Configuration of relay device
2-5. Configuration of terminal device
3. Overview of assumed system
3-1. Configuration of assumed system 1A
3-2. Configuration of assumed system 1B
3-3. Configuration of assumed system 1C
3-4. Configuration of assumed system 1D
3-5. Configuration of assumed system 1E
3-6. Configuration of assumed system 1F
3-7. Configuration of assumed system 1G
3-8. Configuration of assumed system 1H
3-9. Configuration of assumed system 1J
3-10. Configuration of assumed system 1K
3-11. Configuration of assumed system 1L
3-12. Configuration of assumed system 1M
4. Overview of signals to be used
5. In-band full-duplex communication setting operation
5-1. Operation sequence at the time of setting in-band full-duplex communication
5-2. Operation sequence at the time of setting non-full-duplex communication
5-3. In-band full-duplex communication executability determination processing flow
6. URLLC signal communication protection processing in in-band full-duplex communication
6-1. Mode of transmitting request signal using band same as band used for transmitting URLLC signal
6-1-1. Configuration and operation of first embodiment
6-1-2. Configuration and operation of second embodiment
6-2. Mode of transmitting request signal using band different from band used for transmitting URLLC signal
6-2-1. Configuration and operation of third embodiment
6-2-2. Configuration and operation of fourth embodiment
6-3. Mode of suppressing transmission power at timing away from transmission of request signal
6-3-1. Configuration and operation of fifth embodiment
6-3-2. Configuration and operation of six embodiment
6-4. Mode of resetting transmission parameter on interfering station side
6-4-1. Configuration and operation of seventh embodiment
6-4-2. Configuration and operation of eighth embodiment
6-4-3. Configuration and operation of ninth embodiment
6-4-4. Configuration and operation of tenth embodiment
6-4-5. Configuration and operation of eleventh embodiment
6-4-6. Configuration and operation of twelfth embodiment
6-5. Mode of notifying interfering station of communication section for which radio resources of request information and control information are set
6-5-1. Configuration and operation of thirteenth embodiment
6-5-2. Configuration and operation of fourteenth embodiment
6-5-3. Configuration and operation of fifteenth embodiment
6-5-4. Configuration and operation of sixteenth embodiment
6-6. Mode of not executing in-band duplex communication operation
6-6-1. Configuration and operation of seventeenth embodiment
6-6-2. Configuration and operation of eighteenth embodiment
6-6-3. Configuration and operation of nineteenth embodiment
6-6-4. Configuration and operation of twentieth embodiment
6-6-5. Configuration and operation of twenty-first embodiment
6-6-6. Configuration and operation of twenty-second embodiment
6-6-7. Configuration and operation of twenty-third embodiment
6-7. Mode of protecting own-cell URLLC signal from neighboring another-cell eMBB signal
6-7-1. Configuration and operation of twenty-fourth embodiment
6-7-2. Configuration and operation of twenty-fifth embodiment
6-7-3. Configuration and operation of twenty-sixth embodiment
6-7-4. Configuration and operation of twenty-seventh embodiment
6-7-5. Configuration and operation of twenty-eighth embodiment
6-8. Mode of protecting URLLC signal in case of transmitting periodic URLLC signal
6-8-1. Configuration and operation of twenty-ninth embodiment
6-8-2. Configuration and operation of thirtieth embodiment
6-9. Mode of setting URLLC signal and acknowledgement signal as protection target
6-9-1. Configuration and operation of thirty-first embodiment
6-9-2. Configuration and operation of thirty-second embodiment
7. Interference signal
8. Request signal
8-1. Specific example of request information
8-2. Specific example of request signal transmission method
8-3. Request signal for communication system that applies NR
8-4. Request signal in case of communication system that applies WLAN
9. Modifications
10. Conclusion

<<1. Introduction>>

With a rapid increase in mobile data traffic in recent years, there have been active studies to promote innovative technologies for improving frequency utilization efficiency. The technologies include full-duplex communication. The full-duplex communication includes out-band full-duplex communication (out-band full-duplex) and in-band full-duplex communication (in-band full-duplex). The out-band full-duplex communication uses a system of performing communication using different frequencies in the transmission band and the reception band in order to avoid interference between the transmission signal and the reception signal. In contrast, the in-band full-duplex communication is a duplex system of performing transmission and reception simultaneously using an identical frequency band. In in-band full-duplex communication, a signal transmitted by a communication device leaks into a reception circuit of the communication device, leading to an occurrence of very strong self-interference. However, the progress of interference cancellation technology has made it possible to reduce self-interference. Hereinafter, when simply described as full-duplex communication, the full-duplex communication refers to in-band full-duplex communication.

<1-1. Overview of In-Band Full-Duplex Communication>

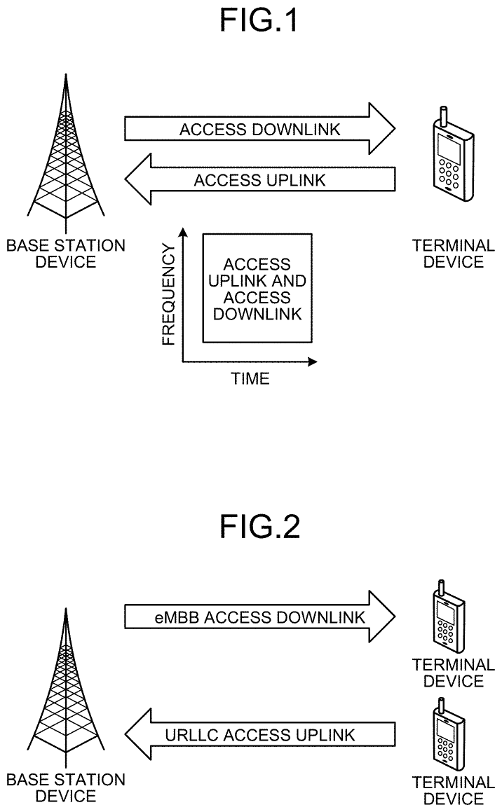

FIG. 1 is a diagram illustrating an overview of in-band full-duplex communication. An access uplink and an access downlink between the base station device and the terminal device illustrated in FIG. 1 adopt in-band full-duplex communication capable of simultaneously performing communications of transmission and reception using an identical frequency band. As a result, the in-band full-duplex communication is capable of performing simultaneous communications of transmission and reception using the identical frequency band, making it possible to improve the frequency utilization efficiency up to twice as compared with the out-band full-duplex communication.

Moreover, there has been a growing consensus in 5G that one radio system will support a communication mode of not only enhanced mobile broadband (eMBB) in data communication using existing smartphones, but also a communication mode of ultra-reliable and low-latency communication (URLLC), which requires high reliability and low latency in cases such as emergency message transmission used in autonomous driving.

<1-2. Communication Method of eMBB and URLLC Using TDD>

FIG. 2 is a diagram illustrating an example of a communication method of eMBB and URLLC using TDD. The base station device illustrated in FIG. 2 transmits an eMBB signal to the terminal device using the access downlink and receives a URLLC signal from another terminal device using the access uplink.

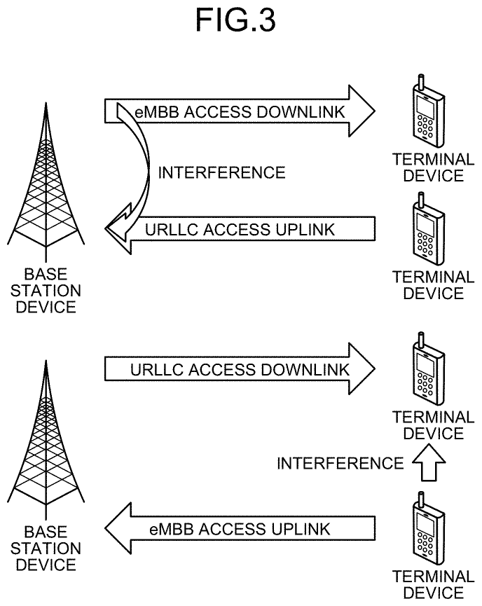

FIG. 3 is a diagram illustrating an example of signal interference in an access uplink and an access downlink. In an assumed case, the base station device illustrated in FIG. 3 has the access uplink and the access downlink using the identical frequency band, and while transmitting the eMBB signal to the terminal device using the access downlink, the base station device receives a URLLC signal from another terminal device using the access uplink. In this case, it is conceivable that the base station device is in a situation where the access downlink eMBB signal interferes with the access uplink URLLC signal.

In an assumed case, the base station device has the access uplink and the access downlink using the identical frequency band, and while receiving the eMBB signal from the terminal device using the access uplink, the base station device transmits a URLLC signal to another terminal device using the access downlink. In this case, it is conceivable that the terminal device is in a situation where the eMBB signal of the access uplink interferes with the URLLC signal of the access downlink.

Therefore, in a case where the in-band full-duplex communication is introduced and when a URLLC signal requiring low latency occurs during eMBB signal communication, it is difficult to ensure the quality of service (QoS) of the URLLC signal due to signal interference from the eMBB signal.

In view of this, the present embodiment is intended to solve this problem by the following means.

For example, the communication device includes a transmission unit and a notification unit. The transmission unit transmits a second signal (for example, an URLLC signal) that requires low latency severer than a first signal (for example, an eMBB signal). When the transmission unit transmits the second signal, the notification unit notifies another communication device that transmits the first signal of a request signal containing information requesting suppression of transmission power of the first signal.

For example, in an assumed case, a second signal such as a URLLC signal is transmitted during transmission of a first signal such as an eMBB signal. When transmitting the second signal, notification of a request signal containing information requesting suppression of transmission power of the first signal is provided to another communication device that transmits the first signal. The another communication device suppresses the transmission power of the first signal in response to the request signal. This avoids the signal interference to the second signal from the first signal. The suppression of the transmission power can be achieved by executing operations such as transmission cancellation of the first signal, reduction of the transmission power, and change of the transmission beam at the transmission timing of the second signal, for example.

The overview of the present embodiment has been described above. Hereinafter, a communication system 1 of the present embodiment will be described in detail.

<<2. Configuration of Communication System>>

The communication system 1 includes a base station device 20 and a relay device 30, and can be connected to a terminal device 40 by radio communication. Hereinafter, the configuration of the communication system 1 will be specifically described.

<2-1. Overall Configuration of Communication System>

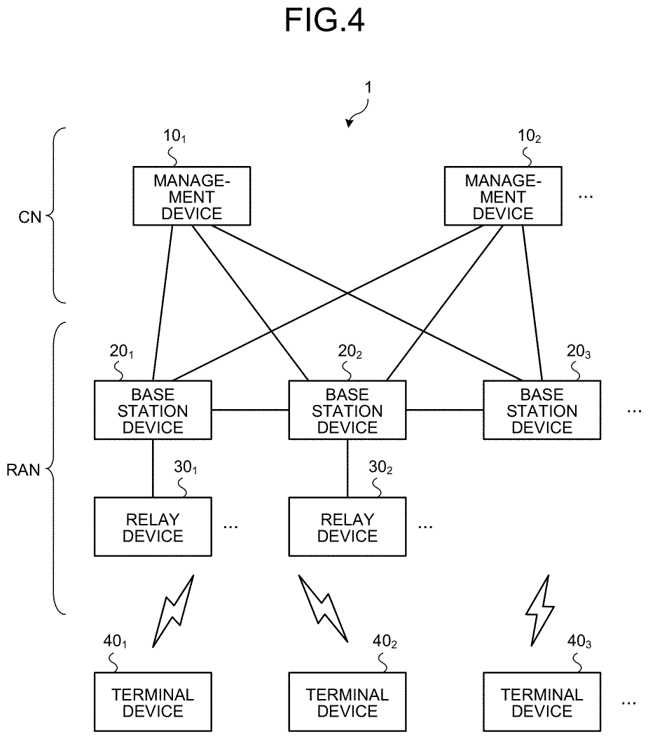

FIG. 4 is a diagram illustrating a configuration example of the communication system 1 according to an embodiment of the present disclosure. The communication system 1 is a radio communication system that provides a radio access network to the terminal device 40. For example, the communication system 1 is a cellular communication system using a radio access technology such as long term evolution (LTE) or new radio (NR).

As illustrated in FIG. 4, the communication system 1 includes a management device 10, a base station device 20, a relay device 30, and a terminal device 40. With individual radio communication devices constituting the communication system 1 operating in cooperation with each other, the communication system 1 provides a user with a radio network capable of mobile communication. The radio network of the present embodiment includes a radio access network RAN and a core network CN, for example. The radio communication device is a device having a radio communication function, and in the example of FIG. 4, the base station device 20, the relay device 30, and the terminal device 40 are examples of this device.

The communication system 1 may include a plurality of management devices 10, a plurality of base station devices 20, a plurality of relay devices 30, and a plurality of terminal devices 40. In the example of FIG. 4, the communication system 1 includes management devices 101, 102, and so on as the management device 10. Furthermore, the communication system 1 includes base station devices 201, 202, 203, and so on as the base station device 20, and includes relay devices 301, 302, and so on as the relay device 30. Furthermore, the communication system 1 includes terminal devices 401, 402, 403, and so on as the terminal device 40.

The device in the figure may be considered as a device in a logical sense. That is, parts of the device in the drawing may be partially actualized by a virtual machine (VM), a container, a docker, or the like, and they may be implemented on physically the same hardware.

The base station in LTE may be referred to as Evolved Node B (eNodeB) or eNB. NR base stations are sometimes referred to as gNodeB or gNB. In LTE and NR, a terminal device (also referred to as a mobile station, mobile station device, or terminal) may be referred to as user equipment (UE). The terminal device is a type of communication device, and is also referred to as a mobile station, a mobile station device, or a terminal.

In the present embodiment, the concept of the “communication device” includes not only a portable mobile device (terminal device) such as a mobile terminal but also a device installed in a structure or a mobile body. The structure or a mobile body itself may be regarded as a communication device. In addition, the concept of the communication device includes not only a terminal device but also a base station device and a relay device. The communication device is a type of processing device and information processing device. Furthermore, the communication device can be rephrased as a transmitting device (transmitting station) or a receiving device (receiving station).

[Management Device]

The management device 10 is a device that manages a radio network. For example, the management device 10 is a device that manages communication of the base station device 20. For example, the management device 10 is a device that functions as a Mobility Management Entity (MME), an Access and Mobility Management Function (AMF), or a Session Management Function (SMF).

The management device 10 configures the core network CN together with a gateway device and the like. The core network CN is a network of a predetermined entity such as a mobile communication carrier. For example, the core network CN is an evolved packet core (EPC) or a 5G core network (5GC). Note that the predetermined entity may be the same as or different from the entity that uses, operates, and/or manages the base station device 20.

Note that the management device 10 may have a function of a gateway. For example, when the core network is an EPC, the management device 10 may have a function as an S-GW or a P-GW. When the core network is a 5GC, the management device 10 may be a device having a function as a user plane function (UPF). Note that the management device 10 does not necessarily have to be a device constituting the core network CN. For example, it is assumed that the core network CN is a core network of Wideband Code Division Multiple Access (W-CDMA) or Code Division Multiple Access 2000 (cdma2000). At this time, the management device 10 may be a device that functions as a radio network controller (RNC).

The management device 10 is connected to each of the plurality of base station devices 20 and manages communication of the base station devices 20. Note that the management device 10 grasps and manages, for each terminal device 40, which base station device (or which cell) the terminal device is connected to, in which base station device (or which cell) the terminal device 40 exists in the communication area, and the like. The cell may be a primary cell (pCell) or a secondary cell (sCell). The cells may be configured such that radio resources (for example, a frequency channel, a component carrier, and the like) that can be used by the terminal device 40 differ for each cell. Furthermore, one base station device may provide a plurality of cells. In addition, the management device 10 may be referred to as a control station, for example.

[Base Station Device]

The base station device 20 is a radio communication device that performs radio communication with the terminal device 40. The base station device 20 is a type of communication device. The base station device 20 is, for example, a device corresponding to a radio base station (Base Station, Node B, eNB, gNB, etc.) or a radio access point. The base station device 20 may be a radio relay station. The base station device 20 may be an optical link device referred to as a Remote Radio Head (RRH). Furthermore, the base station device 20 may be a receiving station device such as a Field Pickup Unit (FPU). In addition, the base station device 20 may be an Integrated Access and Backhaul (IAB) donor node or an IAB relay node that provides a radio access channel and a radio backhaul channel by using time division multiplexing, frequency division multiplexing, or space division multiplexing.

Note that the radio access technology used by the base station device 20 may be a cellular communication technology or a wireless LAN technology. Needless to say, the radio access technology used by the base station device 20 is not limited thereto, and may be other radio access technologies. For example, the radio access technology used by the base station device 20 may be a low power wide area (LPWA) communication technology. Here, the LPWA communication is communication conforming to the LPWA standard. Examples of the LPWA standard include ELTRES, ZETA, SIGFOX, LoRaWAN, and NB-Iot. Needless to say, the LPWA standard is not to be limited thereto, and may be other LPWA standards. In addition, the radio communication used by the base station device 20 may be radio communication using millimeter waves. Furthermore, the radio communication used by the base station device 20 may be radio communication using radio waves or wireless communication (optical wireless communication) using infrared rays or visible light.

The base station device 20 may be capable of performing NOMA communication with the terminal device 40. Here, NOMA communication refers to communication (transmission, reception, or both) using non-orthogonal resources. Note that the base station device 20 may be configured to be able to perform NOMA communication with another base station device 20 and the relay device 30.

The base station device 20 may be capable of communicating with each other via a base station device-core network interface (for example, S1 Interface). This interface may be implemented as wired or wireless interface. Furthermore, the base station devices may be capable of communicating with each other via an interface between the base station devices (for example, X2 Interface, S1 Interface, or the like). This interface may be implemented as wired or wireless interface.

The base station device 20 can be utilized, operated, and/or managed by various entities (subjects). Assumable examples of the entity include: a mobile network operator (MNO), a mobile virtual network operator (MVNO), a mobile virtual network enabler (MVNE), a neutral host network (NHN) operator, an enterprise, an educational institution (incorporated educational institutions, boards of education of local governments, and the like), a real estate (building, apartment, and the like) administrator, an individual, or the like.

Note that the subject of use, operation, and/or management of the base station device 20 is not limited thereto. The base station device 20 may be installed and/or operated by one business operator, or may be installed and/or operated by one individual. Needless to say, the installation/operation subject of the base station device 20 is not limited thereto. For example, the base station device 20 may be installed and operated by a plurality of business operators or a plurality of individuals in cooperation. Furthermore, the base station device 20 may be a shared facility used by a plurality of business operators or a plurality of individuals. In this case, installation and/or operation of the facility may be performed by a third party different from the user.

The concept of the base station device (also referred to as a base station) includes not only a donor base station but also a relay base station (also referred to as a relay station or a relay station device). Furthermore, a base station conceptually includes not only a structure having a function of a base station but also a device installed in the structure.

The structure is, for example, a building such as a high-rise building, a house, a steel tower, a station facility, an airport facility, a port facility, or a stadium. The concept of the structure includes not only buildings but also non-building structures such as tunnels, bridges, dams, fences, and steel columns, as well as facilities such as cranes, gates, and windmills. In addition, the concept of the structure includes not only land-based (ground-based, in a narrow sense) structures or underground structures but also structures on the water, such as a jetty and a mega-float, and underwater structures such as an ocean observation facility. The base station device can be rephrased as a processing device or an information processing device.

The base station device 20 may be a donor station or a relay station. The base station device 20 may be a fixed station or a mobile station. The mobile station is a radio communication device (for example, a base station device) configured to be movable. At this time, the base station device 20 may be a device installed on a mobile body, or may be the mobile body itself. For example, a relay station device having mobility can be regarded as the base station device 20 as a mobile station. In addition, a device designed to have mobility, such as a vehicle, a drone, or a smartphone, and having a function of a base station device (at least a part of the function of a base station device) also corresponds to the base station device 20 as a mobile station.

Here, the mobile body may be a mobile terminal such as a smartphone or a mobile phone. The mobile body may be a mobile body that moves on the land (ground in a narrow sense) (for example, a vehicle such as an automobile, a bicycle, a bus, a truck, a motorbike, a train, or a linear motor car), or a mobile body (for example, subway) that moves under the ground (for example, through a tunnel).

The mobile body may be a mobile body that moves on the water (for example, a ship such as a passenger ship, a cargo ship, and a hovercraft), or a mobile body that moves underwater (for example, a submersible ship such as a submersible boat, a submarine, or an unmanned submarine).

Furthermore, the mobile body may be a mobile body that moves in the atmosphere (for example, an aircraft such as an airplane, an airship, or a drone), or may be a mobile body that moves outside the atmosphere (for example, an artificial astronomical object such as an artificial satellite, a spaceship, a space station, or a spacecraft). A mobile body moving outside the atmosphere can be rephrased as a space mobile body.

Furthermore, the base station device 20 may be a terrestrial base station device (ground station device) installed on the ground. For example, the base station device 20 may be a base station device arranged in a structure on the ground, or may be a base station device installed in a mobile body moving on the ground. More specifically, the base station device 20 may be an antenna installed in a structure such as a building and a signal processing device connected to the antenna. Note that the base station device 20 may be a structure or a mobile body itself. The “ground” represents not only a land (ground in a narrow sense) but also a ground or terrestrial in a broad sense including underground, above-water, and underwater. Note that the base station device 20 is not limited to the terrestrial base station device. The base station device 20 may be a non-terrestrial base station device (non-ground station device) capable of floating in the air or space. For example, the base station device 20 may be an aircraft station device or a satellite station device.

The aircraft station device is a radio communication device capable of floating in the atmosphere, such as an aircraft. The aircraft station device may be a device mounted on an aircraft or the like, or may be an aircraft itself. The concept of the aircraft includes not only heavy aircraft such as an airplane and a glider but also light aircraft such as a balloon and an airship. In addition, the concept of an aircraft includes not only a heavy aircraft and a light aircraft but also a rotorcraft such as a helicopter and an auto-gyro. Note that the aircraft station device (or an aircraft on which an aircraft station device is mounted) may be an unmanned aerial vehicle such as a drone.

Note that the concept of the unmanned aerial vehicle also includes an unmanned aircraft system (UAS) and a tethered UAS. The concept of unmanned aerial vehicles also includes a Lighter-than-Air (LTA) unmanned aircraft system (UAS) and a Heavier-than-Air (HTA) unmanned aircraft system (UAS). Other concepts of unmanned aerial vehicles also include High Altitude Platforms (HAPs) unmanned aircraft system (UAS).

The satellite station device is a radio communication device capable of floating outside the atmosphere. The satellite station device may be a device mounted on a space mobile body such as an artificial satellite, or may be a space mobile body itself. The satellite serving as the satellite station device may be any of a low earth orbiting (LEO) satellite, a medium earth orbiting (MEO) satellite, a geostationary earth orbiting (GEO) satellite, or a highly elliptical orbiting (HEO) satellite. Accordingly, the satellite station device may be a device mounted on a low earth orbiting satellite, a medium earth orbiting satellite, a geostationary earth orbiting satellite, or a highly elliptical orbiting satellite.

The coverage of the base station device 20 may be large such as a macro cell or small such as a pico cell. Needless to say, the coverage of the base station device 20 may be extremely small such as a femto cell. Furthermore, the base station device 20 may have a beamforming capability. In this case, the base station device 20 may form a cell or a service area for each beam.

In the example of FIG. 4, the base station device 201 is connected to the relay device 301, and the base station device 202 is connected to the relay device 302. The base station device 201 can indirectly perform radio communication with the terminal device 40 via the relay device 301. Similarly, the base station device 202 can indirectly perform radio communication with the terminal device 40 via the relay device 302.

[Relay Device]

The relay device 30 is a device to be a relay station of a base station. The relay device 30 is a type of base station device. The relay device can be rephrased as a relay base station device (or a relay base station). The relay device 30 can perform NOMA communication with the terminal device 40. The relay device 30 relays communication between the base station device 20 and the terminal device 40. The relay device 30 may be configured to be able to perform NOMA communication with another relay device 30 and the base station device 20. The relay device 30 may be a ground station device or a non-ground station device. The relay device 30 constitutes a radio access network RAN together with the base station device 20.

The relay device 30 is a device that transfers information from one communication device to the other communication device. Specifically, it is a device that receives a signal from one communication device and transmits a signal to the other communication device. As an assumption of the relay device 30, communication between one communication device and the relay device 30 and communication between the relay device 30 and the other communication device are performed as radio communication. Note that the relay device 30 may be a fixed device, a movable device, or a floating device. The relay device 30 has no limitation in the size of the coverage. For example, the relay device 30 may be a macro cell, a micro cell, or a small cell. In addition, the relay device 30 may be mounted on any type of device as long as the function of relay is satisfied. For example, the relay device 30 may be mounted on a terminal device 40 such as a smartphone, may be mounted on an automobile or a human-powered vehicle, may be mounted on a balloon, an airplane, or a drone, or on a home appliance such as a television, a game machine, an air conditioner, a refrigerator, or a lighting fixture.

[Terminal Device]

The terminal device 40 is a radio communication device that performs radio communication with the base station device 20 or the relay device 30. Examples of the terminal device 40 include a mobile phone, a smart device (smartphone or tablet), a personal digital assistant (PDA), or a personal computer. Furthermore, the terminal device 40 may be a device such as a business camera equipped with a communication function, or may be a motorcycle, a moving relay vehicle, or the like on which a communication device such as a field pickup unit (FPU) is mounted. The terminal device 40 may be a machine to machine (M2M) device or an Internet of Things (IoT) device.

Furthermore, the terminal device 40 may be capable of sidelink communication with another terminal device 40. The terminal device 40 may be capable of using an automatic retransmission technology such as HARQ when performing sidelink communication. The terminal device 40 may be capable of NOMA communication with the base station device 20 and the relay device 30. The terminal device 40 may also be capable of NOMA communication in the communication (sidelink) with another terminal device 40. Furthermore, the terminal device 40 may be capable of LPWA communication with another communication device (for example, the base station device 20, the relay device 30, or another terminal device 40). In addition, the radio communication used by the terminal device 40 may be radio communication using millimeter waves. The radio communication (including sidelink communication) used by the terminal device 40 may be radio communication using radio waves or wireless communication (optical wireless communication) using infrared rays or visible light.

Furthermore, the terminal device 40 may be a mobile device. Here, the mobile device is a movable radio communication device. At this time, the terminal device 40 may be a radio communication device installed on a mobile body, or may be the mobile body itself. For example, the terminal device 40 may be a vehicle that moves on a road, such as an automobile, a bus, a truck, or a motorbike, or may be a radio communication device mounted on the vehicle. The mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

The terminal device 40 may perform communication while being simultaneously connected to a plurality of base station devices or a plurality of cells. For example, when one base station device supports a communication area via a plurality of cells (for example, pCell and sCell), it is possible to bundle the plurality of cells and communicate between the base station device 20 and the terminal device 40 by using a carrier aggregation (CA) technology, a dual connectivity (DC) technology, or a multi-connectivity (MC) technology. Alternatively, the terminal device 40 and the plurality of base station devices 20 can communicate with each other by a Coordinated Multi-Point Transmission and Reception (CoMP) technology via cells of different base station devices 20.

The terminal device 40 does not necessarily have to be a device directly used by a person. The terminal device 40 may be a sensor installed in a machine or the like in a factory, such as a sensor used for communication referred to as machine type communication (MTC). The terminal device 40 may be a machine to machine (M2M) device or an Internet of Things (IoT) device. Furthermore, the terminal device 40 may be a device having a relay communication function as represented by Device to Device (D2D) and Vehicle to everything (V2X). Furthermore, the terminal device 40 may be a device referred to as Client Premises Equipment (CPE) used in a radio backhaul or the like.

Hereinafter, configuration of each device included in the communication system 1 according to the embodiment will be specifically described. The configuration of each device illustrated below is just an example. The configuration of each device may differ from the configuration below.

<2-2. Configuration of Management Device>

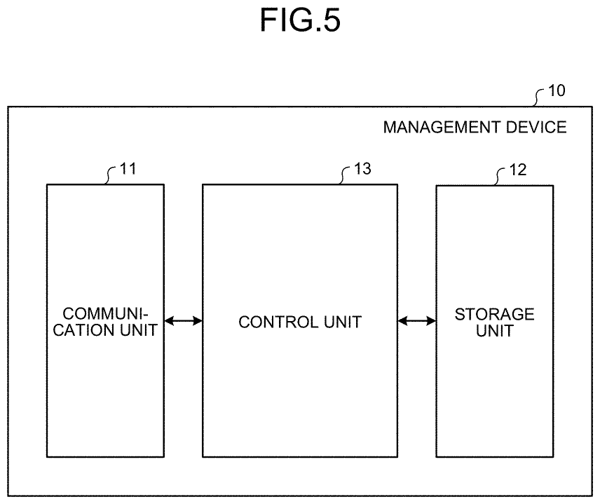

FIG. 5 is a diagram illustrating a configuration example of the management device 10 according to an embodiment of the present disclosure. The management device 10 is a device that manages a radio network. The management device 10 includes a communication unit 11, a storage unit 12, and a control unit 13. Note that the configuration illustrated in FIG. 5 is a functional configuration, and the hardware configuration may be different from this. Furthermore, the functions of the management device 10 may be implemented in a distributed manner in a plurality of physically separated configurations. For example, the management device 10 may be constituted with a plurality of server devices.

The communication unit 11 is a communication interface for communicating with other devices. The communication unit 11 may be a network interface, or may be a device connection interface. For example, the communication unit 11 may be a local area network (LAN) interface such as a network interface card (NIC), or may be a universal serial bus (USB) interface including a USB host controller, a USB port, and the like. Furthermore, the communication unit 11 may be a wired interface, or may be a wireless interface. The communication unit 11 functions as a communication means of the management device 10. The communication unit 11 communicates with the base station device 20 under the control of the control unit 13.

The storage unit 12 is a data readable/writable storage device such as dynamic random access memory (DRAM), static random access memory (SRAM), a flash drive, or a hard disk. The storage unit 12 functions as a storage means in the management device 10. The storage unit 12 stores, for example, a connection state of the terminal device 40. For example, the storage unit 12 stores a radio resource control (RRC) state and an EPS connection management (ECM) state of the terminal device 40. The storage unit 12 may function as a unit referred to as “home memory” (user information database) that stores the positional information of the terminal device 40.

The control unit 13 is a controller that controls individual components of the management device 10. The control unit 13 is realized by a processor such as a central processing unit (CPU) or a micro processing unit (MPU), for example. For example, the control unit 13 is actualized by execution of various programs stored in the storage device inside the management device 10 by the processor using random access memory (RAM) or the like as a work area. Note that the control unit 13 may be realized by an integrated circuit such as an application specific integrated circuit (ASIC) or a field programmable gate array (FPGA). The CPU, MPU, ASIC, and FPGA can all be regarded as controllers.

<2-3. Configuration of Base Station Device>

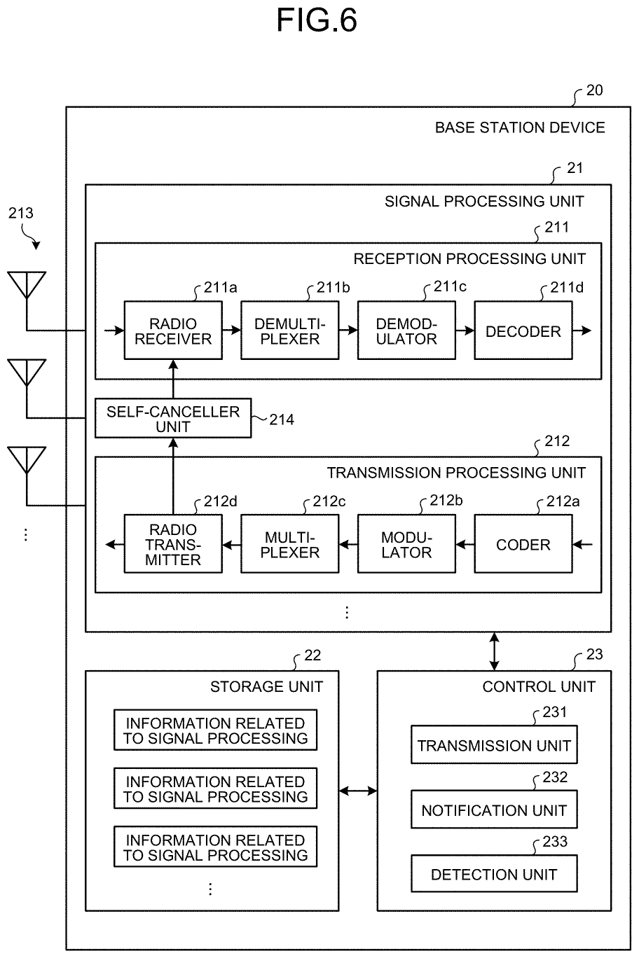

Next, a configuration of the base station device 20 will be described. FIG. 6 is a diagram illustrating a configuration example of the base station device 20 according to the embodiment of the present disclosure. The base station device 20 supports a 2-step random access procedure in addition to the conventional 4-step random access procedure (contention-based random access procedure) and the conventional 3-step random access procedure (non-contention-based random access procedure). Furthermore, the base station device 20 can perform NOMA communication with the terminal device 40. The base station device 20 includes a signal processing unit 21, a storage unit 22, and a control unit 23. Note that the configuration illustrated in FIG. 6 is a functional configuration, and the hardware configuration may be different from this. Furthermore, the functions of the base station device 20 may be implemented in a distributed manner in a plurality of physically separated devices.

The signal processing unit 21 is a signal processing unit for performing radio communication with other radio communication devices (for example, the terminal device 40 and the relay device 30). The signal processing unit 21 operates under the control of the control unit 23. The signal processing unit 21 supports one or a plurality of radio access methods. For example, the signal processing unit 21 supports both NR and LTE.

The signal processing unit 21 may support W-CDMA and cdma2000 in addition to NR and LTE. Furthermore, the signal processing unit 21 supports communication using NOMA.

The signal processing unit 21 includes a reception processing unit 211, a transmission processing unit 212, an antenna 213, and a self-canceller unit 214. The signal processing unit 21 may include a plurality of reception processing units 211, a plurality of transmission processing units 212, a plurality of antennas 213, and a plurality of self-canceller units 214. In a case where the signal processing unit 21 supports a plurality of radio access methods, individual portions of the signal processing unit 21 can be configured separately for each of the radio access methods. For example, the reception processing unit 211 and the transmission processing unit 212 may be individually configured for LTE and NR.

The reception processing unit 211 processes an uplink signal received via the antenna 213. The reception processing unit 211 includes a radio receiver 211a, a demultiplexer 211b, a demodulator 211c, and a decoder 211d.

For example, the radio receiver 211a performs processing on the uplink signal, such as down-conversion, removal of unnecessary frequency components, amplification level control, orthogonal demodulation, conversion to digital signal, removal of guard interval (cyclic prefix), and frequency domain signal extraction using fast Fourier transform. The demultiplexer 211b demultiplexes an uplink channel such as a physical uplink shared channel (PUSCH) or a physical uplink control channel (PUCCH) and an uplink reference signal from the signal output from the radio receiver 211a. Using a modulation scheme such as binary phase shift keying (BPSK) or quadrature phase shift keying (QPSK) for the modulation symbol of the uplink channel, the demodulator 211c demodulates the received signal. The modulation scheme used by the demodulator 211c may be 16 quadrature amplitude modulation (QAM), 64 QAM, or 256 QAM. In this case, the signal points on the constellation do not necessarily have to be equidistant. The constellation may be a non-uniform constellation (NUC). The decoder 211d performs decoding processing on the demodulated coded bits of the uplink channel. The decoded uplink data and uplink control information are output to the control unit 23.

The transmission processing unit 212 performs transmission processing of downlink control information and downlink data. The transmission processing unit 212 includes a coder 212a, a modulator 212b, a multiplexer 212c, and a radio transmitter 212d.

The coder 212a encodes the downlink control information and the downlink data input from the control unit 23 by using a coding method such as block coding, convolutional coding, or turbo coding. The modulator 212b modulates the coded bits output from the coder 212a by a predetermined modulation scheme such as BPSK, QPSK, 16 QAM, 64 QAM, or 256 QAM. In this case, the signal points on the constellation do not necessarily have to be equidistant. The constellation may be a non-uniform constellation. The multiplexer 212c multiplexes the modulation symbol of each of channels and the downlink reference signal and allocates the multiplexed signals on a predetermined resource element. The radio transmitter 212d performs various types of signal processing on the signal from the multiplexer 212c. For example, the radio transmitter 212d performs processing such as conversion to the time domain using fast Fourier transform, addition of a guard interval (cyclic prefix), generation of a baseband digital signal, conversion to an analog signal, quadrature modulation, upconvert, removal of extra frequency components, and power amplification. The signal generated by the transmission processing unit 212 is transmitted from the antenna 213.

The self-canceller unit 214 cancels self-interference, which is leakage of a signal transmitted from the radio transmitter 212d into the radio receiver 211a.

The storage unit 22 is a data readable/writable storage device such as DRAM, SRAM, a flash drive, and a hard disk. The storage unit 22 functions as a storage means in the base station device 20.

The control unit 23 is a controller that controls individual components of the base station device 20. The control unit 23 is realized by a processor such as a central processing unit (CPU) or a micro processing unit (MPU), for example. For example, the control unit 23 is realized by execution of various programs stored in the storage device inside the base station device 20 by the processor using random access memory (RAM) or the like as a work area. Note that the control unit 23 may be realized by an integrated circuit such as an application specific integrated circuit (ASIC) or a field programmable gate array (FPGA). The CPU, MPU, ASIC, and FPGA can all be regarded as controllers.

As illustrated in FIG. 6, the control unit 23 includes a transmission unit 231, a notification unit 232, and a detection unit 233. Individual blocks (the transmission unit 231 and the notification unit 232) constituting the control unit 23 are functional blocks individually indicating functions of the control unit 23. These functional blocks may be software blocks or hardware blocks. For example, each of the functional blocks described above may be one software module realized by software (including a microprogram) or one circuit block on a semiconductor chip (die). Needless to say, each of the functional blocks may be formed as one processor or one integrated circuit. The functional block may be configured by using any method.

Note that the control unit 23 may be configured in a functional unit different from the above-described functional block. The operation of individual blocks (the transmission unit 231, the notification unit 232, and the detection unit 233) constituting the control unit 23 will be described below. The operations of individual block constituting the control unit 23 may be similar to the operations of individual blocks constituting a control unit 45 of the terminal device 40. The configuration of the terminal device 40 will be described below.

<2-4. Configuration of Relay Device>

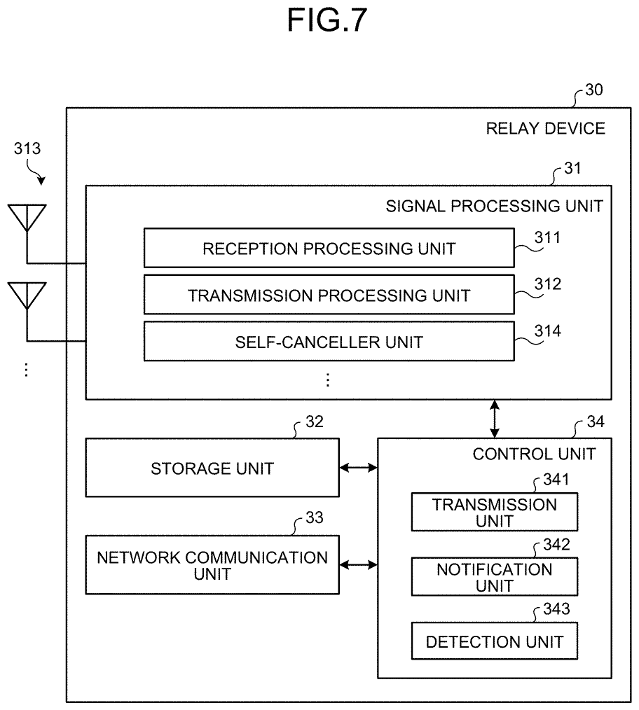

Next, a configuration of the relay device 30 will be described. FIG. 7 is a diagram illustrating a configuration example of the relay device 30 according to an embodiment of the present disclosure. The relay device 30 can perform NOMA communication with the terminal device 40. The relay device 30 includes a signal processing unit 31, a storage unit 32, a network communication unit 33, and a control unit 34. Note that the configuration illustrated in FIG. 7 is a functional configuration, and the hardware configuration may be different from this. Furthermore, the functions of the relay device 30 may be implemented in a distributed manner in a plurality of physically separated configurations.

The signal processing unit 31 is a signal processing unit for radio communication with other radio communication devices (for example, the base station device 20 and the terminal device 40). The signal processing unit 31 operates under the control of the control unit 34. The signal processing unit 31 includes a reception processing unit 311, a transmission processing unit 312, an antenna 313, and a self-canceller unit 314. The configurations of the signal processing unit 31, the reception processing unit 311, the transmission processing unit 312, and the antenna 313 are respectively similar to the configurations of the signal processing unit 21, the reception processing unit 211, the transmission processing unit 212, the antenna 213, and the self-canceller unit 214 of the base station device 20

The storage unit 32 is a data readable/writable storage device such as DRAM, SRAM, a flash drive, and a hard disk. The storage unit 32 functions as a storage means in the relay device 30. The configuration of the storage unit 32 is similar to the configuration of the storage unit 22 of the base station device 20.

The network communication unit 33 is a communication interface for communicating with other devices. For example, the network communication unit 33 is a LAN interface such as an NIC. Furthermore, the network communication unit 33 may be a wired interface, or may be a wireless interface. The network communication unit 33 functions as a network communication means of the relay device 30. The network communication unit 33 communicates with the base station device 20 under the control of the control unit 34.

The control unit 34 is a controller that controls individual parts of the relay device 30. The configuration of the control unit 34 may be similar to the configuration of the control unit 23 of the base station device 20. The control unit 34 includes a transmission unit 341, a notification unit 342, and a detection unit 343. Note that the control unit 34 may be configured in a functional unit different from the above-described functional block. The operation of individual blocks (the transmission unit 341, the notification unit 342, and the detection unit 343) constituting the control unit 34 will be described below.

<2-5. Configuration of Terminal Device>

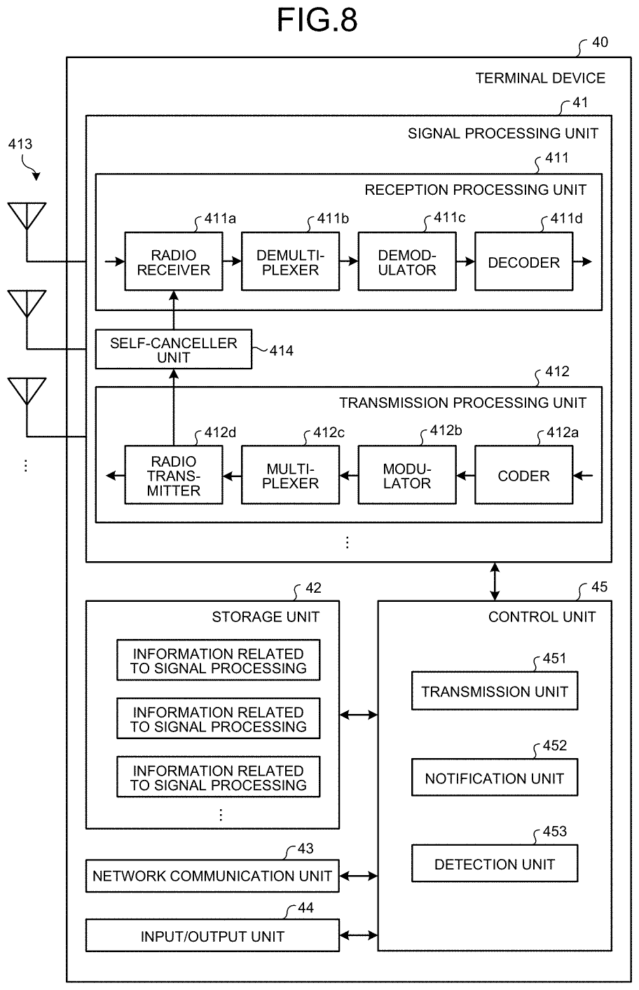

Next, a configuration of the terminal device 40 will be described. FIG. 8 is a diagram illustrating a configuration example of the terminal device 40 according to the embodiment of the present disclosure. The terminal device 40 can use a 2-step random access procedure in addition to the conventional 4-step random access procedure (contention-based random access procedure) and the conventional 3-step random access procedure (non-contention-based random access procedure). The terminal device 40 is capable of NOMA communication with the base station device 20 and the relay device 30. The terminal device 40 includes a signal processing unit 41, a storage unit 42, a network communication unit 43, an input/output unit 44, and a control unit 45. Note that the configuration illustrated in FIG. 8 is a functional configuration, and the hardware configuration may be different from this. Furthermore, the functions of the terminal device 40 may be implemented in a distributed manner in a plurality of physically separated configurations.

The signal processing unit 41 is a signal processing unit for radio communication with other radio communication devices (for example, the base station device 20 and the relay device 30). The signal processing unit 41 operates under the control of the control unit 45. The signal processing unit 41 supports one or a plurality of radio access methods. For example, the signal processing unit 41 supports both NR and LTE. The signal processing unit 41 may support W-CDMA and cdma2000 in addition to NR and LTE. Furthermore, the signal processing unit 41 supports communication using NOMA.

The signal processing unit 41 includes a reception processing unit 411, a transmission processing unit 412, an antenna 413, and a self-canceller unit 414. The signal processing unit 41 may include a plurality of reception processing units 411, a plurality of transmission processing units 412, a plurality of antennas 413, and a plurality of self-canceller units 414. In a case where the signal processing unit 41 supports a plurality of radio access methods, individual portions of the signal processing unit 41 can be configured separately for each of the radio access methods. For example, the reception processing unit 411 and the transmission processing unit 412 may be individually configured for LTE and NR.

The reception processing unit 411 processes a downlink signal received via the antenna 413. The reception processing unit 411 includes a radio receiver 411a, a demultiplexer 411b, a demodulator 411c, and a decoder 411d.

For example, the radio receiver 411a performs processing on the downlink signal, such as down-conversion, removal of unnecessary frequency components, amplification level control, orthogonal demodulation, conversion to digital signal, removal of guard interval (cyclic prefix), and frequency domain signal extraction using fast Fourier transform. The demultiplexer 411b demultiplexes a downlink channel, a downlink synchronization signal, and a downlink reference signal from the signal output from the radio receiver 411a. Examples of the downlink channel include a channel such as a physical broadcast channel (PBCH), a physical downlink shared channel (PDSCH), or a physical downlink control channel (PDCCH). The demodulator 211c demodulates the received signal using a modulation scheme such as BPSK, QPSK, 16QAM, 64QAM, or 256QAM onto the modulation symbol of the downlink channel. In this case, the signal points on the constellation do not necessarily have to be equidistant. The constellation may be a non-uniform constellation. The decoder 411d performs decoding processing on the demodulated coded bits of the downlink channel. The decoded downlink data and uplink control information are output to the control unit 45.

The transmission processing unit 412 performs transmission processing of uplink control information and uplink data. The transmission processing unit 412 includes a coder 412a, a modulator 412b, a multiplexer 412c, and a radio transmitter 412d.

The coder 412a encodes the uplink control information and the uplink data input from the control unit 45 by using a coding method such as block coding, convolutional coding, or turbo coding. The modulator 412b modulates the coded bits output from the coder 412a by a predetermined modulation scheme such as BPSK, QPSK, 16 QAM, 64 QAM, or 256 QAM. In this case, the signal points on the constellation do not necessarily have to be equidistant. The constellation may be a non-uniform constellation. The multiplexer 412c multiplexes the modulation symbol of each of channels and an uplink reference signal, and allocates the multiplexed signals on a predetermined resource element. The radio transmitter 412d performs various types of signal processing on the signal from the multiplexer 412c. For example, the radio transmitter 412d performs processing such as conversion to the time domain using inverse fast Fourier transform, addition of a guard interval (cyclic prefix), generation of a baseband digital signal, conversion to an analog signal, quadrature modulation, upconvert, removal of extra frequency components, and power amplification. The signal generated by the transmission processing unit 412 is transmitted from the antenna 413.

The self-canceller unit 414 cancels self-interference, which is leakage of a signal transmitted from the radio transmitter 412d into the radio receiver 411a. The storage unit 42 is a data readable/writable storage device such as DRAM, SRAM, a flash drive, and a hard disk. The storage unit 42 functions as a storage means in the terminal device 40.

The network communication unit 43 is a communication interface for communicating with other devices. For example, the network communication unit 43 is a LAN interface such as an NIC. Furthermore, the network communication unit 43 may be a wired interface, or may be a wireless interface. The network communication unit 43 functions as a network communication means of the terminal device 40. The network communication unit 43 communicates with other devices under the control of the control unit 45.

The input/output unit 44 is a user interface for exchanging information with the user. For example, the input/output unit 44 is an operation device such as a keyboard, a mouse, operation keys, and a touch panel, used by a user to perform various operations. Alternatively, the input/output unit 44 is a display device such as a liquid crystal display, or an organic electroluminescence (EL) display. The input/output unit 44 may be an acoustic device such as a speaker or a buzzer. Furthermore, the input/output unit 44 may be a lighting device such as a light emitting diode (LED) lamp. The input/output unit 44 functions as an input/output means (input means, output means, operation means, or notification means) provided on the terminal device 40.

The control unit 45 is a controller that controls individual parts of the terminal device 40. The control unit 45 is actualized by a processor such as a CPU or an MPU, for example. For example, the control unit 45 is realized by a processor executing various programs stored in a storage device inside the terminal device 40 using RAM or the like as a work area. Note that the control unit 45 may be realized by an integrated circuit such as an ASIC or an FPGA. The CPU, MPU, ASIC, and FPGA can all be regarded as controllers.

As illustrated in FIG. 8, the control unit 45 includes a transmission unit 451, a notification unit 452, and a detection unit 453. Each of blocks (the transmission unit 451, the notification unit 452, and the detection unit 453) constituting the control unit 45 is a functional block each indicating a function of the control unit 45. These functional blocks may be software blocks or hardware blocks. For example, each of the functional blocks described above may be one software module realized by software (including a microprogram) or one circuit block on a semiconductor chip (die). Needless to say, each of the functional blocks may be formed as one processor or one integrated circuit. The functional block may be configured by using any method.

Note that the control unit 45 may be configured in a functional unit different from the above-described functional block. The operation of individual blocks (the transmission unit 451, the notification unit 452, and the detection unit 453) constituting the control unit 45 will be described below. Note that the operation of each block constituting the control unit 45 may be similar to the operation of each block (the transmission unit 231, the notification unit 232, and the detection unit 233) constituting the control unit 23 of the base station device 20.

Note that the base station device 20 in the following description is typically assumed to be a base station such as an eNB or a gNB, but of course, the base station device 20 is not limited to the eNB or the gNB. For example, the base station device 20 may be a relay terminal or a terminal such as a leader terminal in a terminal group. In addition, the base station device 20 may be the device (or system) exemplified in <2-1. Overall configuration of communication system> and the like. In this case, the description of the “base station device 20” in the following description can be appropriately replaced with the “relay device 30” or the “terminal device 40”.

Although the following description includes a portion described by indicating a specific value as a specific example, the value does not have to be the value in the example, and other values may be used.

In addition, the concept of “resource” includes Frequency, Time, Resource Element, Resource Block, Bandwidth Part, Component Carrier, Symbol, Sub-Symbol, Slot, Mini-Slot, Subframe, Frame, PRACH occasion, Occasion, Code, Multi-access physical resource, Multi-access signature, and the like. Naturally, the resource is not limited thereto.

<<3. Overview of Assumed System>>

In an assumed system of the communication system 1, a radio system includes a base station device and a terminal device, and performs radio communication of different quality of service (QoS) of an eMBB signal and a URLLC signal between the base station device and the terminal device, for example.

The eMBB signal and the URLLC signal have a difference in the length of allocated resource in addition to the difference in QoS. Specifically, the length of the channel (such as PDSCH/PUSCH/PUCCH) allocated to the URLLC signal tends to be shorter than the length of the channel allocated to the eMBB signal.

In addition, there is a difference in a channel quality indicator (CQI) table between the eMBB signal and the URLLC signal. The CQI table applied to the eMBB signal includes high amounts of high-efficiency modulation and coding rates, while the CQI table applied to the URLLC signal includes high amounts of low-efficiency modulation and coding rates. Specifically, the CQI table applied to the eMBB signal contains 256 QAM, and the CQI table applied to the URLLC signal does not include 256 QAM. In comparison between the CQI table applied to the eMBB signal and the CQI table applied to the URLLC signal, the CQI error rate table applied to the eMBB signal is more efficient when an identical index is used.

In addition, the eMBB signal and the URLLC signal use different Modulation and Coding Scheme (MCS) tables. The MCS table applied to the eMBB signal includes high amounts of high-efficiency modulation and coding rates, while the MCS table applied to the URLLC signal includes high amounts of low-efficiency modulation and coding rates. Specifically, in comparison between the MCS table applied to the eMBB signal and the MCS table applied to the URLLC signal, the MCS table applied to the eMBB signal is more efficient when an identical index is used.

In addition, the eMBB signal and the URLLC signal are also different in the applicability of repetitive transmission setting. While the repetitive transmission setting is not applied to the eMBB signal, the repetitive transmission setting is applied to the URLLC signal.

In addition, the eMBB signal and the URLLC signal have different PDSCH/PUSCH mapping types. Specifically, there is a tendency that the eMBB signal applies slot-based scheduling (PDSCH/PUSCH mapping type A), while the URLLC signal applies non-slot-based scheduling (PDSCH/PUSCH mapping type B). The slot-based scheduling is a method in which a resource is allocated from the head of the slot on the time axis, while the non-slot-based scheduling is a method in which a resource can be allocated from the middle of the slot on the time axis.

<3-1. Configuration of Assumed System 1A>

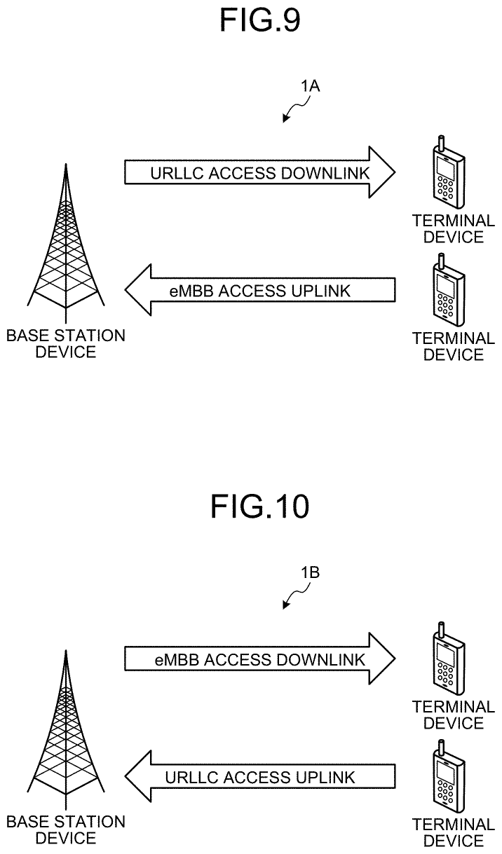

FIG. 9 is a diagram illustrating a configuration example of an assumed system 1A according to an embodiment of the present disclosure. The assumed system 1A includes one base station device and two terminal devices. While transmitting a URLLC signal to one terminal device by using an access downlink, the base station device receives an eMBB signal from the other terminal device by using an access uplink. The base station device and the other terminal device that transmits the eMBB signal are assumed to be capable of executing the in-band full-duplex communication operation.

<3-2. Configuration of Assumed System 1B>

FIG. 10 is a diagram illustrating a configuration example of an assumed system 1B according to the embodiment of the present disclosure. The assumed system 1B includes one base station device and two terminal devices. While transmitting an eMBB signal to one terminal device by using an access downlink, the base station device receives a URLLC signal from the other terminal device by using an access uplink. The base station device is assumed to be capable of executing the in-band full-duplex communication operation.

<3-3. Configuration of Assumed System 1C>

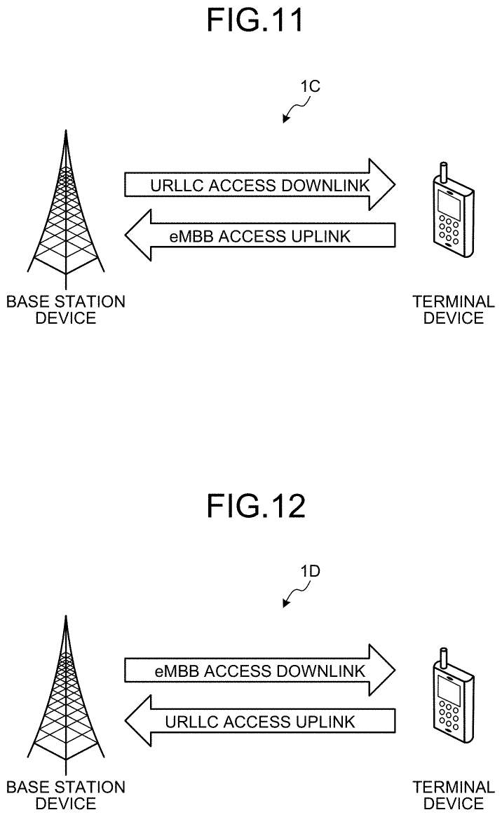

FIG. 11 is a diagram illustrating a configuration example of an assumed system 1C according to the embodiment of the present disclosure. The assumed system 1C includes one base station device and one terminal device. While transmitting a URLLC signal to the terminal device by using an access downlink, the base station device receives an eMBB signal from the terminal device by using an access uplink. The base station device and the terminal device are assumed to be capable of executing the in-band full-duplex communication operation.

<3-4. Configuration of Assumed System 1D>

FIG. 12 is a diagram illustrating a configuration example of an assumed system 1D according to the embodiment of the present disclosure. The assumed system 1D includes one base station device and one terminal device. While transmitting an eMBB signal to the terminal device by using an access downlink, the base station device receives a URLLC signal from the terminal device by using an access uplink. The base station device and the terminal device are assumed to be capable of executing the in-band full-duplex communication operation.

<3-5. Configuration of Assumed System 1E>

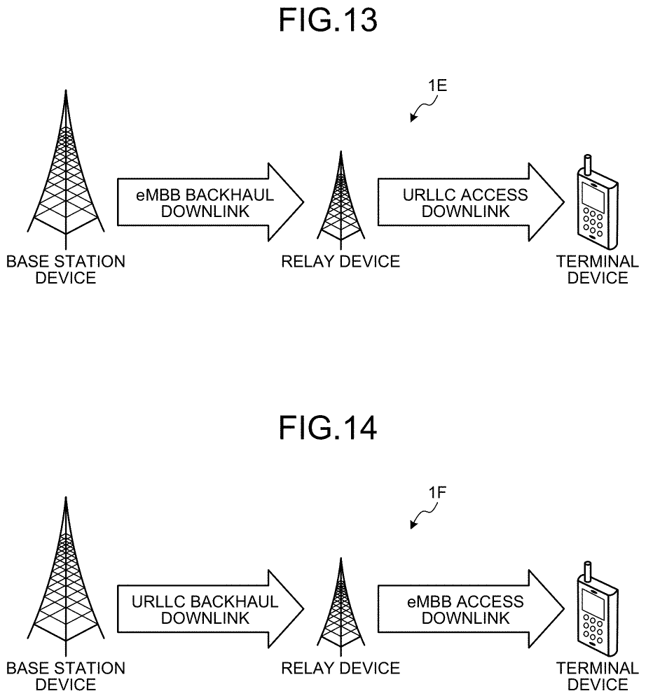

FIG. 13 is a diagram illustrating a configuration example of an assumed system 1E according to the embodiment of the present disclosure. The assumed system 1E includes one base station device, one relay device, and one terminal device. While the base station device transmits an eMBB signal to the relay device by using a backhaul downlink, the relay device transmits a URLLC signal to the terminal device by using an access downlink. The base station device and the relay device are assumed to be capable of executing the in-band full-duplex communication operation.

<3-6. Configuration of Assumed System 1F>

FIG. 14 is a diagram illustrating a configuration example of an assumed system 1F according to the embodiment of the present disclosure. The assumed system 1F includes one base station device, one relay device, and one terminal device. While the base station device transmits a URLLC signal to the relay device by using a backhaul downlink, the relay device transmits an eMBB signal to the terminal device by using an access downlink. The base station device and the relay device are assumed to be capable of executing the in-band full-duplex communication operation.

<3-7. Configuration of Assumed System 1G>

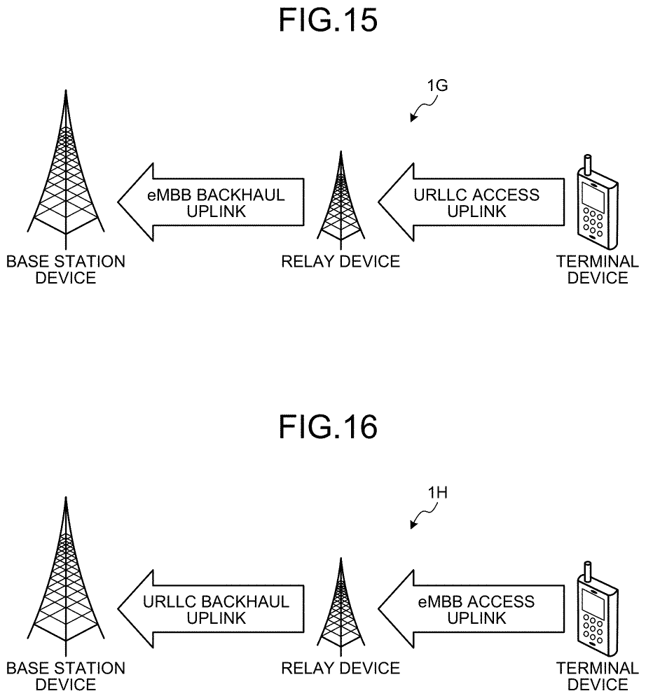

FIG. 15 is a diagram illustrating a configuration example of an assumed system 1G according to the embodiment of the present disclosure. The assumed system 1G includes one base station device, one relay device, and one terminal device. While the terminal device transmits a URLLC signal to the relay device by using the access uplink, the relay device transmits an eMBB signal to the base station device by using a backhaul uplink. The base station device and the relay device are assumed to be capable of executing the in-band full-duplex communication operation.

<3-8. Configuration of Assumed System 1H>

FIG. 16 is a diagram illustrating a configuration example of an assumed system 1H according to the embodiment of the present disclosure. The assumed system 1H includes one base station device, one relay device, and one terminal device. While the terminal device transmits an eMBB signal to the relay device by using the access uplink, the relay device transmits a URLLC signal to the base station device by using a backhaul uplink. The base station device and the relay device are assumed to be capable of executing the in-band full-duplex communication operation.

<3-9. Configuration of Assumed System 1J>

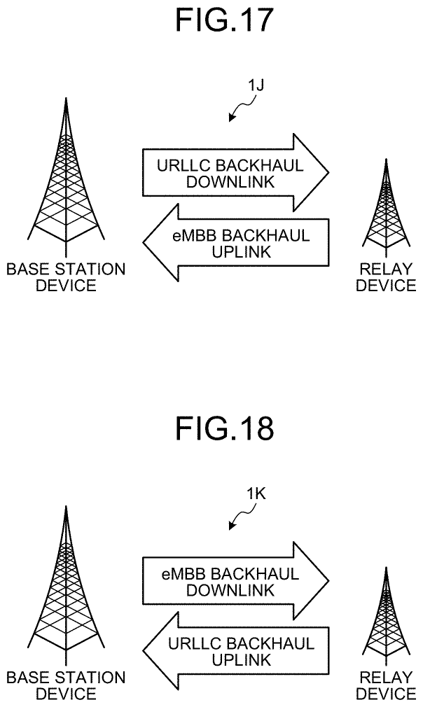

FIG. 17 is a diagram illustrating a configuration example of an assumed system 1J according to the embodiment of the present disclosure. The assumed system 1J includes one base station device and one relay device. While transmitting a URLLC signal to the relay device using the backhaul downlink, the base station device receives an eMBB signal from the relay device using the backhaul uplink. The base station device and the relay device are assumed to be capable of executing the in-band full-duplex communication operation.

<3-10. Configuration of Assumed System 1K>

FIG. 18 is a diagram illustrating a configuration example of an assumed system 1K according to the embodiment of the present disclosure. The assumed system 1K includes one base station device and one relay device. While transmitting an eMBB signal to the relay device using the backhaul downlink, the base station device receives a URLLC signal from the relay device using the backhaul uplink. The base station device and the relay device are assumed to be capable of executing the in-band full-duplex communication operation.

<3-11. Configuration of Assumed System 1L>

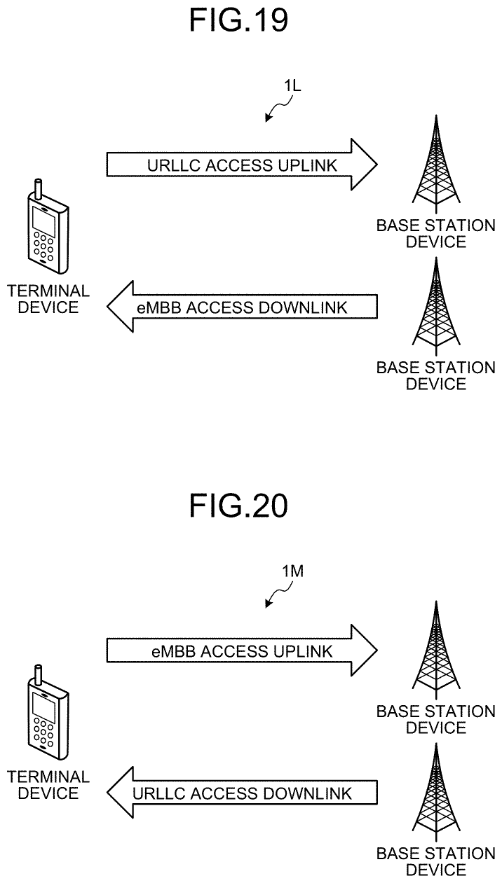

FIG. 19 is a diagram illustrating a configuration example of an assumed system 1L according to the embodiment of the present disclosure. The assumed system 1L includes two base station devices and one terminal device. While transmitting a URLLC signal to one base station device by using an access uplink, the terminal device receives an eMBB signal from the other base station device by using an access downlink. The terminal device is assumed to be capable of executing the in-band full-duplex communication operation.

<3-12. Configuration of Assumed System 1M>

FIG. 20 is a diagram illustrating a configuration example of an assumed system 1M according to the embodiment of the present disclosure. The assumed system 1M includes two base station devices and one terminal device. While transmitting an eMBB signal to one base station device by using an access uplink, the terminal device receives a URLLC signal from the other base station device by using an access downlink. The terminal device is assumed to be capable of executing the in-band full-duplex communication operation.

<<4. Overview of Signals to be Used>>

Next, examples of the eMBB signal include audio data, video data, and streaming data. Exemplary requirement values for the audio data are: allowable delay of 100 msec, and the packet error rate of 10⁻². Exemplary requirement values for the video data are: allowable delay of 150 msec, and the packet error rate of 10⁻³. Exemplary requirement values for the streaming data are: allowable delay of 300 msec, and the packet error rate of 10⁻⁶.

Furthermore, examples of the URLLC signal include sensor data/control signals of robots, sensor data/control signals of remote control of cars, trains, and the like, and sensor data/control signals of power distribution systems. Exemplary requirement values for the sensor data and control signal of a robot are: allowable delay of 10 msec, and the packet error rate of 10⁻⁴. Exemplary requirement values for the sensor data and control signal in remote control of cars and trains are: allowable delay of 30 msec, and the packet error rate of 10⁻³. Exemplary requirement values for the sensor data and control signal of a power distribution system are: allowable delay of 5 msec, and the packet error rate of 10⁻³.

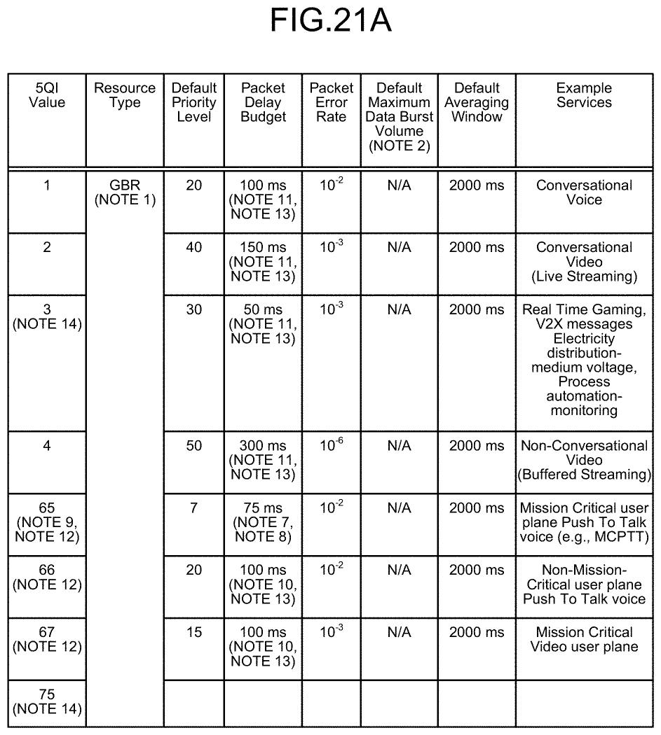

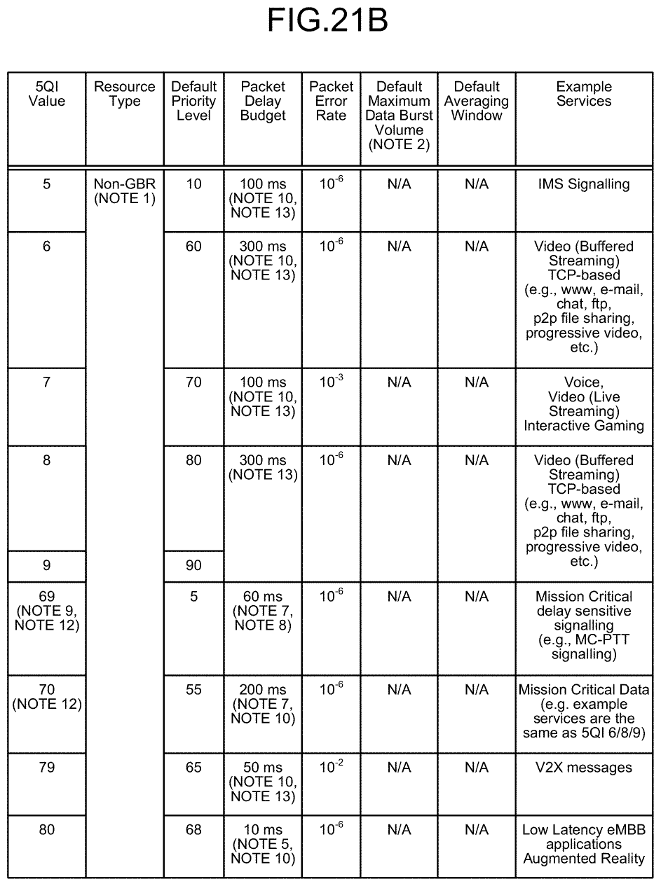

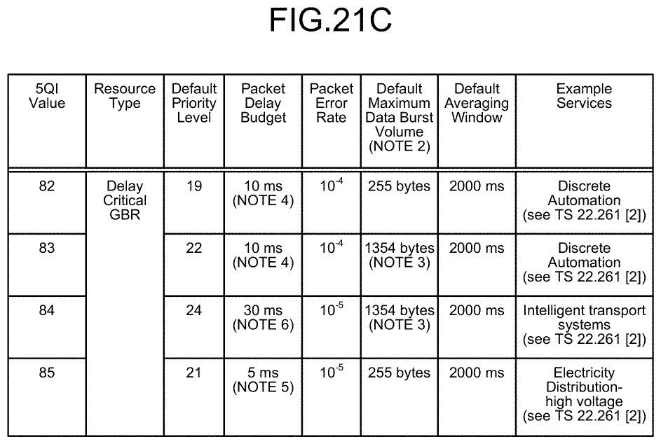

The allowable delay (also referred to as a packet delay budget) and the packet error rate of each signal are requirement values in the network layer. In a 4G system in 3GPP, QoS requirement values are classified as a QoS class identifier (QCI). In a 5G system in 3GPP, a QoS requirement value is classified as a 5G QoS Identifier (5QI). FIGS. 21A to 21C are correspondence tables of data types and QoS requirement values of 5G. The QoS requirement values (QoS characteristics) define information such as Resource Type, Default Priority Level, Packet Delay Budgets (PDB), Packet Error Rate), Default Maximum Data Burst Volume, and Default Averaging Window.

Resource Type is information determined at the time of allocation of a dedicated network resource related to a guaranteed flow bit rate (GFBR) value of a QoS flow level. Resource Type is information classified into one of Guaranteed Bit Rate (GBR), critical GBR, or Non-GBR. Priority Level is information indicating priority of a scheduling resource between QoS flows. Packet Delay Budget is a maximum allowable value of a delay time between the UPF and the terminal device terminated on the N6 interface. Packet Error Rate is an allowable value for an error rate of a PDU (for example, an IP packet) in a link layer protocol (for example, the RLC layer in the RAN defined in 3GPP). Default Averaging Window is a section calculated by GFBR and a maximum flow bit rate (MFBR).

Mapping between QoS and data in 3GPP is performed in Service Data Adaptation Protocol (SDAP) layer, for example. Specifically, in the SDAP layer, an identifier indicating QoS corresponding to the IP flow is included in the header and notification thereof is provided.

As an example of mapping between a data type and a QoS index in IEEE, for example, the QoS index is defined as a terminal priority (User Priority: UP) in IEEE. IEEE defines the following eight terminal priorities and types of data (traffic) corresponding to indexes thereof.
7: Network management traffic
6: Voice traffic with less than 10 ms latency
5: Video traffic with less than 100 ms latency
4: “Controlled-load” traffic for mission-critical data applications
3: Traffic meriting “extra-effort” by the network for prompt delivery, for example, executives' e-mail
2: Reserved for future use
0: Traffic meriting the network's “best-effort” for prompt delivery. This is the default priority.
1: Background traffic such as bulk data transfers and backups

<<5. In-Band Full-Duplex Communication Setting Operation>>

<5-1. Operation sequence at the time of setting in-band full-duplex communication>

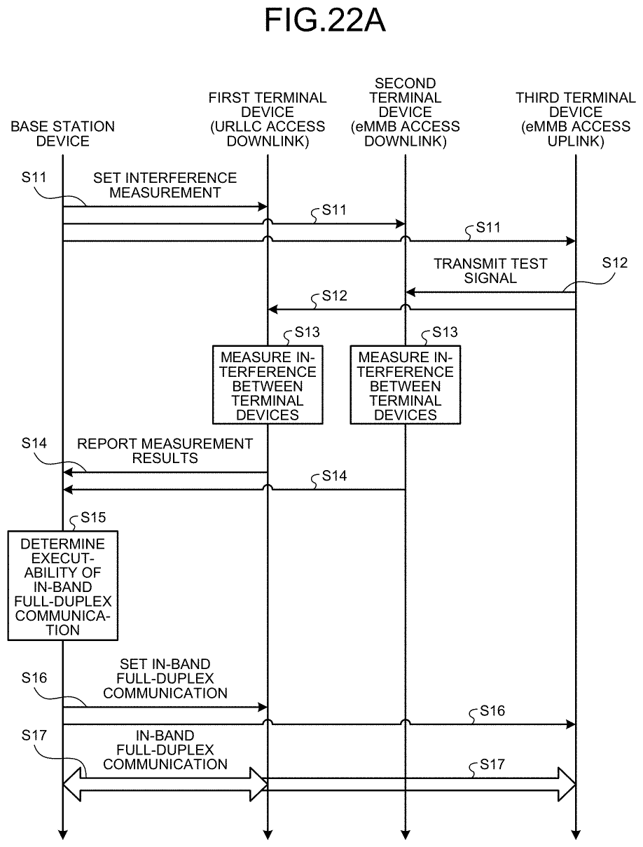

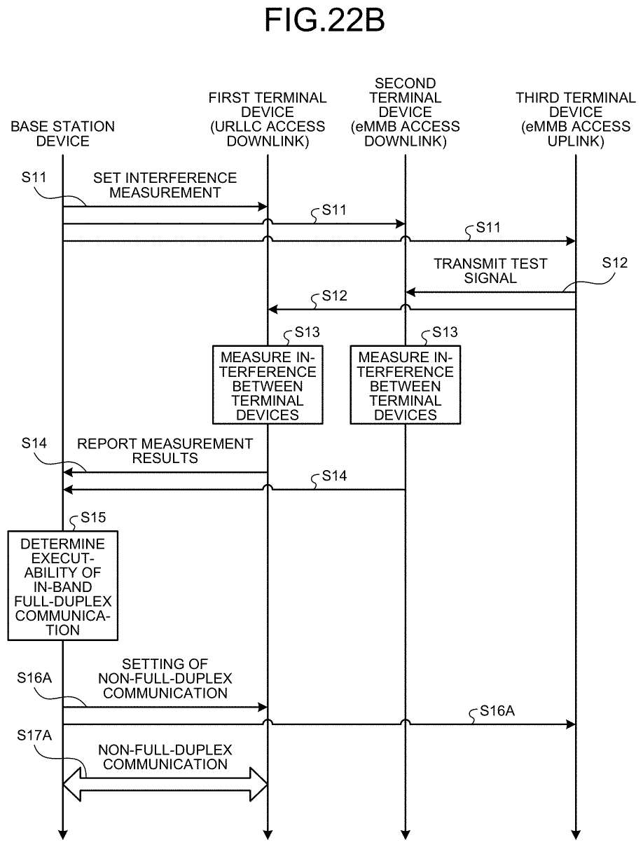

FIG. 22A is a diagram illustrating an example of an operation sequence at the setting of full-duplex communication. In an assumed case, the base station device illustrated in FIG. 22A transmits a URLLC signal to a first terminal device by using an access downlink, transmits an eMBB signal to a second terminal device by using an access downlink, and receives an eMBB signal from a third terminal device by using an access uplink.

In FIG. 22A, the base station device sets an inter-terminal device interference measurement for the first terminal device, the second terminal device, and the third terminal device (Step S11). When having detected the interference measurement setting, each terminal device transmits a test signal to other terminal devices (Step S12). For example, the first terminal device transmits a test signal to the second terminal device and the third terminal device as the other terminal devices, and the second terminal device transmits a test signal to the first terminal device and the third terminal device as the other terminal devices. The third terminal device transmits a test signal to the first terminal device and the second terminal device as the other terminal devices. When having received a test signal from another terminal device, each terminal device measures inter-terminal device interference (Step S13). Each terminal device transmits a measurement result of the inter-terminal device interference to the base station device (Step S14).

When having received the measurement result of the inter-terminal device interference from each terminal device, the base station device determines executability of the in-band full-duplex communication based on the measurement result (Step S15). When having determined that the in-band full-duplex communication is executable, the base station device instructs the first terminal device on the URLLC access downlink and the third terminal device on the eMBB access uplink to set the in-band full-duplex communication (Step S16). The base station device sets the in-band full-duplex communication between the access downlink of the URLLC signal and the access uplink of the eMBB signal (Step S17). As a result, the base station device receives the eMBB signal from the third terminal device through the access uplink while transmitting the URLLC signal through the access downlink to the first terminal device by using the identical frequency band.

<5-2. Operation Sequence at the Time of Setting Non-Full-Duplex Communication>

FIG. 22B is a diagram illustrating an example of a communication sequence at the setting of non-full-duplex communication. Note that the same reference numerals are given to the same configurations as those of the FIG. 22B, and description of duplicated configurations and operations will be omitted. When having determined that the in-band full-duplex communication is not executable, the base station device instructs each terminal device to set a non-full-duplex communication (Step S16A). Note that the non-full-duplex communication is, for example, a communication scheme other than the in-band full-duplex communication, and is, for example, out-band full-duplex communication, single-link communication within a predetermined time, and the like. The base station device suspends transmitting the eMBB signal on the access uplink to the third terminal device, and sets, to the first terminal device, non-full-duplex communication, which is single-link communication, with the access downlink of the URLLC signal (Step S17A). As a result, the base station device suspends transmitting the eMBB signal to the third terminal device, and transmits a URLLC signal to the first terminal device.

<5-3. In-Band Full-Duplex Communication Executability Determination Processing Flow>

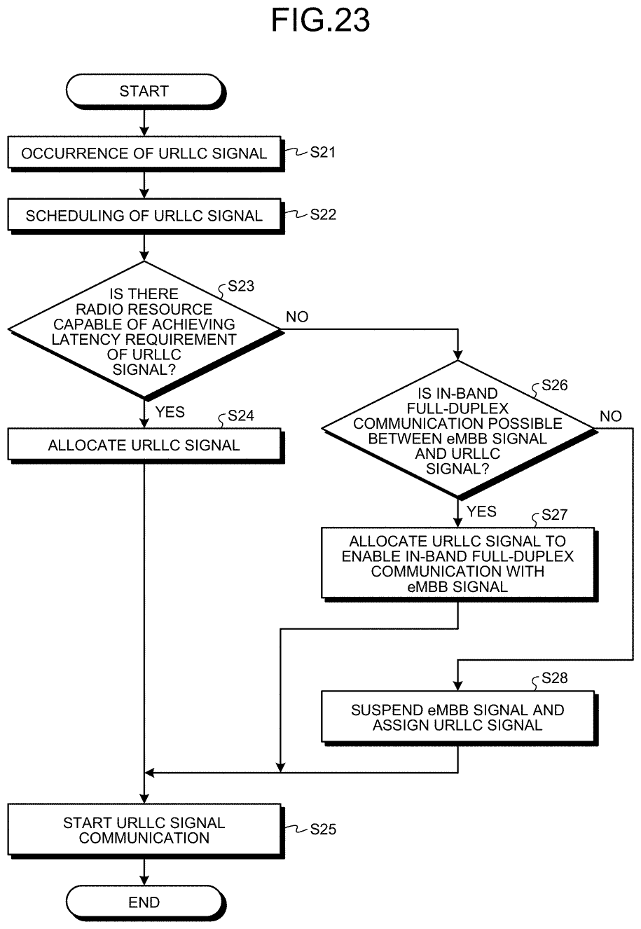

FIG. 23 is a diagram illustrating an example of an in-band full-duplex communication executability determination processing flow. Note that the in-band full-duplex communication executability determination processing flow is the content of the determination processing in Step S15 in FIGS. 22A and 22B. Triggered by the generation of the URLLC signal (Step S21), the base station device starts a series of determination operations. First, the base station device executes scheduling of the generated URLLC signal (Step S22). The base station device determines whether there is a radio resource capable of achieving the latency requirement of the URLLC signal (Step S23).

In a case where there is a radio resource capable of achieving the latency requirement of the URLLC signal (Step S23: Yes), the base station device allocates a URLLC signal to the radio resource to be allocated (Step S24), starts URLLC signal communication (Step S25), and ends the processing operation illustrated in FIG. 23.

When there is no radio resource capable of achieving the latency requirement of the URLLC signal (Step S23: No), the base station device determines whether the in-band full-duplex communication is executable between the eMBB signal and the URLLC signal based on the channel state information including the inter-terminal device interference measured in advance (Step S26). The determination of No in Step S23 is made in a case where all the radio resources capable of achieving the latency requirement of the URLLC signal have been scheduled to other links (for example, the eMBB signal).

When the in-band full-duplex communication is executable between the eMBB signal and the URLLC signal (Step S26: Yes), the base station device allocates a URLLC signal to the scheduled radio resource so as to achieve the in-band full-duplex communication with the eMBB signal (Step S27), and starts URLLC signal communication using the allocated radio resource (Step S25). When the in-band full-duplex communication is not executable between the eMBB signal and the URLLC signal (Step S26: No), the base station device suspends the eMBB signal, allocates the URLLC signal to the scheduled radio resource (Step S28), and starts URLLC signal communication using the allocated radio resource (Step S25). Note that Step S28 is processing of executing non-full-duplex communication of executing communication of the URLLC signal in a single link.

<<6. URLLC Signal Communication Protection Processing in In-Band Full-Duplex Communication>>

The URLLC signal communication protection processing in in-band full-duplex communication is processing performed at the occurrence of a URLLC signal, and this processing suppresses transmission power of an eMBB signal being transmitted so as to suppress signal interference to the URLLC signal by the eMBB signal. The present embodiment describes an exemplary case where a URLLC signal requiring a low latency severer than an eMBB signal is determined as a target to be protected in communication, and an eMBB signal is determined as a target to which suppression of transmission power is to be requested. However, the targets are not limited to the URLLC signal and the eMBB signal, and alterations are possible in this regard as appropriate. For example, the processing is also applicable when protecting a signal of a predetermined level of QoS requirement so as to request suppressing of transmission power for a signal of a QoS requirement level lower than the predetermined QoS requirement level. Note that the processing of suppressing signal interference does not have to be the suppression of transmission power but may be the suspension of signal transmission, and alterations are possible in this regard as appropriate. In addition, an interfering station is defined as a base station, a terminal, or a relay station that is transmitting an eMBB signal at an occurrence of a URLLC signal in a certain radio station. The base station, the terminal, or the relay station that transmits the URLLC signal shall determine whether the communication quality can be achieved on the reception side before transmitting the URLLC signal, based on measurement information collected in advance. Note that the measurement information is, for example, a measurement result of the inter-terminal device interference measured in advance.

The control unit 23 of the base station device 20 includes a transmission unit 231, a notification unit 232, and a detection unit 233. The transmission unit 231 transmits a second signal (for example, a URLLC signal) for which low latency severer than that for the first signal (for example, an eMBB signal) is required. When transmitting the second signal, the notification unit 232 notifies another communication device that transmits the first signal of a request signal containing information requesting suppression of transmission power of the first signal. The detection unit 233 detects interference of the first signal with the second signal. When having detected the interference of the first signal with the second signal, the notification unit 232 notifies the another communication device of the request signal.

The control unit 34 of the relay device 30 includes a transmission unit 341, a notification unit 342, and a detection unit 343. The transmission unit 341 transmits a second signal (for example, a URLLC signal) for which low latency severer than that for the first signal (for example, an eMBB signal) is required. When transmitting the second signal, the notification unit 342 notifies another communication device that transmits the first signal of a request signal containing information requesting suppression of transmission power of the first signal. The detection unit 343 detects interference of the first signal with the second signal. When having detected the interference of the first signal with the second signal, the notification unit 342 notifies the another communication device of the request signal.

The control unit 45 of the terminal device 40 includes a transmission unit 451, a notification unit 452, and a detection unit 453. The transmission unit 451 transmits a second signal (for example, a URLLC signal) for which low latency severer than that for the first signal (for example, an eMBB signal) is required. When transmitting the second signal, the notification unit 452 notifies another communication device that transmits the first signal of a request signal containing information requesting suppression of transmission power of the first signal. The detection unit 453 detects interference of the first signal with the second signal. When having detected the interference of the first signal with the second signal, the notification unit 452 notifies the another communication device of the request signal.

<6-1. Mode of Transmitting Request Signal Using Band Same as Band Used for Transmitting URLLC Signal>

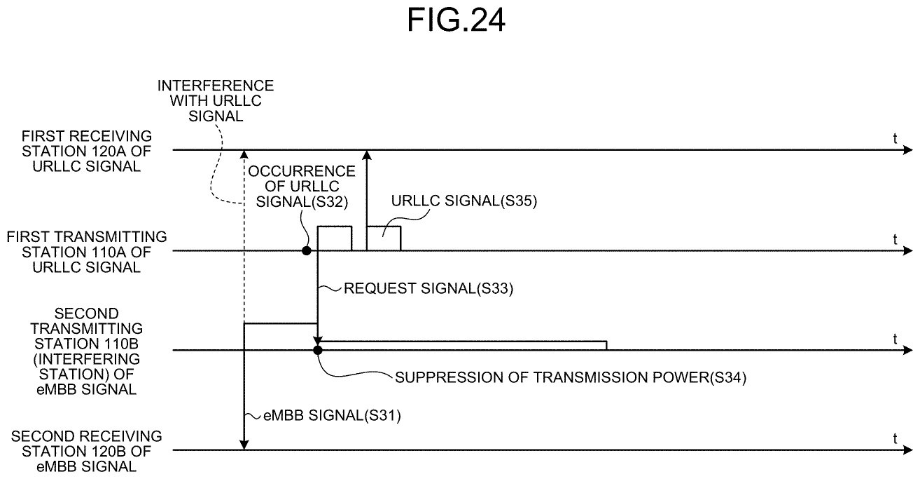

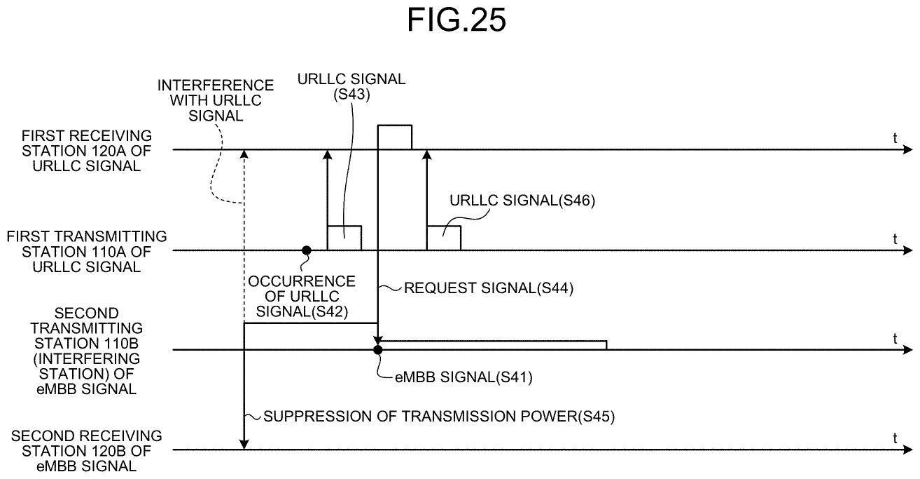

The following will describe an example of transmitting information (request information or request signal) requesting suppression of transmission power using the band same as the band used for transmitting the URLLC signal. The present embodiment is an embodiment in a case of using the in-band full-duplex communication. FIGS. 24 and 25 are applicable to the assumed systems 1A to 1M.

<6-1-1. Configuration and Operation of First Embodiment>

FIG. 24 is a diagram illustrating an example of URLLC signal protection processing according to a first embodiment of the present disclosure. In the URLLC signal protection processing of the first embodiment, a first transmitting station 110A for a URLLC signal transmits a request signal. The communication system illustrated in FIG. 24 includes: the first transmitting station 110A that transmits a URLLC signal; a first receiving station 120A that receives a URLLC signal; a second transmitting station 110B that transmits an eMBB signal; and a second receiving station 120B that receives an eMBB signal. The first transmitting station 110A transmits a URLLC signal to the first receiving station 120A. Note that the first transmitting station 110A is, for example, a base station, a terminal, a relay station, or a relay that transmits a URLLC signal. Furthermore, the second transmitting station 110B transmits the eMBB signal to the second receiving station 120B. For convenience of description, the second transmitting station 110B is assumed to be an interfering station in which the eMBB signal interferes with the URLLC signal because of the eMBB signal being transmitted by the second transmitting station 110B.

The second transmitting station 110B is transmitting an eMBB signal to the second receiving station 120B (Step S31). At this time, for example, when the URLLC signal is transmitted from the first transmitting station 110A to the first receiving station 120A, the eMBB signal being transmitted is interfering with the URLLC signal, that is, causing a state of signal interference. Therefore, the first transmitting station 110A judges that the communication quality of the URLLC signal cannot be achieved.

When the URLLC signal has occurred (Step S32), the first transmitting station 110A transmits a request signal for requesting suppression of transmission power to the interfering station (the second transmitting station 110B) before transmitting the URLLC signal (Step S33). When having received the request signal, the interfering station (second transmitting station 110B) suppresses the transmission power of the eMBB signal based on the request information (Step S34). Based on the request information, the second transmitting station 110B suppresses the transmission power of the eMBB signal so as to satisfy the QoS requirement of the URLLC signal. As a result, the interfering station (second transmitting station 110B) can avoid signal interference to the URLLC signal by suppressing the transmission power of the eMBB signal. After transmitting the request signal, the first transmitting station 110A transmits a URLLC signal to the first receiving station 120A (Step S35). As a result, the first receiving station 120A can receive the URLLC signal by avoiding signal interference of the eMBB signal from the interfering station (second transmitting station 110B).

In the first embodiment, the request signal is transmitted from the first transmitting station 110A of the URLLC signal to the second transmitting station 110B of the eMBB signal in the identical band, the second transmitting station 110B suppresses the transmission power of the eMBB signal. Subsequently, the first transmitting station 110A transmits a URLLC signal during the transmission power suppression of the eMBB signal. As a result, it is possible to avoid signal interference to the URLLC signal by the eMBB signal in the identical band. Even in a case where there is an interfering station transmitting an interference signal, it is possible to generate a channel state capable of achieving desired transmission quality of a URLLC signal, leading to achievement of low-latency and high-reliability communication.

<6-1-2. Configuration and Operation of Second Embodiment>

FIG. 25 is a diagram illustrating an example of URLLC signal protection processing according to a second embodiment of the present disclosure. In the URLLC signal protection processing of the second embodiment, a first receiving station 120A for a URLLC signal transmits a request signal. The communication system illustrated in FIG. 25 includes: a first transmitting station 110A that transmits a URLLC signal; a first receiving station 120A that receives a URLLC signal; a second transmitting station 110B that transmits an eMBB signal; and a second receiving station 120B that receives an eMBB signal. The first transmitting station 110A transmits a URLLC signal to the first receiving station 120A. The second transmitting station 110B transmits an eMBB signal to the second receiving station 120B.

The second transmitting station 110B is transmitting an eMBB signal to the second receiving station 120B (Step S41). At this time, for example, when the URLLC signal is transmitted from the first transmitting station 110A to the first receiving station 120A, the eMBB signal being transmitted is interfering with the URLLC signal, that is, causing a state of signal interference.

When the URLLC signal has occurred (Step S42), the first transmitting station 110A transmits a URLLC signal to the first receiving station 120A (Step S43). There are two possible cases where the first transmitting station 110A performs a retransmission operation of the URLLC signal after being notified of an acknowledgement signal such as ACK/NACK from the first receiving station 120A every time the URLLC signal is transmitted, and a case where the first transmitting station 110A repeatedly transmits the URLLC signal at regular intervals until the acknowledgement signal is transmitted from the first receiving station 120A. When having not correctly received the URLLC signal, the first receiving station 120A transmits a request signal to the interfering station (second transmitting station 110B) (Step S44).

When having received the request signal, the second transmitting station 110B suppresses the transmission power of the eMBB signal based on the request signal (Step S45). As a result, the second transmitting station 110B can avoid signal interference to the URLLC signal by suppressing the transmission power of the eMBB signal. After the second transmitting station 110B suppresses the transmission power, the first transmitting station 110A transmits a URLLC signal to the first receiving station 120A. As a result, the first receiving station 120A can receive the URLLC signal by avoiding signal interference of the eMBB signal from the interfering station 110B.

In the second embodiment, the request signal is transmitted from the first receiving station 120A of the URLLC signal to the second transmitting station 110B of the eMBB signal in the identical band, the second transmitting station 110B suppresses the transmission power of the eMBB signal. Subsequently, the first transmitting station 110A transmits a URLLC signal during the transmission power suppression of the eMBB signal. As a result, it is possible to avoid signal interference to the URLLC signal by the eMBB signal in the identical band. Even in a case where there is an interfering station transmitting an interference signal, it is possible to generate a channel state capable of achieving desired transmission quality of a URLLC signal, leading to achievement of low-latency and high-reliability communication.

Although the second embodiment is the case where the first receiving station 120A notifies the second transmitting station 110B of the request signal, it is also allowable to provide notification of an acknowledgement signal of ACK or NACK for the URLLC signal as the request signal. In this case, the interfering station (second transmitting station 110B) enables reception of an ACK or NAC acknowledgement signal for the URLLC signal.

The first and second embodiments have described a case where transmission of the request signal is performed using the band 1 which is same as the band 1 used for transmission of the URLLC signal, as the band used for transmission of the request signal. Here, a band 2 same as the band 1 used for transmission of the URLLC signal refers to a band in which the entire frequency band is the same as the band used for transmission of the URLLC signal. Furthermore, there is a case where transmission is performed using a band 2 different from the band 1 used for transmitting the URLLC signal, as a band used for transmission of the request signal. Note that the band 2 different from the band 1 used for transmission of the URLLC signal refers to a band in which a part or all of the frequency band is different from the band used for transmission of the URLLC signal. The mode of implementation will be described below.

<6-2. Mode of transmitting request signal using band different from band used for transmitting URLLC signal>

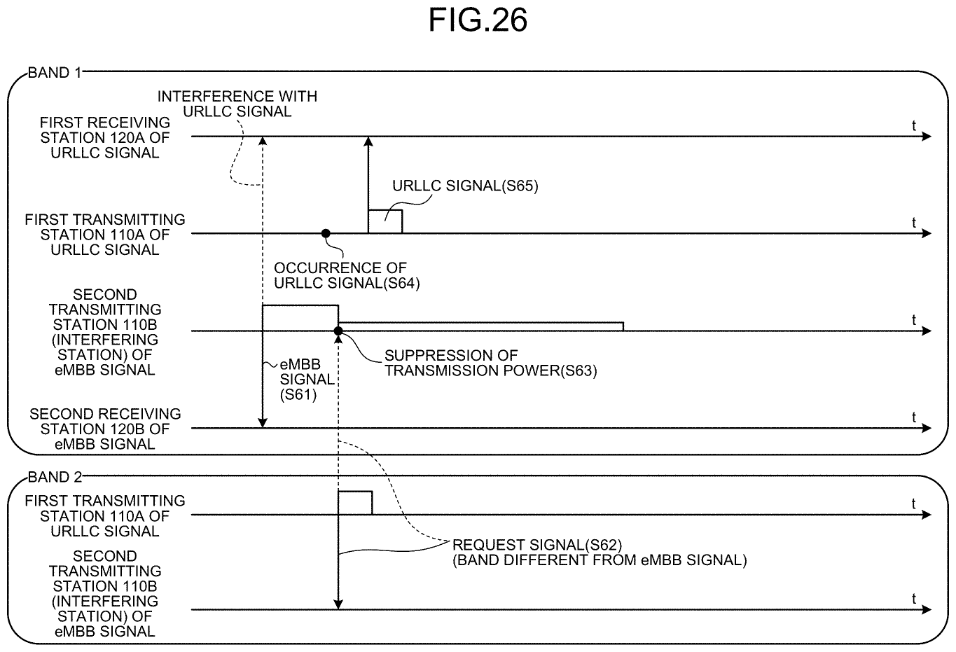

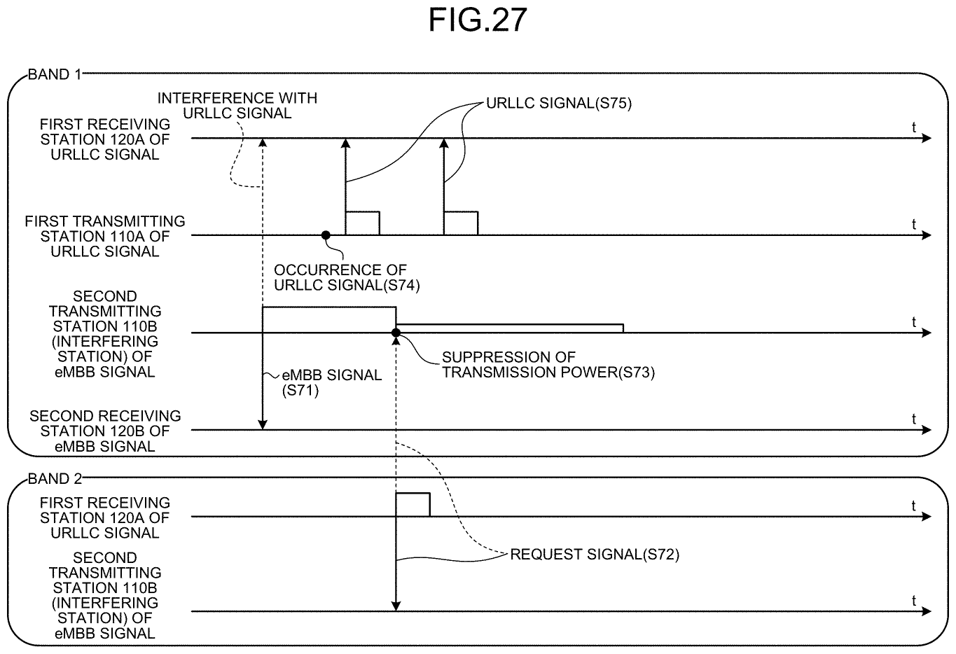

The following will describe an example of transmitting information (request information or request signal) requesting suppression of transmission power using the band 2 different from the band 1 used for transmitting the URLLC signal. FIGS. 26 and 27 are applicable to the assumed systems 1A to 1M.

<6-2-1. Configuration and Operation of Third Embodiment>

FIG. 26 is a diagram illustrating an example of URLLC signal protection processing according to a third embodiment of the present disclosure. In the URLLC signal protection processing of the third embodiment, the first transmitting station 110A of the URLLC signal transmits a request signal to the second transmitting station 110B of the eMBB signal using the band 2 different from the band 1 used for transmitting the URLLC signal. The communication system illustrated in FIG. 26 uses a mode in which the eMBB signal transmitted in the band 1 and the request signal transmitted in the band 2 are transferred by out-band full-duplex communication. The communication system includes a first transmitting station 110A, a first receiving station 120A, a second transmitting station 110B, and a second receiving station 120B. The first transmitting station 110A transmits a request signal by using the band 2, and transmits the URLLC signal by using the band 1. The first receiving station 120A receives a URLLC signal by using the band 1. The second transmitting station 110B transmits an eMBB signal by using the band 1, and receives the request signal by using the band 2. The second receiving station 120B receives an eMBB signal by using the band 1.

The first transmitting station 110A of the URLLC signal transmits a request signal using the band 2 different from the band used for the transmission of the eMBB signal. While transmitting an eMBB signal in a predetermined band (band 1), the interfering station (second transmitting station 110B) receives a request signal using the band 2 different from the band used for transmission of the eMBB signal.

The second transmitting station 110B illustrated in FIG. 26 transmits the eMBB signal to the second receiving station 120B using the band 1 (Step S61). At this time, for example, when the URLLC signal is transmitted from the first transmitting station 110A to the first receiving station 120A, the eMBB signal being transmitted is interfering with the URLLC signal, that is, causing a state of signal interference. The first transmitting station 110A transmits the request signal to the second transmitting station 110B using the band 2 different from the band 1 (Step S62). Therefore, when having received the request signal from the first transmitting station 110A, the second transmitting station 110B suppresses the transmission power of the eMBB signal based on the received request signal (Step S63). As a result, the second transmitting station 110B can avoid signal interference to the URLLC signal by suppressing the transmission power of the eMBB signal. When the URLLC signal has occurred (Step S64), the first transmitting station 110A transmits a URLLC signal to the first receiving station 120A. As a result, the first receiving station 120A can receive the URLLC signal by avoiding signal interference of the eMBB signal from the second transmitting station 110B.

In the third embodiment, the request signal using the band 2 is transmitted from the first transmitting station 110A to the second transmitting station 110B using the band 1, enabling the second transmitting station 110B to suppress the transmission power of the eMBB signal. Subsequently, the first transmitting station 110A transmits a URLLC signal during the transmission power suppression of the eMBB signal. As a result, it is possible to avoid signal interference to the URLLC signal in the band 1 by the eMBB signal in the band 1 by using the request signal in the band 2. Even in a case where there is an interfering station transmitting an interference signal, it is possible to generate a channel state capable of achieving desired transmission quality of a URLLC signal, leading to achievement of low-latency and high-reliability communication.

<6-2-2. Configuration and Operation of Fourth Embodiment>

FIG. 27 is a diagram illustrating an example of URLLC signal protection processing according to a fourth embodiment of the present disclosure. In the URLLC signal protection processing of the fourth embodiment, the first receiving station 120A of the URLLC signal transmits a request signal to the second transmitting station 110B of the eMBB signal using the band 2 different from the band 1 used for transmitting the URLLC signal. The communication system illustrated in FIG. 27 uses a mode in which the eMBB signal transmitted in the band 1 and the request signal transmitted in the band 2 are transferred by out-band full-duplex communication. The communication system includes a first transmitting station 110A, a first receiving station 120A, a second transmitting station 110B, and a second receiving station 120B. The first transmitting station 110A transmits a URLLC signal by using the band 1. The first receiving station 120A receives the URLLC signal by using the band 1, and transmits a request signal by using the band 2. The second transmitting station 110B transmits an eMBB signal by using the band 1, and receives the request signal by using the band 2. The second receiving station 120B receives an eMBB signal by using the band 1.

While transmitting an eMBB signal in a predetermined band (band 1), the interfering station (second transmitting station 110B) receives a request signal using the band 2 different from the band used for transmission of the eMBB signal. The first receiving station 120A of the URLLC signal transmits a request signal using the band 2 different from the band used for the transmission of the eMBB signal.

The second transmitting station 110B illustrated in FIG. 27 transmits the eMBB signal to the second receiving station 120B using the band 1 (Step S71). At this time, for example, when the URLLC signal is transmitted from the first transmitting station 110A to the first receiving station 120A, the eMBB signal being transmitted is interfering with the URLLC signal, that is, causing a state of signal interference. The first receiving station 120A transmits the request signal to the second transmitting station 110B using the band 2 different from the band 1 (Step S72). Therefore, when having received the request signal from the first receiving station 120A, the second transmitting station 110B suppresses the transmission power of the eMBB signal based on the received request signal (Step S73). As a result, the second transmitting station 110B can avoid signal interference to the URLLC signal by suppressing the transmission power of the eMBB signal. When the URLLC signal has occurred (Step S74), the first transmitting station 110A transmits a URLLC signal to the first receiving station 120A (Step S75). As a result, the first receiving station 120A can receive the URLLC signal by avoiding signal interference of the eMBB signal from the second transmitting station 110B.

In the fourth embodiment, the request signal using the band 2 is transmitted from the first receiving station 120A to the second transmitting station 110B in the band 1, enabling the second transmitting station 110B to suppress the transmission power of the eMBB signal. Subsequently, the first transmitting station 110A transmits a URLLC signal during the transmission power suppression of the eMBB signal. As a result, it is possible to avoid signal interference to the URLLC signal in the band 1 by the eMBB signal in the band 1 by using the request signal in the band 2. Even in a case where there is an interfering station transmitting an interference signal, it is possible to generate a channel state capable of achieving desired transmission quality of a URLLC signal, leading to achievement of low-latency and high-reliability communication.

In the third and fourth embodiments, when the request signal is transmitted using different bands, it is preferable that a band used for transmitting the request signal is determined in advance. The band used for transmission of the request signal may be set from a radio station that transmits the request signal, may be set from a radio station that receives the request signal, may be set from an interfering station, or may be determined in advance by a regulation or a law. For example, a band used for transmitting the request signal is a reference band (for example, a primary channel, a primary component carrier, and a default bandwidth part (BWP), and the transmission of the request signal does not use a band other than the reference band (for example, a secondary channel, a secondary component carrier, or a bandwidth part other than the default bandwidth part). The band used for transmitting the request signal may be selected by the radio station that transmits the request signal among a plurality of set bands. For example, the radio station that transmits a request signal selects one band not used for transmission of the URLLC signal among the set four bands. The radio station that receives the request signal attempts the reception processing in all of the set four bands.

<6-3. Mode of Suppressing Transmission Power at Timing Away from Transmission of Request Signal>

Although the first and third embodiments have described the case where the URLLC signal is transmitted after transmission of the request signal, the transmission timing of the request signal and the transmission timing of the URLLC signal may be temporally separated.

<6-3-1. Configuration and Operation of Fifth Embodiment>

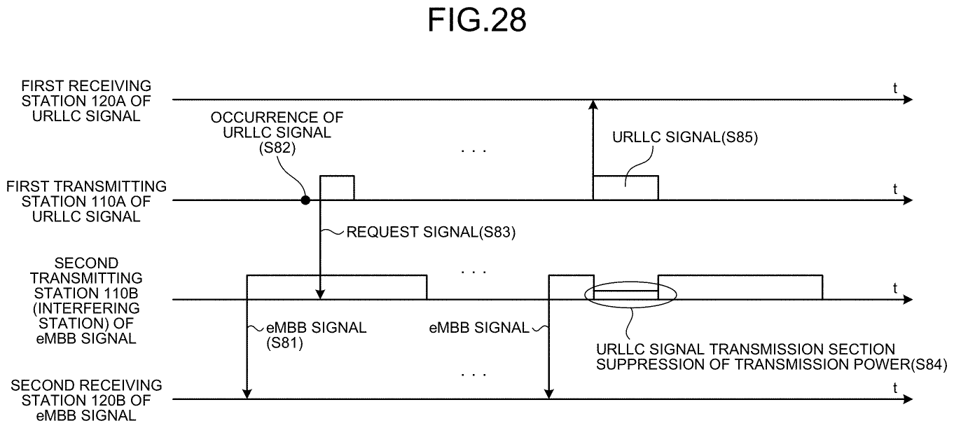

FIG. 28 is a diagram illustrating an example of URLLC signal protection processing according to a fifth embodiment of the present disclosure. In the URLLC signal protection processing of the fifth embodiment, the first transmitting station 110A of the URLLC signal transmits the request signal at a transmission timing separated from a transmission timing of the URLLC signal. The communication system illustrated in FIG. 28 includes: a first transmitting station 110A that transmits a URLLC signal; a first receiving station 120A that receives a URLLC signal; a second transmitting station 110B that transmits an eMBB signal; and a second receiving station 120B that receives an eMBB signal. The first transmitting station 110A transmits a URLLC signal to the first receiving station 120A. Furthermore, the second transmitting station 110B transmits the eMBB signal to the second receiving station 120B.

The second transmitting station 110B is transmitting an eMBB signal to the second receiving station 120B (Step S81). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S82), the first transmitting station 110A transmits a request signal for requesting suppression of transmission power to the interfering station (second transmitting station) 110B (Step S83). Note that the request signal includes section information regarding a transmission timing, a length, and a section of transmission of the URLLC signal.

When having received the request signal, the second transmitting station 110B suppresses the transmission power of the eMBB signal based on the section information of the URLLC signal in the request signal (Step S84). As a result, by suppressing the transmission power of the eMBB signal at the transmission section and the transmission timing of the URLLC signal, the second transmitting station 110B can avoid signal interference with the URLLC signal. Furthermore, the first transmitting station 110A transmits a URLLC signal to the first receiving station 120A during transmission power suppression of the eMBB signal based on the transmission section and the transmission timing of the URLLC signal (Step S85). As a result, the first receiving station 120A can receive the URLLC signal by avoiding signal interference of the eMBB signal from the interfering station 110B. That is, when having received the request signal first, the second transmitting station 110B suppresses the transmission power of the eMBB signal in the section of transmission of the URLLC signal based on the request signal.

In the fifth embodiment, the request signal containing the transmission section of the URLLC signal is transmitted from the first transmitting station 110A of the URLLC signal to the second transmitting station 110B of the eMBB signal, and thus, the second transmitting station 110B suppresses the transmission power of the eMBB signal in the transmission section of the URLLC signal. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

Note that the request signal is a signal requesting suppression of the transmission power of the eMBB signal when the suppression is capable of satisfying the QoS requirement described in the desired QoS information of the URLLC signal based on the transmission section and the transmission timing of the URLLC signal. In a case where it is judged that satisfying the QoS requirement would be difficult even with any transmission power is used for transmission, there is no need to transmit the eMBB signal in the period, and alterations are possible in this regard as appropriate. In addition, although the request signal is described as a signal that suppresses the transmission power of the eMBB signal, the request signal may be a signal that suspends the transmission of the eMBB signal instead of suppressing the transmission power of the eMBB signal, and alterations are possible in this regard as appropriate.

<6-3-2. Configuration and Operation of Sixth Embodiment>

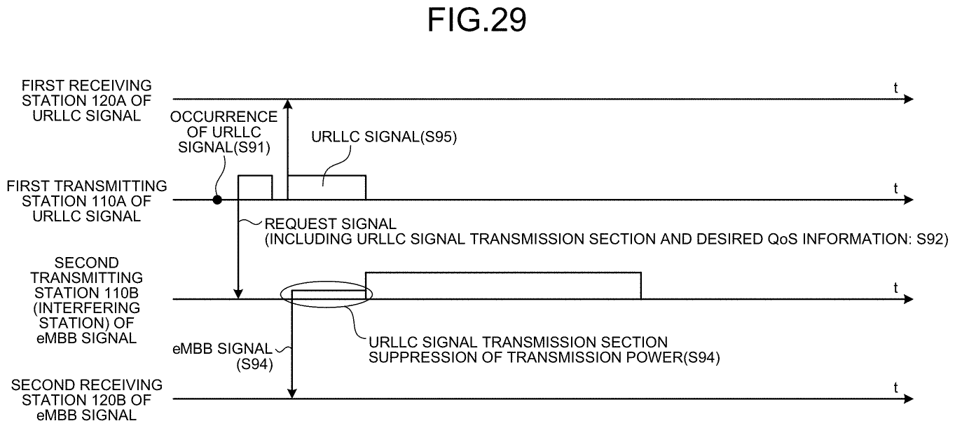

FIG. 29 is a diagram illustrating an example of URLLC signal protection processing according to a sixth embodiment of the present disclosure. In the URLLC signal protection processing of the sixth embodiment, the first transmitting station 110A of the URLLC signal transmits the request signal before the second transmitting station 110B of the eMBB signal transmits the eMBB signal. The communication system illustrated in FIG. 29 includes: a first transmitting station 110A that transmits a URLLC signal; a first receiving station 120A that receives a URLLC signal; a second transmitting station 110B that transmits an eMBB signal; and a second receiving station 120B that receives an eMBB signal. The first transmitting station 110A transmits a URLLC signal to the first receiving station 120A. Furthermore, the second transmitting station 110B transmits the eMBB signal to the second receiving station 120B.

When the URLLC signal has occurred before the interfering station transmits the eMBB signal (Step S91), the first transmitting station 110A transmits a request signal containing a transmission timing and a transmission section of the URLLC signal and desired QoS information to the second transmitting station (interfering station) 110B (Step S92). When having received the request signal and when transmitting the eMBB signal (Step S93), the second transmitting station 110B suppresses the transmission power of the eMBB signal during the transmission section of the URLLC signal based on the transmission timing, the transmission section, and the desired QoS information regarding the URLLC signal in the request signal (Step S94). As a result, the second transmitting station 110B can avoid signal interference to the URLLC signal by suppressing the transmission power of the eMBB signal. The first transmitting station 110A transmits the URLLC signal to the first receiving station 120A (Step S95). As a result, the first receiving station 120A can receive the URLLC signal by avoiding signal interference of the eMBB signal from the second transmitting station 110B.

In the sixth embodiment, even before the eMBB signal is transmitted by the interfering station, the request signal has been transmitted from the first transmitting station 110A of the URLLC signal to the second transmitting station 110B of the eMBB signal in the identical band. Accordingly, the second transmitting station 110B suppresses the transmission power of the eMBB signal in the transmission section of the URLLC signal. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

Based on the desired QoS information regarding the URLLC signal stored in the request signal, the second transmitting station 110B performs transmission with transmission power capable of achieving the desired QoS during a transmission period of the URLLC signal. However, when the second transmitting station 110B has a difficulty in achieving the desired QoS, the transmission of the eMBB signal may be suspended. Furthermore, for example, the request signal may be transmitted by broadcast toward all radio stations instead of the second transmitting station 110B, that is, a specific radio station, and alterations are possible in this regard as appropriate.

<6-4. Mode of Resetting Transmission Parameter on Interfering Station Side>

When the interfering station is to receive the request signal, the interfering station itself can reset the transmission parameter of the eMBB signal. For example, the interfering station that has received the request signal resets the transmission power, the modulation level, and/or the coding rate based on the request information. The transmission parameter is reset under the condition, for example, that the request signal includes information regarding the communication quality requirement for the URLLC signal. In the present mode, the transmitting station of the eMBB signal preferably has high performance. For example, the resetting of the transmission parameter can be applied to an environment in which the transmitting station of the eMBB signal is considered to have higher performance (assumed performance: base station>relay station>terminal) than the transmitting station of the URLLC signal, for example, environment such as the assumed system 1B (FIG. 10), the assumed system 1D (FIG. 12), the assumed system 1E (FIG. 13), the assumed system 1G (FIG. 15), and the assumed system 1K (FIG. 18).

Similarly, when a control station (base station or relay station) receives a request signal, the control station generates a transmission parameter and transmits the generated transmission parameter to the interfering station. In this case, it is assumed, for example, that a terminal or a relay station that performs transmission of the URLLC signal transmits the request signal. Furthermore, in a case where a terminal transmits a URLLC signal, it is assumed that the base station or the relay station receives the request signal. When the relay station transmits the URLLC signal, it is assumed that the base station receives the request signal.

The request signal stores information regarding the communication quality requirement for the URLLC signal. The base station or the relay station that has received the request signal generates information designating transmission power (including a true value of 0), a modulation level, and a coding rate, and/or information designating a beam direction based on the information regarding the communication quality requirement in the request signal. Subsequently, the base station or the relay station transmits the request signal containing the added the information to the interfering station. Here, the request signal is transmitted by unicast, groupcast, or broadcast. Broadcast transmission is performed in a case where an interfering station cannot be discriminated, and the like.

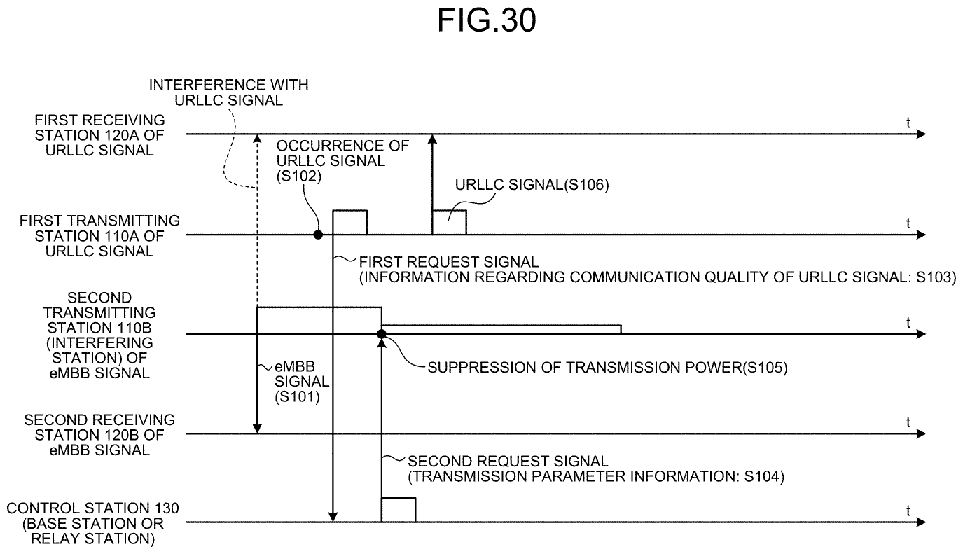

The above operation is applied to a case where the transmitting station of the URLLC signal is a terminal or a relay station and has three or more radio stations. Specifically, the above operation is applied to the assumed system 1B (FIG. 10) and the assumed system 1E (FIG. 13). Hereinafter, an embodiment will be described with reference to FIGS. 30 to 35.

<6-4-1. Configuration and Operation of Seventh Embodiment>

FIG. 30 is a diagram illustrating an example of URLLC signal protection processing according to a seventh embodiment of the present disclosure. In the URLLC signal protection processing of the seventh embodiment, the first transmitting station 110A of the URLLC signal transmits information regarding the communication quality, and a control station 130 generates the transmission parameter information of the interfering station. The communication system illustrated in FIG. 30 includes: a first transmitting station 110A that transmits a URLLC signal; a first receiving station 120A that receives a URLLC signal; a second transmitting station 110B that transmits an eMBB signal; a second receiving station 120B that receives an eMBB signal; and the control station 130. The first transmitting station 110A transmits a URLLC signal to the first receiving station 120A. Furthermore, the second transmitting station 110B transmits the eMBB signal to the second receiving station 120B. The control station 130 is, for example, a base station, a relay station, a relay station, or the like connected to the first transmitting station 110A, the first receiving station 120A, the second transmitting station 110B, the second receiving station 120B, and the like.

The second transmitting station 110B transmits an eMBB signal to the second receiving station 120B (Step S101). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S102), the first transmitting station 110A transmits a first request signal containing the information regarding the communication quality of the URLLC signal to the control station 130 before transmitting the URLLC signal (Step S103).

When having received the first request signal, the control station 130 generates transmission parameter information regarding the eMBB signal of the second transmitting station 110B based on the communication quality of the URLLC signal in the first request signal such that the communication quality of the URLLC signal satisfies the QoS requirement. The transmission parameter information is, for example, information regarding the transmission power, the modulation levels, the coding rate, and the beam direction regarding the eMBB signal.

The control station 130 transmits the second request signal containing the generated transmission parameter information to the second transmitting station 110B (Step S104). When having received the second request signal, the second transmitting station 110B suppresses the transmission power of the eMBB signal based on the transmission parameter information in the second request signal (Step S105). As a result, the second transmitting station 110B can avoid signal interference to the URLLC signal by suppressing the transmission power of the eMBB signal. The first transmitting station 110A transmits a URLLC signal to the first receiving station 120A. As a result, the first receiving station 120A can receive the URLLC signal by avoiding signal interference of the eMBB signal from the second transmitting station 110B.

When having received the first request signal, the control station 130 of the seventh embodiment generates transmission parameter information regarding the eMBB signal based on the communication quality of the URLLC signal in the first request signal such that the communication quality of the URLLC signal satisfies the QoS requirement. Furthermore, the control station 130 transmits a second request signal containing transmission parameter information to the second transmitting station 110B. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

The seventh embodiment eliminates necessity of setting all the radio stations to share the information for setting the transmission parameter needed for achieving the QoS of the URLLC signal, making it possible to reduce the overhead for signaling the information.

<6-4-2. Configuration and Operation of Eighth Embodiment>

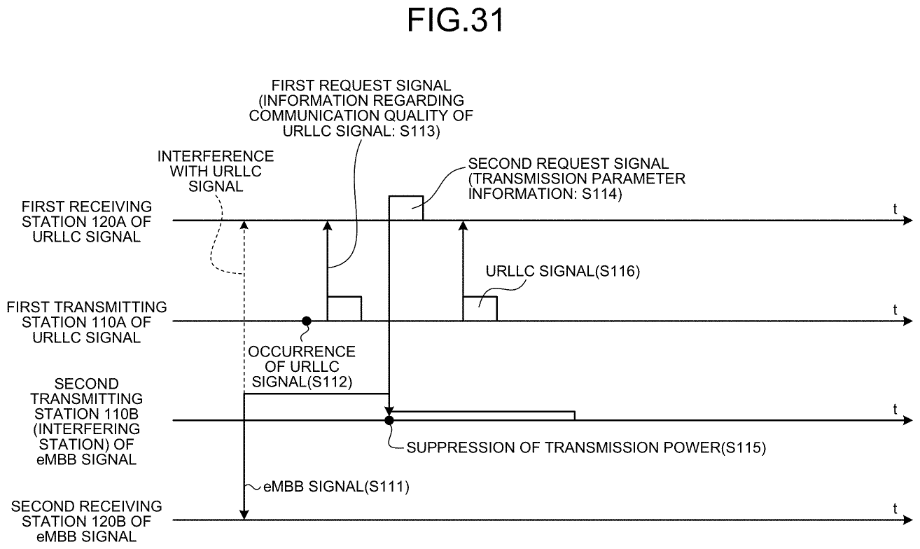

FIG. 31 is a diagram illustrating an example of URLLC signal protection processing according to an eighth embodiment of the present disclosure. In the URLLC signal protection processing of the eighth embodiment, the first transmitting station 110A of the URLLC signal transmits information regarding the communication quality, and the first receiving station 120A of the URLLC signal generates the transmission parameter information of the interfering station. The communication system illustrated in FIG. 31 includes: a first transmitting station 110A that transmits a URLLC signal; a first receiving station 120A that receives a URLLC signal; a second transmitting station 110B that transmits an eMBB signal; and a second receiving station 120B that receives an eMBB signal. The first transmitting station 110A transmits a URLLC signal to the first receiving station 120A. Furthermore, the second transmitting station 110B transmits the eMBB signal to the second receiving station 120B.

The second transmitting station 110B transmits an eMBB signal to the second receiving station 120B (Step S111). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S112), the first transmitting station 110A transmits the first request signal containing the information regarding the communication quality of the URLLC signal to the first receiving station 120A before transmitting the URLLC signal (Step S113).

When having received the first request signal, the first receiving station 120A generates transmission parameter information regarding the eMBB signal of the second transmitting station 110B based on the communication quality of the URLLC signal in the first request signal such that the communication quality of the URLLC signal satisfies the QoS requirement. The transmission parameter information is, for example, information regarding the transmission power, the modulation levels, the coding rate, and the beam direction regarding the eMBB signal.

The first receiving station 120A transmits the second request signal containing the generated transmission parameter information to the second transmitting station 110B (Step S114). When having received the second request signal, the second transmitting station 110B suppresses the transmission power of the eMBB signal based on the transmission parameter information in the second request signal (Step S115). As a result, the second transmitting station 110B can avoid signal interference to the URLLC signal by suppressing the transmission power of the eMBB signal. The first transmitting station 110A transmits the URLLC signal to the first receiving station 120A (Step S116). As a result, the first receiving station 120A can receive the URLLC signal by avoiding signal interference of the eMBB signal from the second transmitting station 110B.

When having received the first request signal, the first receiving station 120A of the URLLC signal according to the eighth embodiment generates transmission parameter information regarding the eMBB signal based on the communication quality of the URLLC signal in the first request signal such that the communication quality of the URLLC signal satisfies the QoS requirement. Furthermore, the first receiving station 120A transmits the second request signal containing the transmission parameter information to the second transmitting station 110B of the eMBB signal. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal by the eMBB signal.

The eighth embodiment eliminates necessity of setting all the radio stations to share the information for setting the transmission parameter needed for achieving the QoS of the URLLC signal, making it possible to reduce the overhead for signaling the information. Even in a case where there is an interfering station transmitting an interference signal, it is possible to generate a channel state capable of achieving desired transmission quality of a URLLC signal, leading to achievement of low-latency and high-reliability communication.

<6-4-3. Configuration and Operation of Ninth Embodiment>

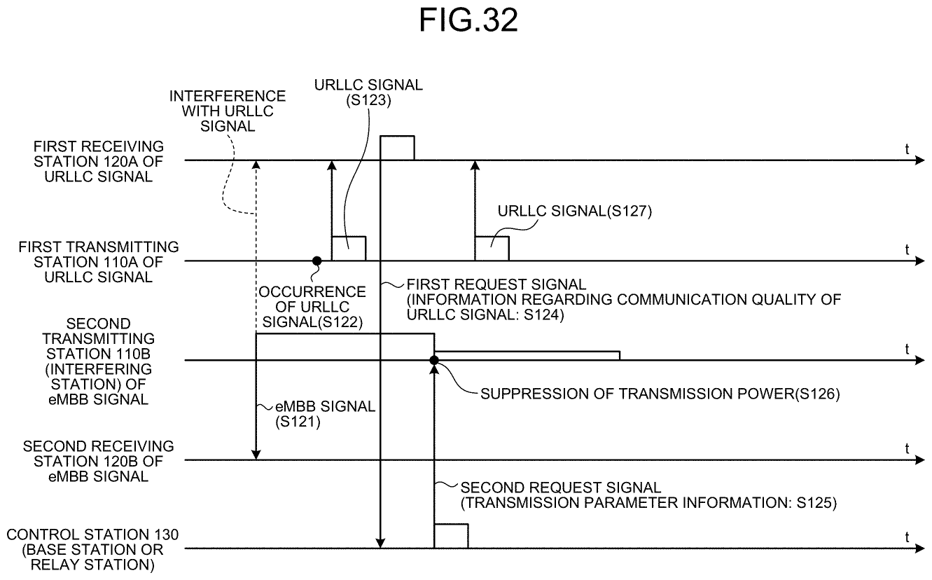

FIG. 32 is a diagram illustrating an example of URLLC signal protection processing according to a ninth embodiment of the present disclosure. In the URLLC signal protection processing of the ninth embodiment, the first receiving station 120A of the URLLC signal transmits information regarding the communication quality, and a control station 130 generates the transmission parameter information of the interfering station. The communication system illustrated in FIG. 32 includes: a first transmitting station 110A that transmits a URLLC signal; a first receiving station 120A that receives a URLLC signal; a second transmitting station 110B that transmits an eMBB signal; a second receiving station 120B that receives an eMBB signal; and the control station 130. The first transmitting station 110A transmits a URLLC signal to the first receiving station 120A. Furthermore, the second transmitting station 110B transmits the eMBB signal to the second receiving station 120B. The control station 130 is, for example, a base station, a relay station, a relay station, or the like connected to the first transmitting station 110A, the first receiving station 120A, the second transmitting station 110B, the second receiving station 120B, and the like.

The second transmitting station 110B transmits an eMBB signal to the second receiving station 120B (Step S121). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S122), the first transmitting station 110A transmits a URLLC signal to the first receiving station 120A (Step S123). When having failed in receiving the URLLC signal normally, the first receiving station 120A transmits the first request signal containing the information regarding the communication quality of the URLLC signal to the control station 130 (Step S124).

When having received the first request signal, the control station 130 generates eMBB signal transmission parameter information regarding the second transmitting station 110B of the eMBB signal based on the communication quality of the URLLC signal in the first request signal such that the communication quality of the URLLC signal satisfies the QoS requirement. The transmission parameter information is, for example, information regarding the transmission power, the modulation levels, the coding rate, and the beam direction regarding the eMBB signal.

The control station 130 transmits the second request signal containing the generated transmission parameter information to the second transmitting station 110B (Step S125). When having received the second request signal, the second transmitting station 110B suppresses the transmission power of the eMBB signal based on the transmission parameter information in the second request signal (Step S126). As a result, the second transmitting station 110B can avoid signal interference to the URLLC signal by suppressing the transmission power of the eMBB signal. The first transmitting station 110A transmits the URLLC signal to the first receiving station 120A (Step S127). As a result, the first receiving station 120A can receive the URLLC signal by avoiding signal interference of the eMBB signal from the second transmitting station 110B.

When having failed in receiving the URLLC signal normally, the first receiving station 120A of the ninth embodiment transmits the first request signal containing the information regarding the communication quality of the URLLC signal to the control station 130. When having received the first request signal, the control station 130 generates transmission parameter information regarding the eMBB signal based on the communication quality of the URLLC signal in the first request signal such that the communication quality of the URLLC signal satisfies the QoS requirement. Furthermore, the control station 130 transmits a second request signal containing transmission parameter information to the second transmitting station 110B. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

The ninth embodiment eliminates necessity of setting all the radio stations to share the information for setting the transmission parameter needed for achieving the QoS of the URLLC signal, making it possible to reduce the overhead for signaling the information.

<6-4-4. Configuration and Operation of Tenth Embodiment>

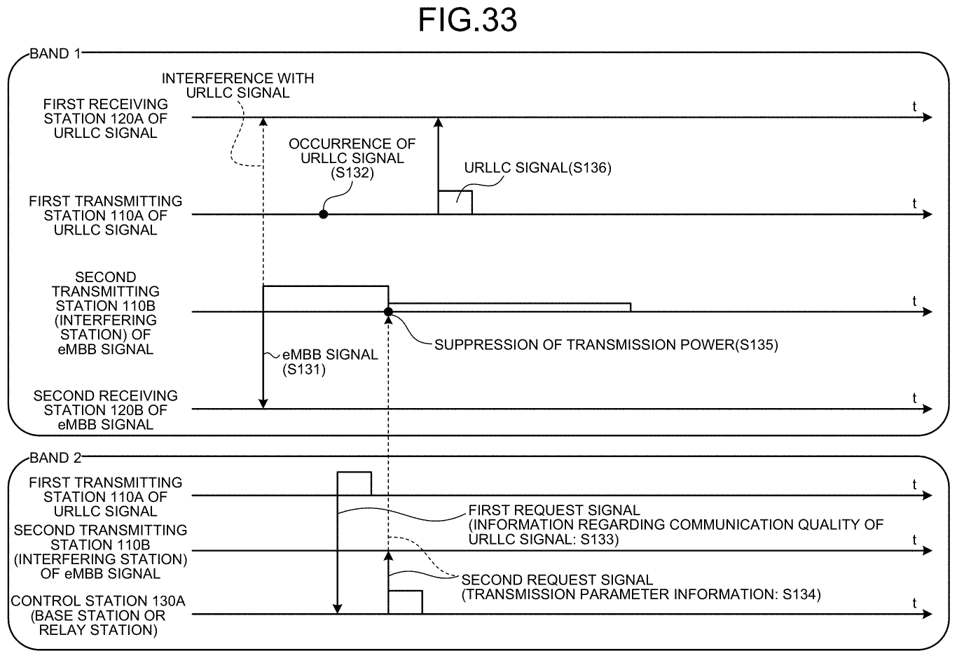

FIG. 33 is a diagram illustrating an example of URLLC signal protection processing according to a tenth embodiment of the present disclosure. In the URLLC signal protection processing of the tenth embodiment, the first transmitting station 110A transmits the first request signal related to the information regarding the communication quality by using the band 2 different from the band used for transmitting the URLLC signal, and a control station 130A transmits the second request signal related to the transmission parameter information of the interfering station by using the band 2. The communication system illustrated in FIG. 33 uses a mode in which the eMBB signal transmitted in the band 1 and the request signal transmitted in the band 2 are transferred by out-band full-duplex communication. The communication system includes a first transmitting station 110A, a first receiving station 120A, a second transmitting station 110B, a second receiving station 120B, and a control station 130A. The first transmitting station 110A transmits the first request signal by using the band 2, and transmits the URLLC signal by using the band 1. The first receiving station 120A receives a URLLC signal by using the band 1. The second transmitting station 110B transmits the eMBB signal by using the band 1. The second receiving station 120B receives the eMBB signal by using the band 1. The control station 130A receives the first request signal and transmits the second request signal by using the band 2.

The second transmitting station 110B transmits the eMBB signal to the second receiving station 120B (Step S131). At this time, for example, when the URLLC signal is transmitted from the first transmitting station 110A to the first receiving station 120A, the eMBB signal being transmitted is interfering with the URLLC signal, that is, causing a state of signal interference. The first transmitting station 110A determines that a URLLC signal has occurred (Step S132).

The first transmitting station 110A transmits the first request signal containing the information regarding the communication quality of the URLLC signal to the control station 130A using the band 2 different from the band 1 (Step S133). When having received the first request signal, the control station 130A generates transmission parameter information regarding the eMBB signal of the second transmitting station 110B based on the communication quality of the URLLC signal in the first request signal such that the communication quality of the URLLC signal satisfies the QoS requirement. The transmission parameter information is, for example, information regarding the transmission power, the modulation levels, the coding rate, and the beam direction regarding the eMBB signal.

The control station 130A transmits the second request signal containing the generated transmission parameter information to the second transmitting station 110B by using the band 2 (Step S134). When having received the second request signal, the second transmitting station 110B suppresses the transmission power of the eMBB signal based on the transmission parameter information in the second request signal (Step S135). As a result, the second transmitting station 110B can avoid signal interference to the URLLC signal by suppressing the transmission power of the eMBB signal. The first transmitting station 110A transmits the URLLC signal to the first receiving station 120A (Step S136). As a result, the first receiving station 120A can receive the URLLC signal by avoiding signal interference of the eMBB signal from the second transmitting station 110B.

In the tenth embodiment, the first transmitting station 110A uses the band 2 to transmit the first request signal containing the information regarding the communication quality to the control station 130A. When having received the first request signal, the control station 130A generates the transmission parameter information regarding the eMBB signal of the band 1 so that the communication quality of the URLLC signal of the band 1 satisfies the QoS requirement, and transmits the second request signal containing the transmission parameter information to the second transmitting station 110B by using the band 2. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal in the band 1 by the eMBB signal in the band 1. Even in a case where there is an interfering station transmitting an interference signal, it is possible to generate a channel state capable of achieving desired transmission quality of a URLLC signal, leading to achievement of low-latency and high-reliability communication.

The tenth embodiment eliminates necessity of setting all the radio stations to share the information for setting the transmission parameter needed for achieving the QoS of the URLLC signal, making it possible to reduce the overhead for signaling the information.

<6-4-5. Configuration and Operation of Eleventh Embodiment>

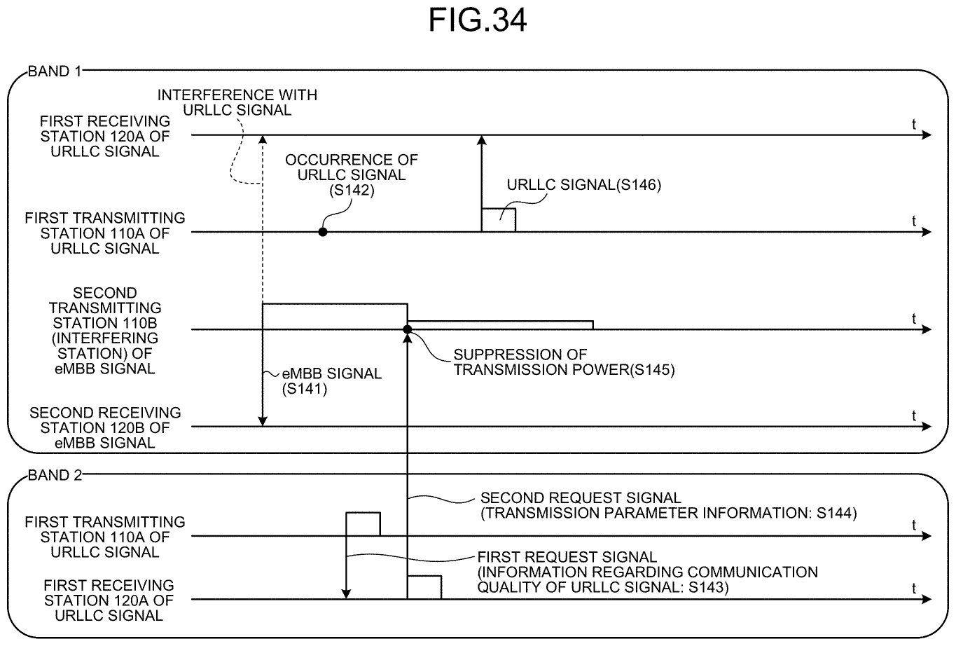

FIG. 34 is a diagram illustrating an example of URLLC signal protection processing according to an eleventh embodiment of the present disclosure. In the URLLC signal protection processing of the eleventh embodiment, the first transmitting station 110A transmits the first request signal related to the information regarding the communication quality by using a band different from the band used for transmitting the URLLC signal, and the first receiving station 120A that has received the first request signal transmits the second request signal related to the transmission parameter information regarding the second transmitting station 110B (interfering station) by using the band 2. The communication system illustrated in FIG. 34 uses a mode in which the eMBB signal transmitted in the band 1 and the request signal transmitted in the band 2 are transferred by out-band full-duplex communication. The communication system includes a first transmitting station 110A, a first receiving station 120A, a second transmitting station 110B, and a second receiving station 120B. The first transmitting station 110A transmits the first request signal by using the band 2, and transmits the URLLC signal by using the band 1. The first receiving station 120A receives the first request signal by using the second band, transmits the second request signal, and receives the URLLC signal by using the first band. The second transmitting station 110B transmits the eMBB signal by using the band 1, and receives the second request signal by using the band 2. The second receiving station 120B receives an eMBB signal by using the band 1.

The second transmitting station 110B transmits the eMBB signal to the second receiving station 120B (Step S141). At this time, for example, when the URLLC signal is transmitted from the first transmitting station 110A to the first receiving station 120A, the eMBB signal being transmitted is interfering with the URLLC signal, that is, causing a state of signal interference. The first transmitting station 110A determines that a URLLC signal has occurred (Step S142).

During the transmission of the eMBB signal from the second transmitting station 110B, the first transmitting station 110A transmits the first request signal containing the information regarding the communication quality of the URLLC signal to the first receiving station 120A by using the band 2 different from the band 1 (Step S143).

In addition, the first receiving station 120A generates transmission parameter information regarding the eMBB signal of the second transmitting station 110B based on the communication quality of the URLLC signal such that the communication quality of the URLLC signal satisfies the QoS requirement. The transmission parameter information is, for example, information regarding the transmission power, the modulation levels, the coding rate, and the beam direction regarding the eMBB signal.

The first receiving station 120A transmits the second request signal containing the generated transmission parameter information to the second transmitting station 110B (interfering station) by using the band 2 (Step S144). Note that the first receiving station 120A transmits the second request signal by broadcast, for example. The second transmitting station 110B is assumed to be in a state capable of receiving a signal in the band 2. When having received the second request signal, the second transmitting station 110B suppresses the transmission power of the eMBB signal based on the transmission parameter information in the second request signal (Step S145). As a result, the second transmitting station 110B can avoid signal interference to the URLLC signal by suppressing the transmission power of the eMBB signal. The first transmitting station 110A transmits the URLLC signal to the first receiving station 120A (Step S146). As a result, the first receiving station 120A can receive the URLLC signal by avoiding signal interference of the eMBB signal from the second transmitting station 110B.

In the eleventh embodiment, the first request signal containing the information regarding the communication quality is broadcast from the first transmitting station 110A of the URLLC signal of the band 2. The first receiving station 120A generates the transmission parameter information of the eMBB signal of the band 1 so that the communication quality of the URLLC signal of the band 1 satisfies the QoS requirement, and broadcasts the second request signal containing the transmission parameter information by using the band 2. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal in the band 1 by the eMBB signal in the band 1. Even in a case where there is an interfering station transmitting an interference signal, it is possible to generate a channel state capable of achieving desired transmission quality of a URLLC signal, leading to achievement of low-latency and high-reliability communication.

The eleventh embodiment eliminates necessity of setting all the radio stations to share the information for setting the transmission parameter needed for achieving the QoS of the URLLC signal, making it possible to reduce the overhead for signaling the information.

<6-4-6. Configuration and Operation of Twelfth Embodiment>

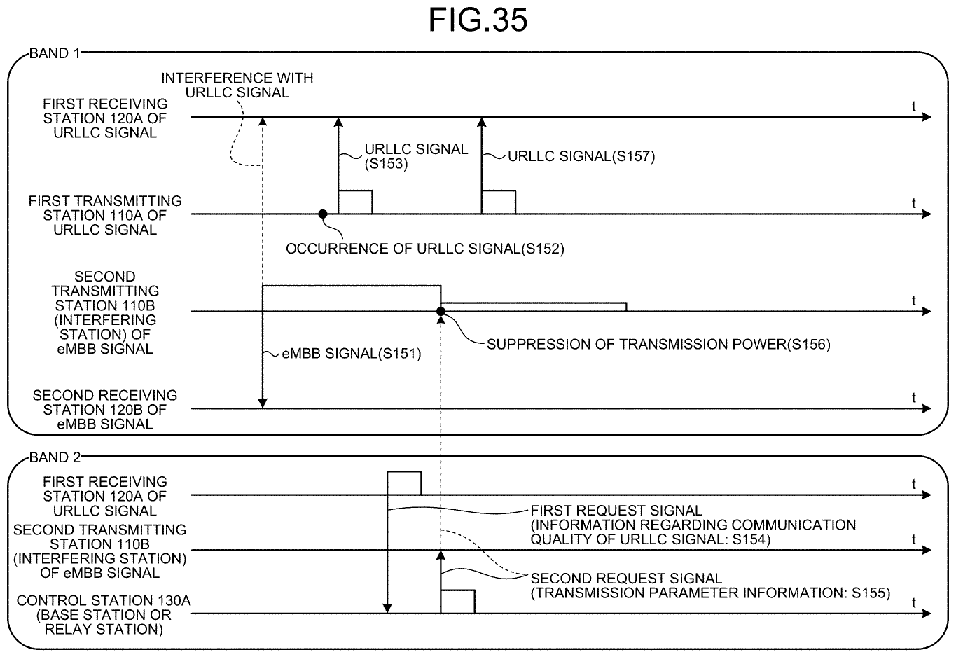

FIG. 35 is a diagram illustrating an example of URLLC signal protection processing according to a twelfth embodiment of the present disclosure. In the URLLC signal protection processing of the twelfth embodiment, the first receiving station 120A transmits the first request signal related to the information regarding the communication quality by using the band 2 different from the band used for receiving the URLLC signal, and the control station 130A transmits the second request signal related to the transmission parameter information of the second transmitting station 110B (interfering station) by using the band 2. The communication system illustrated in FIG. 35 uses a mode in which the eMBB signal transmitted in the band 1 and the request signal transmitted in the band 2 are transferred by out-band full-duplex communication. The communication system includes a first transmitting station 110A, a first receiving station 120A, a second transmitting station 110B, and a second receiving station 120B. The first transmitting station 110A transmits a URLLC signal by using the band 1. The first receiving station 120A receives the URLLC signal by using the band 1, and transmits the first request signal to the control station 130A by using the band 2. The second transmitting station 110B transmits the eMBB signal by using the band 1, and receives the second request signal by using the band 2. The second receiving station 120B receives an eMBB signal by using the band 1. The control station 130A receives the first request signal using the band 2 and transmits the second request signal to the second transmitting station 110B.

The second transmitting station 110B transmits the eMBB signal to the second receiving station 120B (Step S151). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S152), the first transmitting station 110A transmits a URLLC signal to the first receiving station 120A (Step S153).

During the transmission of the eMBB signal from the second transmitting station 110B, the first receiving station 120A transmits the first request signal containing the information regarding the communication quality of the URLLC signal to the control station 130A by using the band 2 (Step S154).

When having received the first request signal, the control station 130A generates eMBB signal transmission parameter information regarding the second transmitting station 110B of the eMBB signal based on the communication quality of the URLLC signal in the first request signal such that the communication quality of the URLLC signal satisfies the QoS requirement. The transmission parameter information is, for example, information regarding the transmission power, the modulation levels, the coding rate, and the beam direction regarding the eMBB signal.

The control station 130A transmits the second request signal containing the generated transmission parameter information to the second transmitting station 110B by using the band 2 (Step S155). When having received the second request signal, the second transmitting station 110B suppresses the transmission power of the eMBB signal based on the transmission parameter information in the second request signal (Step S156). As a result, the second transmitting station 110B can avoid signal interference to the URLLC signal by suppressing the transmission power of the eMBB signal. Note that the second transmitting station 110B is assumed to be in a state capable of receiving a signal in the band 2. The first transmitting station 110A transmits the URLLC signal to the first receiving station 120A (Step S157). As a result, the first receiving station 120A of the URLLC signal can receive the URLLC signal by avoiding signal interference of the eMBB signal from the second transmitting station 110B.

In the twelfth embodiment, the first request signal containing the information regarding the communication quality is transmitted from the first receiving station 120A of the URLLC signal of the band 2 to the control station 130A of the band 2. When having received the first request signal, the control station 130A generates the transmission parameter information regarding the eMBB signal of the band 1 based on the communication quality in the first request information so that the communication quality of the URLLC signal of the band 1 satisfies the QoS requirement, and transmits the second request signal containing the transmission parameter information to the second transmitting station 110B by using the band 2. The second transmitting station 110B suppresses the transmission power of the eMBB signal in response to the second request signal. Subsequently, the first transmitting station 110A transmits a URLLC signal during the transmission power suppression of the eMBB signal. As a result, it is possible to avoid signal interference to the URLLC signal in the band 1 by the eMBB signal in the band 1. Even in a case where there is an interfering station transmitting an interference signal, it is possible to generate a channel state capable of achieving desired transmission quality of a URLLC signal, leading to achievement of low-latency and high-reliability communication.

The twelfth embodiment eliminates necessity of setting all the radio stations to share the information for setting the transmission parameter needed for achieving the QoS of the URLLC signal, making it possible to reduce the overhead for signaling the information.

<6-5. Mode of Notifying Interfering Station of Communication Section for which Radio Resources of Request Information and Control Information are Set>

In the present embodiment, it is also assumed that the transmission power of the control signal of the interfering station is suppressed in order to protect the URLLC signal. However, when the transmission of the control signal of the interfering station is interrupted in the middle, it would be difficult for the receiving station to normally perform the operation of an ordinary data signal (for example, eMBB signal) corresponding to the control signal of the interfering station. In view of this, in the present embodiment, the transmitting station of the URLLC signal transmits a signal containing information for setting a radio resource used for transmitting a control signal related to the URLLC signal, in addition to the request information and the control information. This makes it possible to ensure the radio resource usable for retransmitting the control signal of the interfering station having transmission power suppressed.

The radio resource is resource information including a transmission section for control information related to the URLLC signal and a transmission section for the URLLC signal. Example of the control information related to the URLLC signal include an acknowledgement for the URLLC signal, an acknowledgement signal for the signal of the interfering station having transmission power suppressed, a control signal transmitted by the interfering station having transmission power suppressed, or the like.

Furthermore, in a case where only the acknowledgement signal for the URLLC signal is considered in determination of the length of the communication section, it is also conceivable to use a mode of performing transmission in an SIFS response of the section, specifically, transmitting an acknowledgement signal for the signal of the interfering station having transmission power suppressed or transmitting a control signal transmitted by the interfering station having the transmission power suppressed. The present embodiment is applicable to the assumed systems 1A and 1B.

<6-5-1. Configuration and Operation of Thirteenth Embodiment>

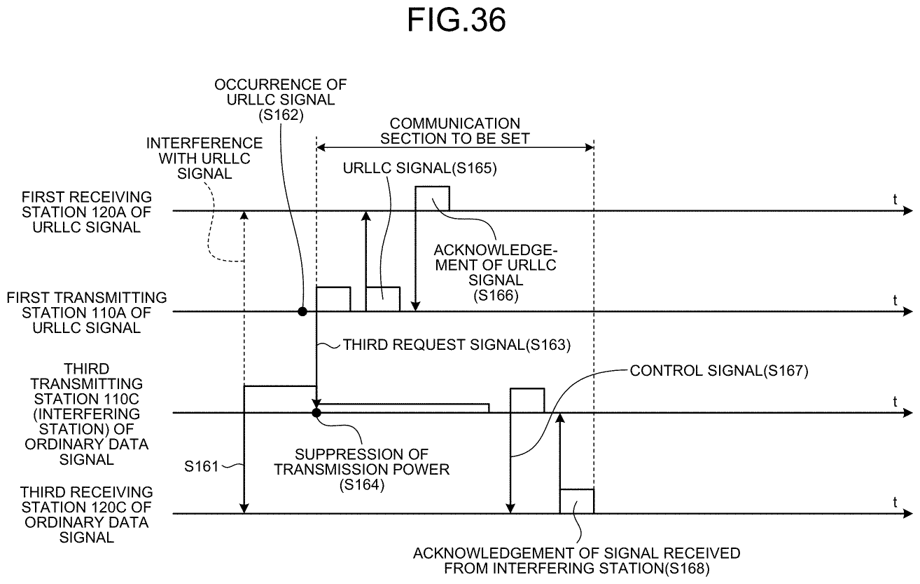

FIG. 36 is a diagram illustrating an example of URLLC signal protection processing according to a thirteenth embodiment of the present disclosure. In the URLLC signal protection processing of the thirteenth embodiment, the first transmitting station 110A of the URLLC signal transmits a signal containing a communication section for which radio resources of request information and control information are to be set. The communication system illustrated in FIG. 36 includes: a first transmitting station 110A that transmits a URLLC signal; a first receiving station 120A that receives a URLLC signal; a third transmitting station 110C that transmits an ordinary data signal; and a third receiving station 120C that receives an ordinary data signal. The first transmitting station 110A transmits a URLLC signal to the first receiving station 120A. Furthermore, the third transmitting station 110C transmits an ordinary data signal to the third receiving station 120C. For convenience of description, the third transmitting station 110C is assumed to be an interfering station in which an ordinary data signal interferes with a URLLC signal because of the ordinary data signal being transmitted.

The third transmitting station 110C transmits the ordinary data signal to the third receiving station 120C (Step S161). At this time, for example, when the URLLC signal is transmitted from the first transmitting station 110A to the first receiving station 120A, the ordinary data signal being transmitted is interfering with the URLLC signal, that is, causing a state of signal interference. When the URLLC signal has occurred (Step S162), the first transmitting station 110A transmits a third request signal for suppressing transmission power of the ordinary data signal to the third transmitting station 110C before transmitting the URLLC signal (Step S163). The third request signal includes a predetermined communication section from a point where the third transmitting station 110C receives the third request signal to a point where the third transmitting station 110C receives an acknowledgement from the third receiving station 120C.

The third transmitting station 110C suppresses the transmission power of the ordinary data signal in response to the third request signal (Step S164). As a result, the third transmitting station 110C can avoid signal interference to the URLLC signal by suppressing the transmission power of the ordinary data signal. After outputting the third request signal, the first transmitting station 110A transmits the URLLC signal to the first receiving station 120A during transmission power suppression of the ordinary data signal (Step S165). As a result, the first receiving station 120A can receive the URLLC signal by avoiding signal interference of the ordinary data signal from the third transmitting station 110C. Furthermore, when having received the URLLC signal from the first transmitting station 110A, the first receiving station 120A transmits an acknowledgement signal of the URLLC signal to the first transmitting station 110A (Step S166). As a result, the first transmitting station 110A can receive the acknowledgement signal of the URLLC signal by avoiding signal interference of the ordinary data signal from the third transmitting station 110C.

The third transmitting station 110C transmits a control signal to the third receiving station 120C (Step S167). When having received the control signal, the third receiving station 120C transmits an acknowledgement signal corresponding to the control signal to the third transmitting station 110C (Step S168).

In the thirteenth embodiment, the third request signal is transmitted from the first transmitting station 110A of the URLLC signal to the third transmitting station 110C of the ordinary data signal in the identical band, and thus, the third transmitting station 110C suppresses the transmission power of the ordinary data signal according to the communication section in the third request signal. Subsequently, the first transmitting station 110A transmits the URLLC signal and the acknowledgement signal during the transmission power suppression of the ordinary data signal. As a result, it is possible to avoid signal interference to the URLLC signal and the acknowledgement signal due to the ordinary data signal. Even in a case where there is an interfering station transmitting an interference signal, it is possible to generate a channel state capable of achieving desired transmission quality of a URLLC signal, leading to achievement of low-latency and high-reliability communication. This further makes it possible to ensure the radio resource usable for retransmitting the control signal of the interfering station having transmission power suppressed.

<6-5-2. Configuration and Operation of Fourteenth Embodiment>

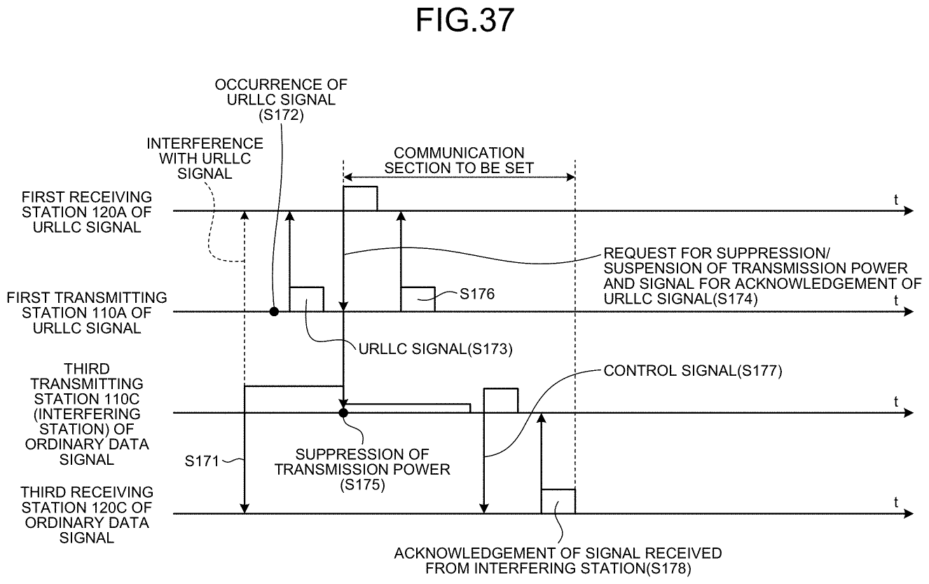

FIG. 37 is a diagram illustrating an example of URLLC signal protection processing according to a fourteenth embodiment of the present disclosure. In the URLLC signal protection processing of the fourteenth embodiment, the first receiving station 120A of the URLLC signal transmits a signal containing a communication section for which radio resources of request information and control information are to be set. The communication system illustrated in FIG. 37 includes: a first transmitting station 110A that transmits a URLLC signal; a first receiving station 120A that receives a URLLC signal; a third transmitting station 110C that transmits an ordinary data signal; and a third receiving station 120C that receives an ordinary data signal. The first transmitting station 110A transmits a URLLC signal to the first receiving station 120A. Furthermore, the third transmitting station 110C transmits an ordinary data signal to the third receiving station 120C. For convenience of description, the third transmitting station 110C is assumed to be an interfering station in which an ordinary data signal interferes with a URLLC signal because of the ordinary data signal being transmitted.

The third transmitting station 110C transmits the ordinary data signal to the third receiving station 120C (Step S171). At this time, for example, when the URLLC signal is transmitted from the first transmitting station 110A to the first receiving station 120A, the ordinary data signal being transmitted is interfering with the URLLC signal, that is, causing a state of signal interference. When the URLLC signal has occurred (Step S172), the first transmitting station 110A transmits a URLLC signal to the first receiving station 120A (Step S173). Since having failed in receiving the URLLC signal normally, the first receiving station 120A transmits an acknowledgement signal (ACK or NACK) of the URLLC signal to the first transmitting station 110A (Step S174). Note that the acknowledgement signal includes: a request signal requesting suppression of the transmission power of the ordinary data signal; and an acknowledgement signal of the URLLC signal.

When having received the acknowledgement signal from the first receiving station 120A, the third transmitting station 110C suppresses the transmission power of the ordinary data signal based on the information in the acknowledgement signal (Step S175). As a result, the third transmitting station 110C can avoid signal interference from the URLLC signal to the acknowledgement signal by suppressing the transmission power of the ordinary data signal.

The first transmitting station 110A transmits the URLLC signal to the first receiving station 120A during the suppression of the transmission power of the ordinary data signal (Step S176). As a result, the first receiving station 120A can receive the URLLC signal by avoiding signal interference of the ordinary data signal from the third transmitting station 110C.

The third transmitting station 110C transmits a control signal to the third receiving station 120C (Step S177). When having received the control signal, the third receiving station 120C transmits an acknowledgement signal corresponding to the control signal to the third transmitting station 110C (Step S178).

In the fourteenth embodiment, the acknowledgement signal (ACK or NACK signal) is transmitted from the first transmitting station 110A of the URLLC signal to the third transmitting station 110C of the ordinary data signal in the identical band, and thus, the third transmitting station 110C suppresses the transmission power of the ordinary data signal according to the communication section in the acknowledgement signal. Subsequently, the first transmitting station 110A transmits the URLLC signal and the acknowledgement signal during the transmission power suppression of the ordinary data signal. As a result, it is possible to avoid signal interference to the URLLC signal and the acknowledgement signal due to the ordinary data signal. Even in a case where there is an interfering station transmitting an interference signal, it is possible to generate a channel state capable of achieving desired transmission quality of a URLLC signal, leading to achievement of low-latency and high-reliability communication.

The transmission of the acknowledgement signal by the first receiving station 120A is performed by unicast, groupcast, or broadcast, for example. The transmission is performed by broadcast in a case, for example, where the interfering station cannot be discriminated. The radio resources of the request information and the control information and the acknowledgement signal of the URLLC signal are transmitted as one signal. Note that these pieces of information may be transmitted by separate signals. Examples of the acknowledgement of the signal received from the interfering station by the control station 130A include an acknowledgement of the signal of the interfering station having transmission power suppressed or a control signal transmitted by the interfering station having transmission power suppressed.

<6-5-3. Configuration and Operation of Fifteenth Embodiment>

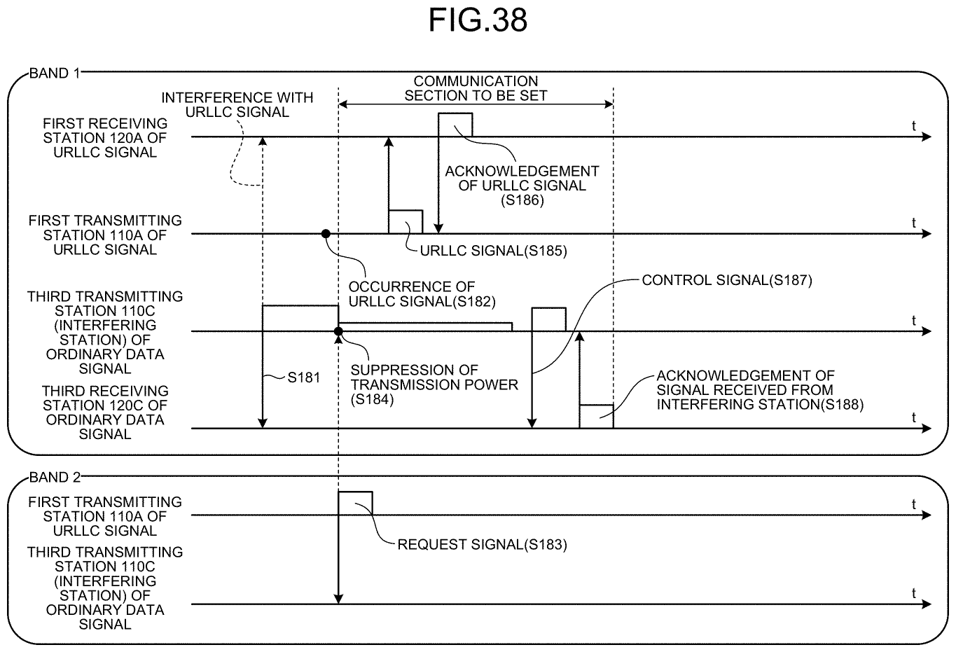

FIG. 38 is a diagram illustrating an example of URLLC signal protection processing according to a fifteenth embodiment of the present disclosure. In the URLLC signal protection processing of the fifteenth embodiment, the first transmitting station 110A transmits a signal containing a communication section for which radio resources of request information and control information are to be set, by using the band 2 different from the band used by the first transmitting station 110A to transmit the URLLC signal. The communication system illustrated in FIG. 38 uses a mode in which the eMBB signal transmitted in the band 1 and the request signal transmitted in the band 2 are transferred by out-band full-duplex communication.

The communication system includes a first transmitting station 110A, a first receiving station 120A, a third transmitting station 110C, and a third receiving station 120C. The first transmitting station 110A transmits the request signal to the third transmitting station 110C by using the band 2. The first transmitting station 110A transmits a request signal by using the band 2, and transmits the URLLC signal by using the band 1. The first receiving station 120A receives a URLLC signal by using the band 1. The third transmitting station 110C transmits an ordinary data signal by using the band 1, and receives a request signal by using the band 2. The third receiving station 120C receives the ordinary data signal by using the band 1.

The third transmitting station 110C transmits the ordinary data signal to the third receiving station 120C using the band 1 (Step S181). At this time, for example, when the URLLC signal is transmitted from the first transmitting station 110A to the first receiving station 120A, the ordinary data signal being transmitted is interfering with the URLLC signal, that is, causing a state of signal interference. The first transmitting station 110A has an occurrence of a URLLC signal (Step S182).

At this time, the first transmitting station 110A transmits a request signal for suppressing the transmission power of the ordinary data signal to the third transmitting station 110C by using the band 2 (Step S183). Note that the third transmitting station 110C is supposed to have a function of receiving a signal in the band 2. The request signal includes information regarding a predetermined communication section from a point where the third transmitting station 110C receives the request signal to a point where the third transmitting station 110C receives an acknowledgement from the third receiving station 120C.

The third transmitting station 110C suppresses the transmission power of the ordinary data signal in response to the request signal from the first transmitting station 110A in the band 2 (Step S184). As a result, the third transmitting station 110C can avoid signal interference to the URLLC signal of the first receiving station 120A by suppressing the transmission power of the ordinary data signal. The first transmitting station 110A transmits the URLLC signal to the first receiving station 120A (Step S185). As a result, the first receiving station 120A can receive the URLLC signal by avoiding interference of the ordinary data signal from the third transmitting station 110C of the ordinary data signal. The first receiving station 120A transmits an acknowledgement signal of the URLLC signal from the first transmitting station 110A to the first transmitting station 110A (Step S186). As a result, the first transmitting station 110A can receive the acknowledgement signal of the URLLC signal by avoiding signal interference of the ordinary data signal from the third transmitting station 110C.

The third transmitting station 110C transmits a control signal to the third receiving station 120C (Step S187). When having received the control signal, the third receiving station 120C transmits an acknowledgement signal corresponding to the control signal to the third transmitting station 110C (Step S188).

In the fifteenth embodiment, the request signal is transmitted by using the second band from the first transmitting station 110A of the URLLC signal in the band 2 to the third transmitting station 110C of the ordinary data signal in the band 1, and thus, the third transmitting station 110C suppresses the transmission power of the ordinary data signal according to the communication section in the request signal. Subsequently, the first transmitting station 110A transmits the URLLC signal and the acknowledgement signal during the transmission power suppression of the ordinary data signal. As a result, it is possible to avoid signal interference to the URLLC signal and the acknowledgement signal due to the ordinary data signal. Even in a case where there is an interfering station transmitting an interference signal, it is possible to generate a channel state capable of achieving desired transmission quality of a URLLC signal, leading to achievement of low-latency and high-reliability communication.

An acknowledgement signal of the URLLC signal can also be protected from the interference signal of the interfering station. This makes it possible to prevent useless retransmission caused by the reception failure of the acknowledgement signal by the transmitting station of the URLLC signal. Furthermore, the period for transmitting the acknowledgement of the signal having the transmission power suppressed is included in the communication period, the interfering station can appropriately shift to the operation for the next transmission.

<6-5-4. Configuration and Operation of Sixteenth Embodiment>

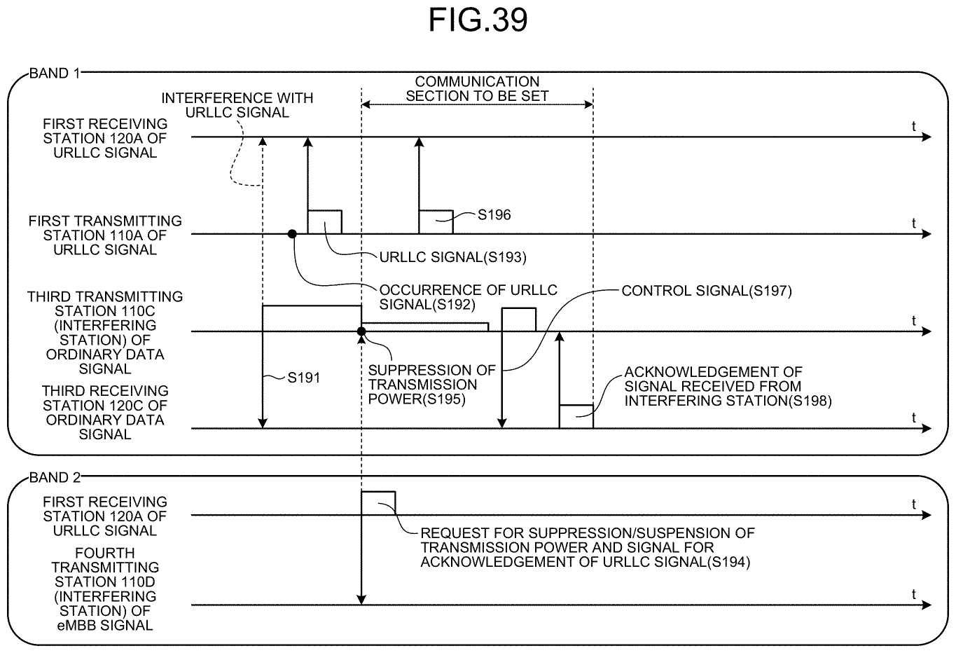

FIG. 39 is a diagram illustrating an example of URLLC signal protection processing according to a sixteenth embodiment of the present disclosure. In the URLLC signal protection processing of the sixteenth embodiment, the first receiving station 120A transmits a signal containing a communication section for which radio resources of request information and control information are to be set, by using the band 2 different from the band used to transmit the URLLC signal. The communication system illustrated in FIG. 39 uses a mode in which the eMBB signal transmitted in the band 1 and the request signal transmitted in the band 2 are transferred by out-band full-duplex communication.

The communication system includes a first transmitting station 110A, a first receiving station 120A, a third transmitting station 110C, and a third receiving station 120C. The first receiving station 120A transmits the request signal using the band 2. The first transmitting station 110A transmits a URLLC signal by using the band 1. The first receiving station 120A receives the URLLC signal by using the band 1, and transmits a signal storing a request for suppression/suspension of transmission power and an acknowledgement of the URLLC signal by using the band 2. The third transmitting station 110C transmits an ordinary data signal by using the band 1, and receives a signal storing a request for suppression/suspension of transmission power and an acknowledgement of a URLLC signal by using the band 2. The third receiving station 120C receives the ordinary data signal by using the band 1.

The third transmitting station 110C transmits the ordinary data signal to the third receiving station 120C using the band 1 (Step S191). At this time, for example, when the URLLC signal is transmitted from the first transmitting station 110A to the first receiving station 120A, the ordinary data signal being transmitted is interfering with the URLLC signal, that is, causing a state of signal interference. When the URLLC signal has occurred (Step S192), the first transmitting station 110A transmits the URLLC signal to the first receiving station 120A by using the band 1 (Step S193).

At this time, the first receiving station 120A transmits an acknowledgement signal of the URLLC signal to a fourth transmitting station 110D using the band 2 (Step S194). Note that the acknowledgement signal includes a request signal requiring suppression of transmission power of a signal using the identical band, an acknowledgement signal of the URLLC signal, and an acknowledgement signal of the control signal. Note that the third transmitting station 110C is in a state capable of receiving the acknowledgement signal from the first receiving station 120A in the band 2.

When having received the acknowledgement signal of the band 2 from the first receiving station 120A, the third transmitting station 110C suppresses the transmission power of the ordinary data signal based on the information in the acknowledgement signal (Step S195). As a result, the third transmitting station 110C can avoid signal interference from the URLLC signal to the acknowledgement signal by suppressing the transmission power of the ordinary data signal.

The first transmitting station 110A transmits the URLLC signal to the first receiving station 120A during the suppression of the transmission power of the ordinary data signal (Step S196). As a result, the first receiving station 120A can receive the URLLC signal by avoiding signal interference of the ordinary data signal from the third transmitting station 110C.

The third transmitting station 110C transmits a control signal to the third receiving station 120C (Step S197). When having received the control signal, the third receiving station 120C transmits an acknowledgement signal corresponding to the control signal to the third transmitting station 110C (Step S198).

In the sixteenth embodiment, the acknowledgement signal is transmitted from the first receiving station 120A of the URLLC signal in the band 2 to the third transmitting station 110C of the ordinary data signal in the band 1 by using a different band 2, the third transmitting station 110C suppresses the transmission power of the ordinary data signal according to the communication section in the acknowledgement signal. Subsequently, the first transmitting station 110A transmits the URLLC signal and the acknowledgement signal during the transmission power suppression of the ordinary data signal. As a result, it is possible to avoid signal interference to the URLLC signal and the acknowledgement signal due to the ordinary data signal. Even in a case where there is an interfering station transmitting an interference signal, it is possible to generate a channel state capable of achieving desired transmission quality of a URLLC signal, leading to achievement of low-latency and high-reliability communication.

An acknowledgement signal of the URLLC signal can also be protected from the signal of the interfering station. This makes it possible to prevent useless retransmission caused by the reception failure of the acknowledgement signal by the transmitting station of the URLLC signal. Furthermore, the period for transmitting the acknowledgement of the signal having the transmission power suppressed is included in the communication period, the interfering station can appropriately shift to the operation for the next transmission.

<6-6. Mode of not Executing In-Band Duplex Communication Operation>

In the present invention, it is possible to perform implementation without executing an in-band duplex communication operation. Therefore, the mode of implementation will be described below.

The present embodiment assumes a case where an eMBB signal to be an interference signal with respect to a URLLC signal arrives from a base station or a relay station. The present embodiment assumes a case where the in-band duplex communication operation is not possible in the assumed system 1B (FIG. 10), the assumed system 1D (FIG. 12), the assumed system 1E (FIG. 13), the assumed system 1F (FIG. 14), the assumed system 1G (FIG. 15), the assumed system 1J (FIG. 17), and the assumed system 1K (FIG. 18), for example. Furthermore, the present embodiment assumes wired or wireless transmission using a band not being used for eMBB transmission, in which the connection between a base station and a relay station or between a base station and another base station is established by backhaul links.

<6-6-1. Configuration and Operation of Seventeenth Embodiment>

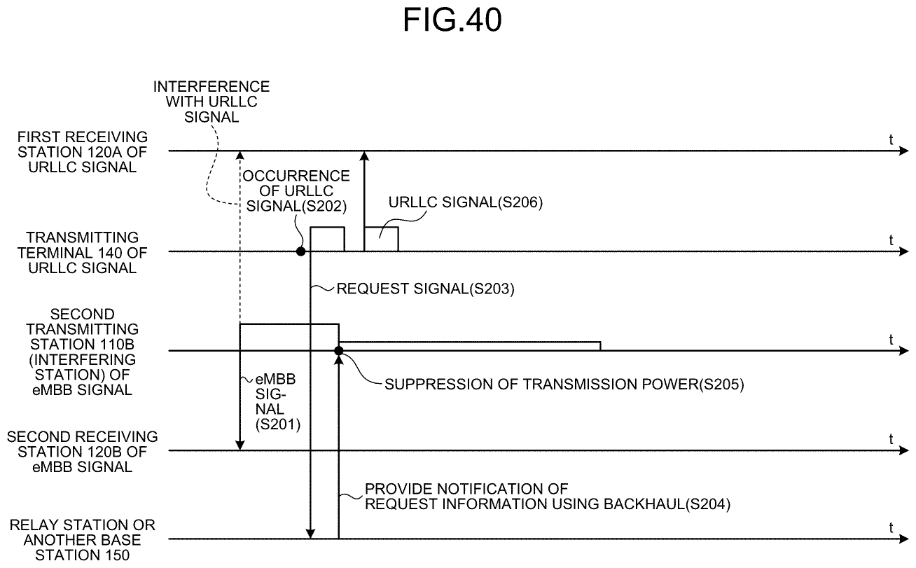

FIG. 40 is a diagram illustrating an example of URLLC signal protection processing according to a seventeenth embodiment of the present disclosure. In the URLLC signal protection processing of the seventeenth embodiment, an interference signal arrives from a base station or a relay station, and a terminal transmits a URLLC signal and transmits a request signal. The communication system of the seventeenth embodiment assumes an assumed system 1B (FIG. 10), an assumed system 1D (FIG. 12), and an assumed system 1G (FIG. 15).

The communication system illustrated in FIG. 40 includes a transmitting terminal 140 that transmits a URLLC signal, a first receiving station 120A that receives a URLLC signal, a second transmitting station 110B that transmits an eMBB signal, a second receiving station 120B that receives an eMBB signal, and a relay station 150. The transmitting terminal 140 transmits the URLLC signal to the first receiving station 120A. Furthermore, the second transmitting station 110B transmits the eMBB signal to the second receiving station 120B. For convenience of description, because of the eMBB signal being transmitted, the second transmitting station 110B of the eMBB signal is an interfering station having the eMBB signal interfering with the URLLC signal. While being connected to the transmitting terminal 140 by using an access link, the relay station 150 is also connected to the second transmitting station 110B by using a backhaul link. Note that the relay station 150 may be a relay station or a base station of another cell. Furthermore, the relay station 150 may be a WLAN access point, and alterations are possible in this regard as appropriate.

The second transmitting station 110B transmits the eMBB signal to the second receiving station 120B (Step S201). At this time, for example, when the URLLC signal is transmitted from the transmitting terminal 140 to the first receiving station 120A, the eMBB signal being transmitted is interfering with the URLLC signal, that is, causing a state of signal interference. Before transmitting the URLLC signal, the transmitting terminal 140 determines whether the communication quality can be achieved on the reception side based on QoS information collected in advance. When the URLLC signal has occurred (Step S202), the transmitting terminal 140 transmits a request signal for suppressing the transmission power of the eMBB signal to the relay station 150 before transmitting the URLLC signal (Step S203).

When having received the request signal, the relay station 150 transmits the request information in the request signal to the second transmitting station 110B by using the backhaul link (Step S204). When having received the request information, the second transmitting station 110B suppresses the transmission power of the eMBB signal (Step S205). As a result, the second transmitting station 110B can avoid signal interference to the URLLC signal by suppressing the transmission power of the eMBB signal. The transmitting terminal 140 transmits the URLLC signal to the first receiving station 120A while suppressing the transmission power of the eMBB signal (Step S206). As a result, the first receiving station 120A can receive the URLLC signal by avoiding signal interference of the eMBB signal from the second transmitting station 110B.

In the seventeenth embodiment, the request signal is transmitted from the transmitting terminal 140 of the URLLC signal to the relay station 150, and the relay station 150 transmits the request information to the second transmitting station 110B by using the backhaul link. Subsequently, the second transmitting station 110B suppresses the transmission power of the eMBB signal in response to the request information. Next, the transmitting terminal 140 transmits the URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

<6-6-2. Configuration and Operation of Eighteenth Embodiment>

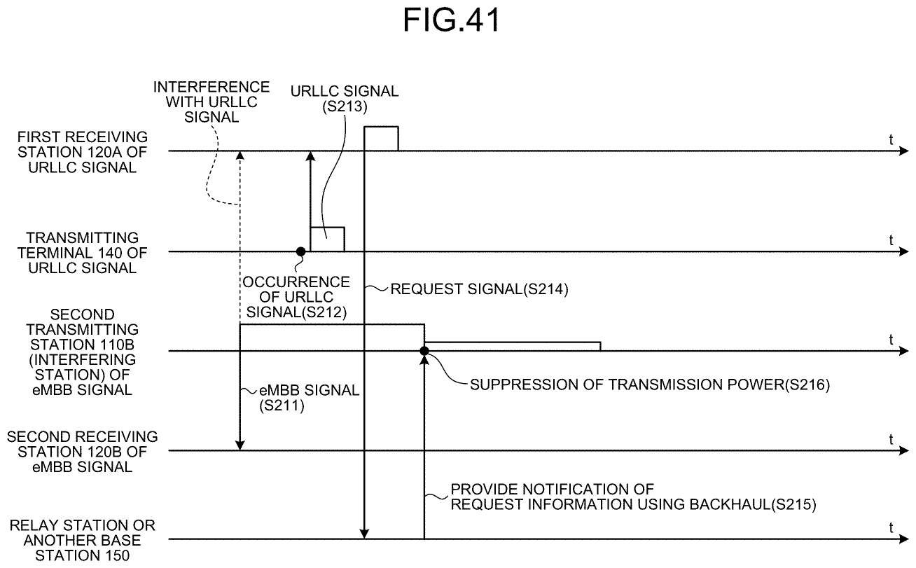

FIG. 41 is a diagram illustrating an example of URLLC signal protection processing according to an eighteenth embodiment of the present disclosure. In the URLLC signal protection processing of the eighteenth embodiment, an interference signal arrives from a base station or a relay station, a terminal transmits a URLLC signal, and a receiving station of the URLLC signal transmits a request signal. The communication system of the eighteenth embodiment assumes an assumed system 1B (FIG. 10), an assumed system 1D (FIG. 12), and an assumed system 1G (FIG.

The communication system illustrated in FIG. 41 includes a transmitting terminal 140 that transmits a URLLC signal, a first receiving station 120A that receives a URLLC signal, a second transmitting station 110B that transmits an eMBB signal, a second receiving station 120B that receives an eMBB signal, and a relay station 150. The transmitting terminal 140 transmits the URLLC signal to the first receiving station 120A. Furthermore, the second transmitting station 110B transmits the eMBB signal to the second receiving station 120B. While being connected to the transmitting terminal 140 by using an access link, the relay station 150 is also connected to the second transmitting station 110B by using a backhaul link. Note that the relay station 150 may be a relay station or a base station of another cell. Furthermore, the relay station 150 may be a WLAN access point, and alterations are possible in this regard as appropriate.

The second transmitting station 110B transmits the eMBB signal to the second receiving station 120B (Step S211). At this time, for example, when the URLLC signal is transmitted from the transmitting terminal 140 to the first receiving station 120A, the eMBB signal being transmitted is interfering with the URLLC signal, that is, causing a state of signal interference. Before transmitting the URLLC signal, the transmitting terminal 140 determines whether the communication quality can be achieved on the reception side based on QoS information collected in advance. When the URLLC signal has occurred (Step S212), the transmitting terminal 140 transmits the URLLC signal to the first receiving station 120A (Step S213).

Having failed in receiving the URLLC signal from the transmitting terminal 140 normally, the first receiving station 120A transmits a request signal to the relay station 150 (Step S214). In response to the request signal, the relay station 150 transmits the request information to the second transmitting station 110B by using the backhaul link (Step S215). When having received the request information, the second transmitting station 110B suppresses the transmission power of the eMBB signal (Step S216). As a result, the second transmitting station 110B can avoid signal interference to the URLLC signal by suppressing the transmission power of the eMBB signal. The transmitting terminal 140 transmits the URLLC signal to the first receiving station 120A while suppressing the transmission power of the eMBB signal. As a result, the first receiving station 120A can receive the URLLC signal by avoiding signal interference of the eMBB signal from the second transmitting station 110B.

In the eighteenth embodiment, the request signal is transmitted from the first receiving station 120A of the URLLC signal to the relay station 150, and the relay station 150 transmits the request information to the second transmitting station 110B using the backhaul link.

Subsequently, the second transmitting station 110B suppresses the transmission power of the eMBB signal in response to the request information. Next, the transmitting terminal 140 transmits the URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

<6-6-3. Configuration and Operation of Nineteenth Embodiment>

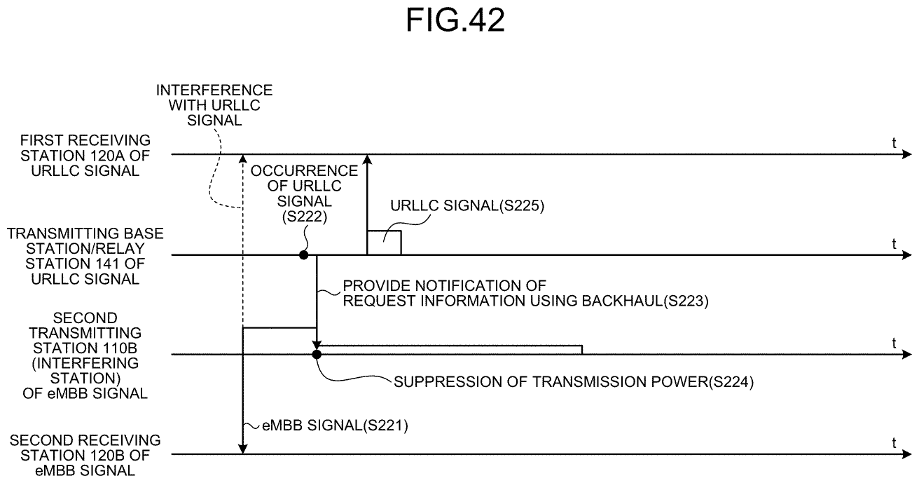

FIG. 42 is a diagram illustrating an example of URLLC signal protection processing according to a nineteenth embodiment of the present disclosure. In the URLLC signal protection processing of the nineteenth embodiment, an interference signal arrives from a base station or a relay station, the base station or the relay station transmits a URLLC signal, and a request signal is transmitted by using a backhaul link. The communication system of the nineteenth embodiment assumes an assumed system 1E (FIG. 13), an assumed system 1F (FIG. 14), an assumed system 1J (FIG. 17), and an assumed system 1K (FIG. 18).

The communication system illustrated in FIG. 42 includes: a transmitting base station 141 that transmits a URLLC signal; a first receiving station 120A that receives a URLLC signal; a second transmitting station 110B that transmits an eMBB signal; and a second receiving station 120B that receives an eMBB signal. The transmitting base station 141 transmits the URLLC signal to the first receiving station 120A. Furthermore, the second transmitting station 110B transmits the eMBB signal to the second receiving station 120B. While being connected to the first receiving station 120A by using an access link, the transmitting base station 141 is connected to the second transmitting station 110B by using a backhaul link. Note that the transmitting base station 141 may be a relay station, or the like.

The second transmitting station 110B transmits the eMBB signal to the second receiving station 120B (Step S221). At this time, for example, when the URLLC signal is transmitted from the transmitting base station 141 to the first receiving station 120A, the eMBB signal being transmitted is interfering with the URLLC signal, that is, causing a state of signal interference. When the URLLC signal has occurred (Step S222), the transmitting base station 141 transmits the request information to the second transmitting station 110B by using the backhaul link before transmitting the URLLC signal (Step S223). When having received the request information, the second transmitting station 110B suppresses the transmission power of the eMBB signal (Step S224). As a result, the second transmitting station 110B can avoid signal interference to the URLLC signal by suppressing the transmission power of the eMBB signal. The transmitting base station 141 transmits the URLLC signal to the first receiving station 120A while suppressing the transmission power of the eMBB signal (Step S225). As a result, the first receiving station 120A can receive the URLLC signal by avoiding signal interference of the eMBB signal from the second transmitting station 110B.

In the nineteenth embodiment, the request information is transmitted from the transmitting base station 141 of the URLLC signal to the second transmitting station 110B using the backhaul link, and accordingly, the second transmitting station 110B suppresses the transmission power of the eMBB signal in response to the request information. Next, the transmitting base station 141 transmits the URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

In the present invention, it is possible to perform implementation without executing an in-band duplex communication operation as described above. The present embodiment assumes a case where an eMBB signal to be an interference signal with respect to a URLLC signal arrives from a terminal. When the terminal is an interfering station, it is difficult for the terminal transmitting the eMBB signal to perform the receiving operation at the same time. That is, it is difficult for another radio station to notify the terminal of the transmission of the URLLC signal. In order to implement URLLC transmission under this circumstance, when a URLLC signal occurs in the base station or relay station, only the judgment as to whether transmission is to be performed using another resource based on non-interference information exchanged in advance is executed. This assumes a case where the URLLC signal is transmitted by a plurality of terminals or relay stations.

The present embodiment assumes, for example, an assumed system 1B (FIG. 10), an assumed system 1D (FIG. 12), an assumed system 1F (FIG. 14), an assumed system 1G (FIG. 15), an assumed system 1H (FIG. 16), and an assumed system 1K (FIG. 18). Furthermore, the present embodiment is applicable to a case where a URLLC signal in the same direction as the eMBB signal is transmitted in the assumed system 1A, the assumed system 1B, and the assumed systems 1E to 1H. In the present embodiment, when a plurality of URLLC signals occur, it is assumed that it is difficult to satisfy all QoS requirements of the plurality of URLLC signals.

<6-6-4. Configuration and Operation of Twentieth Embodiment>

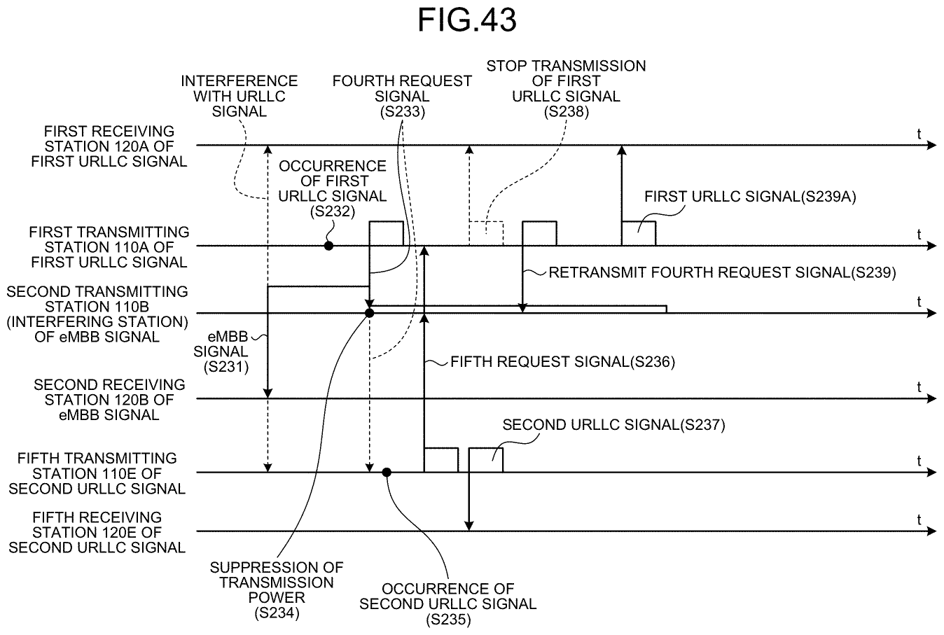

FIG. 43 is a diagram illustrating an example of URLLC signal protection processing according to a twentieth embodiment of the present disclosure. In the URLLC signal protection processing of the twentieth embodiment, a URLLC signal as a protection target is determined from among a plurality of URLLC signals having different transmission timings. The communication system illustrated in FIG. 43 includes: a first transmitting station 110A that transmits a first URLLC signal; a first receiving station 120A that receives the first URLLC signal: a second transmitting station 110B that transmits an eMBB signal; a second receiving station 120B that receives the eMBB signal; a fifth transmitting station 110E that transmits a second URLLC signal; and a fifth receiving station 120E that receives the second URLLC signal. The first transmitting station 110A transmits the first URLLC signal to the first receiving station 120A. Furthermore, the second transmitting station 110B transmits the eMBB signal to the second receiving station 120B. The fifth transmitting station 110E transmits the second URLLC signal to the fifth receiving station 120E. For convenience of description, the second transmitting station 110B is assumed to be an interfering station in which the eMBB signal interferes with the URLLC signal because of the eMBB signal being transmitted by the second transmitting station 110B.

The second transmitting station 110B transmits the eMBB signal to the second receiving station 120B (Step S231). At this time, for example, when the first URLLC signal has been transmitted from the first transmitting station 110A to the first receiving station 120A, or when the second URLLC signal has been transmitted from the fifth transmitting station 110E to the fifth receiving station 120E, the eMBB signal being transmitted is interfering with the URLLC signal, that is, in a state of signal interference with the URLLC signal. The first transmitting station 110A and the fifth transmitting station 110E judge whether the required communication quality of the URLLC signal can be achieved based on measurement information collected in advance. When the first URLLC signal has occurred (Step S232), the first transmitting station 110A generates a fourth request signal for suppressing the transmission power of the eMBB signal before transmitting the first URLLC signal. The fourth request signal stores a priority class indicating priority of the URLLC signal. The first transmitting station 110A transmits the fourth request signal to the second transmitting station 110B (Step S233). Note that the fifth transmitting station 110E is also in a state capable of receiving the fourth request signal.

When having received the fourth request signal, the second transmitting station 110B suppresses the transmission power of the eMBB signal (Step S234). As a result, the second transmitting station 110B can avoid signal interference to the URLLC signal by suppressing the transmission power of the eMBB signal.

When the second URLLC signal has occurred (Step S235), even when having received the fourth request signal, the fifth transmitting station 110E transmits a fifth request signal to the second transmitting station 110B. Note that the first transmitting station 110A is also in a state capable of receiving the fifth request signal. The fifth request signal stores a priority class. For convenience of description, it is assumed that the priority class of the second URLLC signal is set to be higher than the priority class of the first URLLC signal, for example. For example, the fifth request signal may be transmitted by unicast, groupcast, or broadcast. In a case where the priority class is equal or low, the transmission timing and the radio resources of the URLLC signal are to be altered.

Before transmission of the second URLLC signal by the fifth transmitting station 110E, the first transmitting station 110A compares the priority class of the first URLLC signal with the priority class of the second URLLC signal. Since the priority class of the second URLLC signal is higher, the first transmitting station 110A stops transmitting the first URLLC signal (Step S238). In addition, the fifth transmitting station 110E also compares the priority class of the first URLLC signal with the priority class of the second URLLC signal. Since the priority class of the second URLLC signal is higher, the fifth transmitting station 110E transmits the second URLLC signal to the fifth receiving station 120E (Step S237). As a result, the fifth receiving station 120E can receive the second URLLC signal by avoiding signal interference of the eMBB signal from the second transmitting station 110B.

Furthermore, after stopping the transmission of the first URLLC signal, the first transmitting station 110A retransmits the fourth request signal to the second transmitting station 110B (Step S239). The first transmitting station 110A transmits the first URLLC signal to the first receiving station 120A (Step S239A). As a result, the first receiving station 120A can receive the first URLLC signal by avoiding signal interference of the eMBB signal from the second transmitting station 110B.

In the twentieth embodiment, even when a URLLC signal conflict occurs between the first transmitting station 110A and the fifth transmitting station 110E during transmission of the eMBB signal in the identical band, the transmission power of the eMBB signal is suppressed, and thereafter the priority classes of the URLLC signals are compared with each other. In the communication system, based on the comparison result of the priority class, the transmission of the first URLLC signal is stopped and the second URLLC signal is preferentially transmitted. Subsequently, in the communication system, after the transmission of the second URLLC signal, the first URLLC signal is transmitted. As a result, even when an occurrence of conflict in the transmission of a plurality of URLLC signals during eMBB signal transmission in the identical band, signal interference to the URLLC signal by the eMBB signal can be avoided. Even in a case where there is an interfering station transmitting an interference signal, it is possible to generate a channel state capable of achieving desired transmission quality of a URLLC signal, leading to achievement of low-latency and high-reliability communication.

<6-6-5. Configuration and Operation of Twenty-First Embodiment>

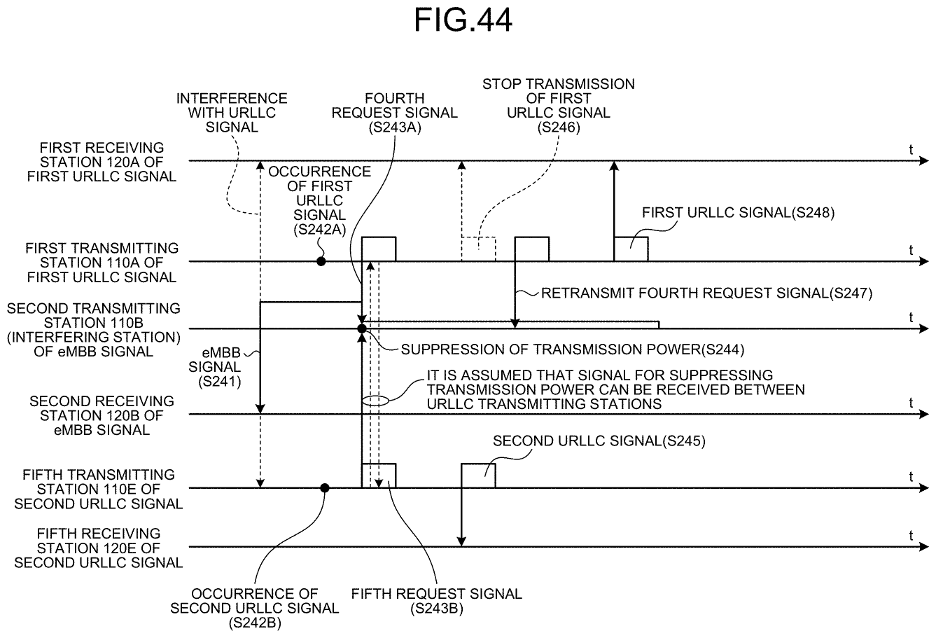

FIG. 44 is a diagram illustrating an example of URLLC signal protection processing according to a twenty-first embodiment of the present disclosure. In the URLLC signal protection processing of the twenty-first embodiment, the URLLC signal as a protection target is determined from among a plurality of URLLC signals having the same transmission timing, and mutual request signals of the URLLC signals can be detected. The communication system illustrated in FIG. 44 includes: a first transmitting station 110A that transmits a first URLLC signal; a first receiving station 120A that receives the first URLLC signal: a second transmitting station 110B that transmits an eMBB signal; a second receiving station 120B that receives the eMBB signal; a fifth transmitting station 110E that transmits a second URLLC signal; and a fifth receiving station 120E that receives the second URLLC signal. The first transmitting station 110A transmits the first URLLC signal to the first receiving station 120A. Furthermore, the second transmitting station 110B transmits the eMBB signal to the second receiving station 120B. The fifth transmitting station 110E transmits the second URLLC signal to the fifth receiving station 120E. For convenience of description, the second transmitting station 110B is assumed to be an interfering station in which the eMBB signal interferes with the URLLC signal because of the eMBB signal being transmitted by the second transmitting station 110B.

The second transmitting station 110B transmits the eMBB signal to the second receiving station 120B (Step S241). At this time, for example, when the first URLLC signal has been transmitted from the first transmitting station 110A to the first receiving station 120A, or when the second URLLC signal has been transmitted from the fifth transmitting station 110E to the fifth receiving station 120E, the eMBB signal being transmitted is interfering with the URLLC signal, that is, in a state of signal interference with the URLLC signal. The first transmitting station 110A and the fifth transmitting station 110E judge whether the required communication quality of the URLLC signal can be achieved based on measurement information collected in advance. It is assumed that there are simultaneous occurrences of the first URLLC signal (Step S242A) and the second URLLC signal (Step S242B). When the first URLLC signal has occurred (Step S242A), the first transmitting station 110A transmits a fourth request signal for suppressing the transmission power of the eMBB signal to the second transmitting station 110B before transmitting the first URLLC signal (Step S243A). Note that the fifth transmitting station 110E is also in a state capable of receiving the fourth request signal.

Furthermore, when the second URLLC signal has occurred (Step S242B), the fifth transmitting station 110E transmits the fifth request signal for suppressing the transmission power of the eMBB signal to the second transmitting station 110B before transmitting the second URLLC signal (Step S243B). Note that the first transmitting station 110A is also in a state capable of receiving the fifth request signal. When having received the fourth request signal or the fifth request signal, the second transmitting station 110B suppresses the transmission power of the eMBB signal (Step S244). As a result, the second transmitting station 110B can avoid signal interference to the URLLC signal by suppressing the transmission power of the eMBB signal.

Before transmission of the second URLLC signal, the first transmitting station 110A compares the priority class of the first URLLC signal with the priority class of the second URLLC signal. Since the priority class of the second URLLC signal is higher, the first transmitting station 110A stops transmitting the first URLLC signal (Step S246). In addition, the fifth transmitting station 110E also compares the priority class of the first URLLC signal with the priority class of the second URLLC signal. Since the priority class of the second URLLC signal is higher, the fifth transmitting station 110E transmits the second URLLC signal to the fifth receiving station 120E (Step S245). As a result, the fifth receiving station 120E can receive the second URLLC signal by avoiding signal interference of the eMBB signal from the second transmitting station 110B.

Furthermore, after stopping the transmission of the first URLLC signal, the first transmitting station 110A retransmits the fourth request signal to the second transmitting station 110B (Step S247). The first transmitting station 110A transmits the first URLLC signal to the first receiving station 120A (Step S248). As a result, the first receiving station 120A can receive the first URLLC signal by avoiding signal interference of the eMBB signal from the second transmitting station 110 and a sixth transmitting station 110FB.

It is assumed that, in a case where the request information is identified using bit information carried by the signal, the type of the signal waveform, or the orthogonal sequence, the first transmitting station 110A, the fifth transmitting station 110E, and the interfering station can extract the request information from the fourth request signal and the fifth request signal. The first transmitting station 110A and the fifth transmitting station 110E extract the request information from the other party's request signal and read the information regarding the transmission timing of the URLLC signal and the QoS information. When the transmission timings of the URLLC signals overlap, the transmitting station of the low priority class changes the scheduled transmission timing.

In the twenty-first embodiment, even when the URLLC signals have simultaneously occurred in the first transmitting station 110A and the fifth transmitting station 110E during the eMBB signal transmission in the identical band, suppression of the transmission power of the eMBB signal is performed and thereafter the transmission of the first URLLC signal is stopped so as to allow the second URLLC signal to be preferentially transmitted. Subsequently, in the communication system, after the transmission of the second URLLC signal, the first URLLC signal is transmitted. As a result, even when the first URLLC signal and the second URLLC signal have simultaneously occurred during eMBB signal transmission in the identical band, signal interference to the URLLC signal by the eMBB signal can be avoided. Even in a case where there is an interfering station transmitting an interference signal, it is possible to generate a channel state capable of achieving desired transmission quality of a URLLC signal, leading to achievement of low-latency and high-reliability communication.

<6-6-6. Configuration and Operation of Twenty-Second Embodiment>

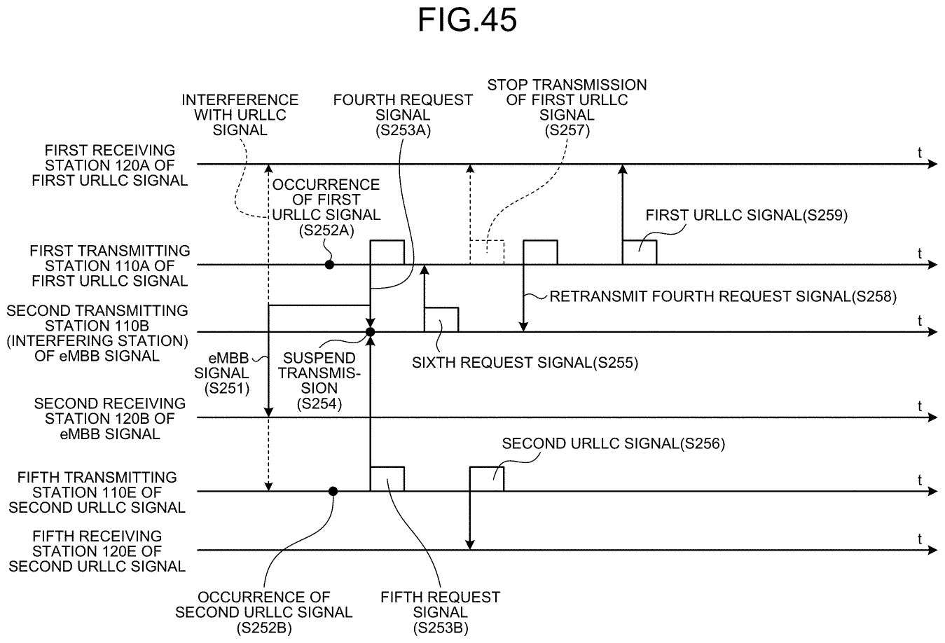

FIG. 45 is a diagram illustrating an example of URLLC signal protection processing according to a twenty-second embodiment of the present disclosure. In the URLLC signal protection processing of the twenty-second embodiment, the URLLC signal as a protection target is determined from among a plurality of URLLC signals having the same transmission timing, and mutual request signals of the URLLC signals cannot be detected. The communication system illustrated in FIG. 45 includes: a first transmitting station 110A that transmits a first URLLC signal; a first receiving station 120A that receives the first URLLC signal: a second transmitting station 110B that transmits an eMBB signal; a second receiving station 120B that receives the eMBB signal; a fifth transmitting station 110E that transmits a second URLLC signal; and a fifth receiving station 120E that receives the second URLLC signal. The first transmitting station 110A transmits the first URLLC signal to the first receiving station 120A. Furthermore, the second transmitting station 110B transmits the eMBB signal to the second receiving station 120B. The fifth transmitting station 110E transmits the second URLLC signal to the fifth receiving station 120E. For convenience of description, the second transmitting station 110B is assumed to be an interfering station in which the eMBB signal interferes with the URLLC signal because of the eMBB signal being transmitted by the second transmitting station 110B.

The second transmitting station 110B transmits the eMBB signal to the second receiving station 120B (Step S251). At this time, for example, when the first URLLC signal has been transmitted from the first transmitting station 110A to the first receiving station 120A, or when the second URLLC signal has been transmitted from the fifth transmitting station 110E to the fifth receiving station 120E, the eMBB signal being transmitted is interfering with the URLLC signal, that is, in a state of signal interference with the URLLC signal. It is assumed that there are simultaneous occurrences of the first URLLC signal (Step S252A) and the second URLLC signal (Step S252B). When the first URLLC signal has occurred (Step S252A), the first transmitting station 110A transmits a fourth request signal for suppressing the transmission power of the eMBB signal to the second transmitting station 110B before transmitting the first URLLC signal (Step S253A).

Furthermore, when the second URLLC signal has occurred (Step S252B), the fifth transmitting station 110E transmits the fifth request signal for suppressing the transmission power of the eMBB signal to the second transmitting station 110B before transmitting the second URLLC signal (Step S253B). When having received the fourth request signal or the fifth request signal, the second transmitting station 110B suppresses the transmission power of the eMBB signal (Step S254). As a result, the second transmitting station 110B can avoid signal interference to the URLLC signal by suppressing the transmission power of the eMBB signal.

After suspending the transmission of the eMBB signal, the second transmitting station 110B generates a sixth request signal requesting the first transmitting station 110A to stop transmitting the first URLLC signal. The second transmitting station 110B compares the priority class of the first URLLC signal with the priority class of the second URLLC signal. Since the priority class of the second URLLC signal is higher, the second transmitting station 110B stops transmitting the first URLLC signal. Accordingly, the second transmitting station 110B transmits the sixth request signal to the first transmitting station 110A (Step S255). When having received the sixth request signal, the first transmitting station 110A stops transmitting the first URLLC signal (Step S257).

Furthermore, the fifth transmitting station 110E transmits the second URLLC signal to the fifth receiving station 120E during suspension of the transmission of the eMBB signal and during the stop of the transmission of the first URLLC signal (Step S256). As a result, the fifth receiving station 120E can receive the second URLLC signal by avoiding signal interference of the eMBB signal from the second transmitting station 110B.

Furthermore, after stopping the transmission of the first URLLC signal, the first transmitting station 110A retransmits the fourth request signal to the second transmitting station 110B (Step S258). The first transmitting station 110A then transmits the first URLLC signal to the first receiving station 120A (Step S259). As a result, the first receiving station 120A can receive the first URLLC signal by avoiding signal interference of the eMBB signal from the second transmitting station 110B.

The request information is represented using bit information carried by the signal, a signal waveform type, or an orthogonal sequence. It is assumed that, even when there is a collision of the fourth request signal and the fifth request signal, the interfering station can extract request information in each signal. When having detected the collision of the request signals, the interfering station transmits a sixth request signal requesting the transmitting station that has transmitted the low-priority class signal not to transmit the URLLC signal based on the extracted request information. When having failed in discrimination of the source of the request signal, the interfering station may transmit a sixth request signal requesting not to transmit a signal of a predetermined priority class or less. The transmitting station (the first transmitting station 110A) that has received the sixth request signal attempts to transmit the URLLC signal at another timing.

In the twenty-second embodiment, even when the URLLC signals have simultaneously occurred in the first transmitting station 110A and the fifth transmitting station 110E during the eMBB signal transmission in the identical band, the transmission power of the eMBB signal is suspended and thereafter the transmission of the first URLLC signal is stopped so as to allow the second URLLC signal to be preferentially transmitted. Subsequently, in the communication system, after the transmission of the second URLLC signal, the first URLLC signal is transmitted. As a result, even when the first URLLC signal and the second URLLC signal have simultaneously occurred during eMBB signal transmission in the identical band, signal interference to the URLLC signal by the eMBB signal can be avoided. Even in a case where there is an interfering station transmitting an interference signal, it is possible to generate a channel state capable of achieving desired transmission quality of a URLLC signal, leading to achievement of low-latency and high-reliability communication.

<6-6-7. Configuration and Operation of Twenty-Third Embodiment>

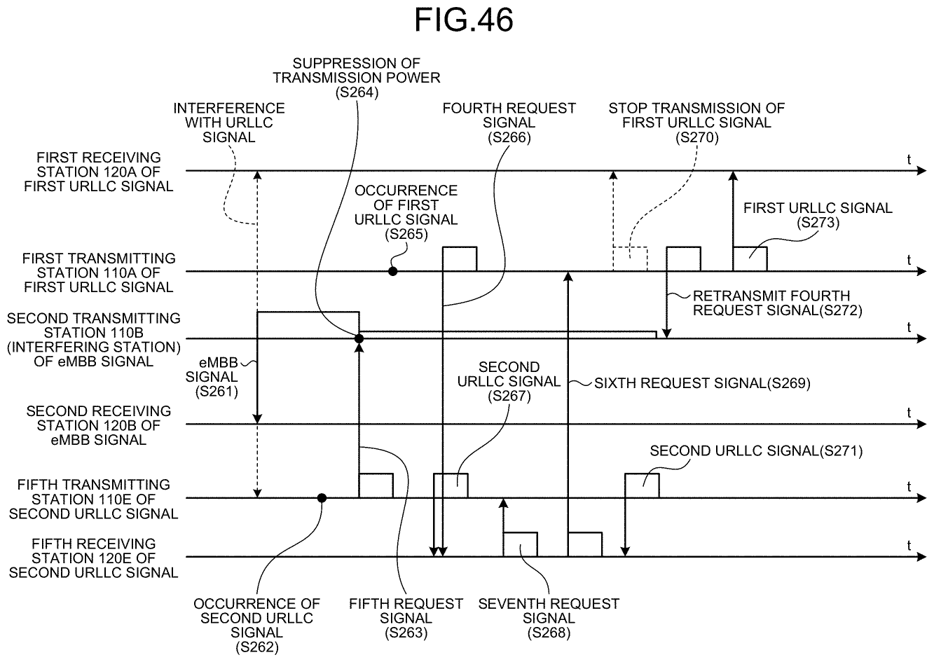

FIG. 46 is a diagram illustrating an example of URLLC signal protection processing according to a twenty-third embodiment of the present disclosure. In the URLLC signal protection processing of the twenty-third embodiment, the URLLC signal as a protection target is determined from among a plurality of URLLC signals having the same transmission timing of the request signal and URLLC signal. The communication system illustrated in FIG. 46 includes: a first transmitting station 110A that transmits a first URLLC signal; a first receiving station 120A that receives the first URLLC signal: a second transmitting station 110B that transmits an eMBB signal; a second receiving station 120B that receives the eMBB signal; a fifth transmitting station 110E that transmits a second URLLC signal; and a fifth receiving station 120E that receives the second URLLC signal. The first transmitting station 110A transmits the first URLLC signal to the first receiving station 120A. Furthermore, the second transmitting station 110B transmits the eMBB signal to the second receiving station 120B. The fifth transmitting station 110E transmits the second URLLC signal to the fifth receiving station 120E. For convenience of description, the second transmitting station 110B is assumed to be an interfering station in which the eMBB signal interferes with the URLLC signal because of the eMBB signal being transmitted by the second transmitting station 110B.

The second transmitting station 110B transmits the eMBB signal to the second receiving station 120B (Step S261). At this time, for example, when the first URLLC signal has been transmitted from the first transmitting station 110A to the first receiving station 120A, or when the second URLLC signal has been transmitted from the fifth transmitting station 110E to the fifth receiving station 120E, the eMBB signal being transmitted is interfering with the URLLC signal, that is, in a state of signal interference with the URLLC signal.

When the second URLLC signal has occurred (Step S262), the fifth transmitting station 110E transmits a fifth request signal for suppressing the transmission power of the eMBB signal to the second transmitting station 110B before transmitting the second URLLC signal (Step S263). When having received the fifth request signal, the second transmitting station 110B suppresses the transmission power of the eMBB signal (Step S264). As a result, the second transmitting station 110B can avoid signal interference to the second URLLC signal by suppressing the transmission power of the eMBB signal.

When the first URLLC signal has occurred (Step S265), the first transmitting station 110A transmits a fourth request signal for suppressing the transmission power of the eMBB signal to the fifth receiving station 120E before transmitting the first URLLC signal (Step S266). The fifth transmitting station 110E transmits the first URLLC signal to the fifth receiving station 120E (Step S267). That is, the fifth receiving station 120E is in a state where the fourth request signal and the first URLLC signal collide with each other. The fifth receiving station 120E compares the priority class of the first URLLC signal with the priority class of the second URLLC signal, and judges that the second URLLC signal has the higher priority class.

The fifth receiving station 120E transmits, to the fifth transmitting station 110E, a seventh request signal requesting the fifth transmitting station 110E to retransmit the second URLLC signal (Step S268). Furthermore, the fifth receiving station 120E transmits, to the first transmitting station 110A, a sixth request signal requesting the first transmitting station 110A to stop transmitting the first URLLC signal (Step S269). When having received the sixth request signal, the first transmitting station 110A stops transmitting the first URLLC signal based on the sixth request signal (Step S270). Furthermore, in response to the seventh request signal, the fifth transmitting station 110E transmits the second URLLC signal to the fifth receiving station 120E (Step S271).

Furthermore, after setting the transmission stop of the first URLLC signal, the first transmitting station 110A retransmits the fourth request signal to the second transmitting station 110B (Step S272). After retransmitting the fourth request signal to the second transmitting station 110B, the first transmitting station 110A transmits the first URLLC signal to the first receiving station 120A (Step S273).

When a collision occurs between the fourth request signal from the first transmitting station 110A and the second URLLC signal from the fifth transmitting station 110E, the fifth receiving station 120E of the twenty-third embodiment transmits, to the fifth transmitting station 110E, a seventh request signal requesting retransmission of the second URLLC signal. Furthermore, the fifth receiving station 120E transmits, to the first transmitting station 110A, a sixth request signal for stopping the transmission of the first URLLC signal. In response to the seventh request signal, the fifth transmitting station 110E transmits the second URLLC signal to the fifth receiving station 120E. As a result, the fifth receiving station 120E can receive the second URLLC signal from the fifth transmitting station 110E. Even in a case where there is an interfering station transmitting an interference signal, it is possible to generate a channel state capable of achieving desired transmission quality of a URLLC signal, leading to achievement of low-latency and high-reliability communication.

Furthermore, the first transmitting station 110A stops transmitting the first URLLC signal in response to the sixth request signal from the fifth receiving station 120E. After setting the transmission stop of the first URLLC signal, the first transmitting station 110A re-outputs the fourth request signal to the second transmitting station 110B, and transmits the first URLLC signal to the first receiving station 120A. As a result, even at the occurrence of collision between the fourth request signal from the first transmitting station 110A and the second URLLC signal from the fifth transmitting station 110E, it is possible to smoothly transmit the URLLC signals from the fifth transmitting station 110E and the first transmitting station 110A.

In the present embodiment, in a case where the URLLC signals have the same priority class, allowable latency levels are compared, and the processing operations of the twentieth, twenty-first, and twenty-third embodiments will be executed regarding the URLLC signal having a severe allowable latency level as a high priority signal. In a case where the priority class of the URLLC signal and the allowable latency levels are the same, the processing operations of the twentieth, twenty-first, and twenty-third embodiments are executed by utilizing the time stamp information of the request signal and the like and regarding the URLLC signal for which the signal has been generated earlier as a high priority. Furthermore, when the URLLC signals have the same priority class and same allowable latency levels, and when the time information of the signal such as the time stamp information cannot be used, the transmitting station of each URLLC signal generates a random number and determines the radio station to be regarded as a high priority station based on the generated random number. A method of generating a random number is specified in a standard, and is generated from information specific to each radio station in the standard, such as User ID, Association ID (AID), and STA ID.

<6-7. Mode of Protecting Own-Cell URLLC Signal from Neighboring Another-Cell eMBB Signal>

A modification in a case where an own-cell URLLC signal is protected from the eMBB signal of another cell will be described. It is assumed that the base station and another base station are connected by a backhaul link, and notification of request information to the another cell is transmitted using the backhaul link. The backhaul link is assumed to use a wired or wireless transmission link using a band not being used for transmission. The transmitting station of the URLLC signal requests other cells to suppress the transmission power of the eMBB signal so that the required transmission quality of the URLLC signal can be achieved via the backhaul link.

<6-7-1. Configuration and Operation of Twenty-Fourth Embodiment>

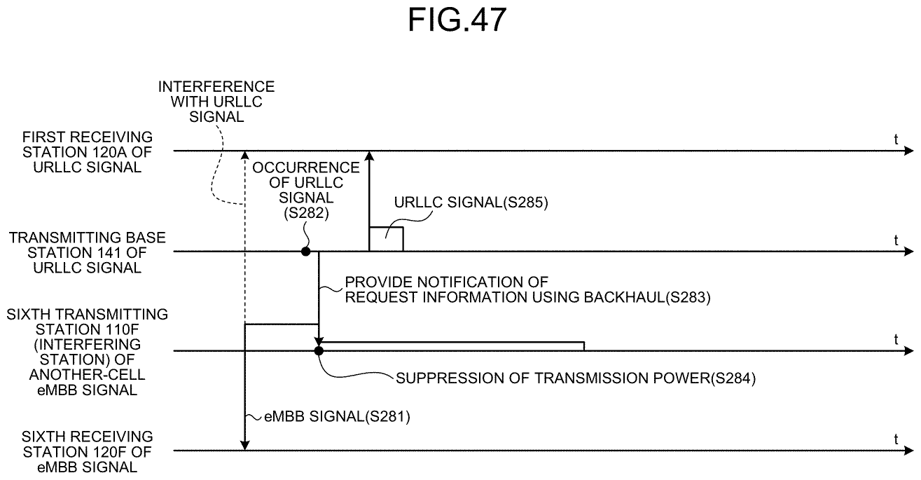

FIG. 47 is a diagram illustrating an example of URLLC signal protection processing according to a twenty-fourth embodiment of the present disclosure. In the URLLC signal protection processing of the twenty-fourth embodiment, the URLLC signal transmitting station is a base station, and a URLLC signal of an own-cell base station is protected from the eMBB signal of a neighboring another-cell base station. The communication system illustrated in FIG. 47 includes: a transmitting base station 141 that transmits a URLLC signal; a first receiving station 120A that receives a URLLC signal; a sixth transmitting station 110F that transmits an eMBB signal of another cell; and a sixth receiving station 120F that receives the eMBB signal from another cell. The transmitting base station 141 transmits the URLLC signal to the first receiving station 120A. Furthermore, an eighth transmitting station 110H is a base station that is in another cell and that transmits an eMBB signal to the sixth receiving station 120F. For convenience of description, the sixth transmitting station 110F is assumed to be an interfering station in which the eMBB signal interferes with the URLLC signal because of the eMBB signal being transmitted by the sixth transmitting station 110F.

The sixth transmitting station 110F transmits the eMBB signal to the sixth receiving station 120F (Step S281). At this time, for example, when the URLLC signal is transmitted from the transmitting base station 141 to the first receiving station 120A, the eMBB signal being transmitted is interfering with the URLLC signal, that is, causing a state of signal interference. When the URLLC signal has occurred (Step S282), the transmitting base station 141 transmits request information requesting suppression of the transmission power to the sixth transmitting station 110F by using a backhaul link before transmitting the URLLC signal (Step S283). When having received the request information, the sixth transmitting station 110F suppresses the transmission power of the eMBB signal based on the request information (Step S284). As a result, the transmitting base station 141 can avoid signal interference to the URLLC signal by suppressing the transmission power of the eMBB signal of the sixth transmitting station 110F. After outputting the request information, the transmitting base station 141 transmits the URLLC signal to the first receiving station 120A (Step S285). As a result, the first receiving station 120A can receive the URLLC signal by avoiding signal interference of the eMBB signal from the sixth transmitting station 110F.

In the twenty-fourth embodiment, the request information is transmitted from the transmitting base station 141 of the URLLC signal to the sixth transmitting station 110F of the eMBB signal in another cell in the identical band via the backhaul link, and accordingly, the sixth transmitting station 110F suppresses the transmission power of the eMBB signal in response to the request information. Next, the transmitting base station 141 transmits the URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

<6-7-2. Configuration and Operation of Twenty-Fifth Embodiment>

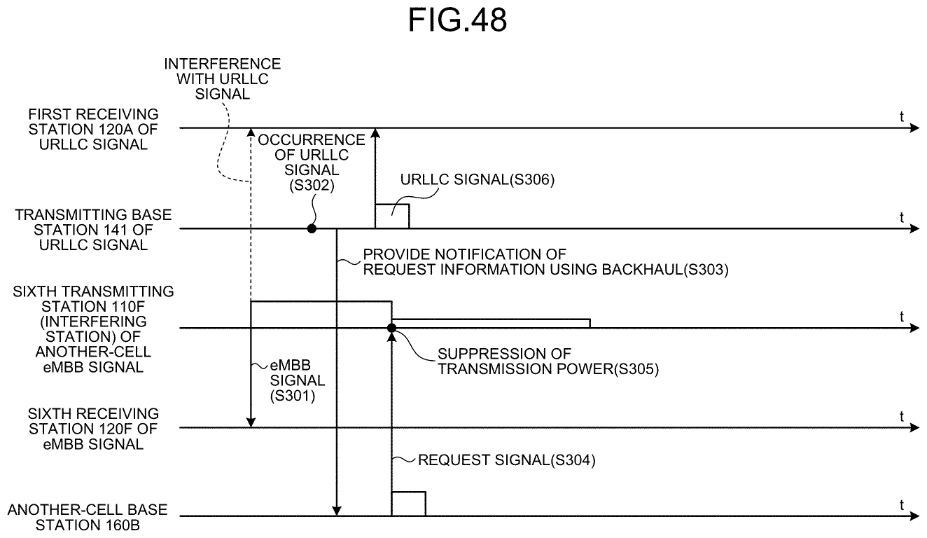

FIG. 48 is a diagram illustrating an example of URLLC signal protection processing according to a twenty-fifth embodiment of the present disclosure. In the URLLC signal protection processing of the twenty-fifth embodiment, the URLLC signal transmitting station is a base station, and a URLLC signal of an own-cell base station is protected from the eMBB signal of a radio station other than the neighboring another-cell base station. The communication system illustrated in FIG. 48 includes: a transmitting base station 141 that transmits a URLLC signal; a first receiving station 120A that receives a URLLC signal; a sixth transmitting station 110F that transmits an eMBB signal of another cell; a sixth receiving station 120F that receives the eMBB signal from another cell; and an another-cell base station 160B. The transmitting base station 141 is an own-cell base station that transmits a URLLC signal to the first receiving station 120A. Furthermore, the sixth transmitting station 110F is a radio station other than a base station and configured to transmit an eMBB signal to the sixth receiving station 120F. For convenience of description, the sixth transmitting station 110F is assumed to be an interfering station in which the eMBB signal interferes with the URLLC signal because of the eMBB signal being transmitted by the sixth transmitting station 110F. The another-cell base station 160B connects the sixth transmitting station 110F and the sixth receiving station 120F in the cell by using an access link, and connects to the transmitting base station 161 using a backhaul link.

The sixth transmitting station 110F transmits the eMBB signal to the sixth receiving station 120F (Step S301). At this time, for example, when the URLLC signal is transmitted from the transmitting base station 141 to the first receiving station 120A, the eMBB signal being transmitted is interfering with the URLLC signal, that is, causing a state of signal interference. When the URLLC signal has occurred (Step S302), the transmitting base station 141 transmits request information requesting suppression of the transmission power to the another-cell base station 160B by using a backhaul link before transmitting the URLLC signal (Step S303). When having received the request information from the transmitting base station 141, the another-cell base station 160B transmits a request signal for suppressing the transmission power of the another-cell sixth transmitting station 110F to the sixth transmitting station 110F (Step S304). The sixth transmitting station 110F suppresses the transmission power of the eMBB signal in response to the request signal (Step S305). As a result, the transmitting base station 141 can avoid signal interference to the URLLC signal by suppressing the transmission power of the eMBB signal of the sixth transmitting station 110F.

After outputting the request information, the transmitting base station 141 transmits the URLLC signal to the first receiving station 120A (Step S306). As a result, the first receiving station 120A can receive the URLLC signal by avoiding signal interference of the eMBB signal from the sixth transmitting station 110F.

In the twenty-fifth embodiment, the request information is output from the transmitting base station 141 of the URLLC signal in the own cell to the another-cell base station 160B via the backhaul link, and the request signal is transmitted from the another-cell base station 160B to the sixth transmitting station 110F. The sixth transmitting station 110F suppresses the transmission power of the eMBB signal in response to the request information. Next, the transmitting base station 141 transmits the URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

<6-7-3. Configuration and Operation of Twenty-Sixth Embodiment>

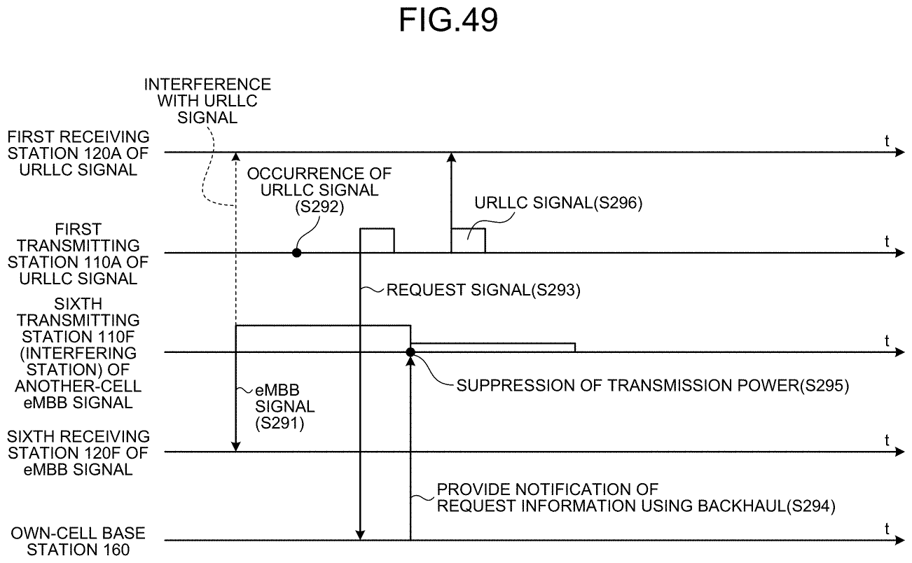

FIG. 49 is a diagram illustrating an example of URLLC signal protection processing according to a twenty-sixth embodiment of the present disclosure. In the URLLC signal protection processing of the twenty-sixth embodiment, it is assumed that the first transmitting station 110A of the URLLC signal is a radio station other than a base station and that a base station in a neighboring another cell is an interfering station. The communication system illustrated in FIG. 49 includes: a first transmitting station 110A that transmits a URLLC signal; a first receiving station 120A that receives a URLLC signal; a sixth transmitting station 110F that transmits an eMBB signal of another cell; a sixth receiving station 120F that receives the eMBB signal from another cell; and an own-cell base station 160. The first transmitting station 110A is a radio station other than a base station and configured to transmit a URLLC signal to the first receiving station 120A. Furthermore, the sixth transmitting station 110F is a base station that is in another cell and that transmits an eMBB signal to the sixth receiving station 120F. For convenience of description, the sixth transmitting station 110F is assumed to be an interfering station other than a base station and in which the eMBB signal interferes with the URLLC signal because of the eMBB signal being transmitted by the sixth transmitting station 110F. The own-cell base station 160 connects the first transmitting station 110A and the first receiving station 120A in the cell by using an access link, and connects to the sixth transmitting station 110F in another cell by using a backhaul link.

The sixth transmitting station 110F transmits the eMBB signal to the sixth receiving station 120F (Step S291). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S292), the first transmitting station 110A transmits a request signal for requesting suppression of transmission power to the own-cell base station 160 before transmitting the URLLC signal (Step S293). When having received the request signal from the first transmitting station 110A, the own-cell base station 160 transmits request information for suppressing the transmission power of the sixth transmitting station 110F in the another cell to the sixth transmitting station 110F in the another cell by using the backhaul link (Step S294). The sixth transmitting station 110F suppresses the transmission power of the eMBB signal in response to the request information (Step S295). As a result, the first transmitting station 110A can avoid signal interference to the URLLC signal by suppressing the transmission power of the eMBB signal of the sixth transmitting station 110F.

After outputting the request signal, the first transmitting station 110A transmits a URLLC signal to the first receiving station 120A (Step S296). As a result, the first receiving station 120A can receive the URLLC signal by avoiding signal interference of the eMBB signal from the sixth transmitting station 110F.

In the twenty-sixth embodiment, the request signal is transmitted from the first transmitting station 110A of the URLLC signal to the own-cell base station 160, and the request information is transmitted from the own-cell base station 160 to the sixth transmitting station 110F (interfering station) in another cell via the backhaul link. The sixth transmitting station 110F suppresses the transmission power of the eMBB signal in response to the request information. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

<6-7-4. Configuration and Operation of Twenty-Seventh Embodiment>

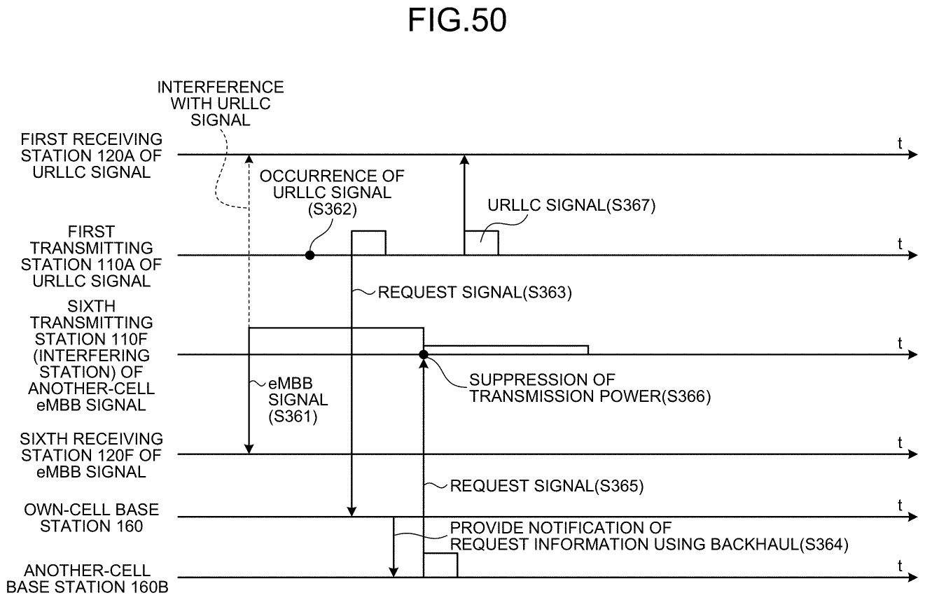

FIG. 50 is a diagram illustrating an example of URLLC signal protection processing according to a twenty-seventh embodiment of the present disclosure. In the URLLC signal protection processing of a twenty-ninth embodiment, it is assumed that the transmitting station of the URLLC signal is a radio station other than a base station and that a radio station other than a base station in a neighboring another cell is an interfering station. The communication system illustrated in FIG. 50 includes: a first transmitting station 110A that transmits a URLLC signal; a first receiving station 120A that receives a URLLC signal; a sixth transmitting station 110F that transmits an eMBB signal of another cell; a sixth receiving station 120F that receives the eMBB signal from another cell; an own-cell base station 160; and an another-cell base station 160B. The first transmitting station 110A is a radio station other than a base station and configured to transmit a URLLC signal to the first receiving station 120A. Furthermore, the sixth transmitting station 110F is a radio station other than a base station and configured to transmit an eMBB signal to the sixth receiving station 120F. For convenience of description, the sixth transmitting station 110F is assumed to be an interfering station in which the eMBB signal interferes with the URLLC signal because of the eMBB signal being transmitted by the sixth transmitting station 110F. The own-cell base station 160 connects the first transmitting station 110A and the first receiving station 120A in the cell by using an access link, and connects to the another-cell base station 160B by using a backhaul link. The another-cell base station 160B connects the sixth transmitting station 110F and the sixth receiving station 120F in the cell by using an access link, and connects to the own-cell base station 160 using a backhaul link.

The sixth transmitting station 110F transmits the eMBB signal to the sixth receiving station 120F (Step S361). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S362), the first transmitting station 110A transmits a request signal for requesting suppression of transmission power to the own-cell base station 160 before transmitting the URLLC signal (Step S363). When having received the request signal from the first transmitting station 110A, the own-cell base station 160 transmits request information for suppressing the transmission power of the sixth transmitting station 110F in the another cell to the another-cell base station 160B by using the backhaul link (Step S364).

When having received request information, the another-cell base station 160B transmits a request signal containing the request information to the sixth transmitting station 110F by using the access link (Step S365). When having received the request signal, the sixth transmitting station 110F suppresses the transmission power of the eMBB signal based on the request signal (Step S366). As a result, the first transmitting station 110A can avoid signal interference to the URLLC signal by suppressing the transmission power of the eMBB signal of the sixth transmitting station 110F.

After outputting the request signal, the first transmitting station 110A transmits a URLLC signal to the first receiving station 120A (Step S367). As a result, the first receiving station 120A can receive the URLLC signal by avoiding signal interference of the eMBB signal from the sixth transmitting station 110F.

In the twenty-seventh embodiment, the request signal is transmitted from the first transmitting station 110A of the URLLC signal to the own-cell base station 160, and the request information is transmitted from the own-cell base station 160 to the another-cell base station 160B via the backhaul link. The another-cell base station 160B transmits the request information to the sixth transmitting station 110F (interfering station), and the sixth transmitting station 110F suppresses the transmission power of the eMBB signal in response to the request information. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication. Even in a case where there is an interfering station transmitting an interference signal, it is possible to generate a channel state capable of achieving desired transmission quality of a URLLC signal, leading to achievement of low-latency and high-reliability communication.

<6-7-5. Configuration and Operation of Twenty-Eighth Embodiment>

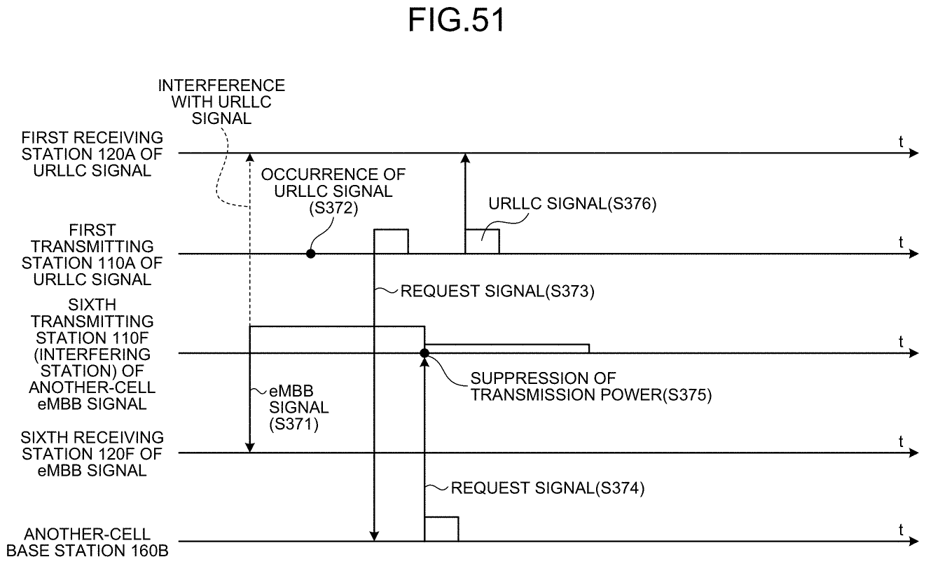

FIG. 51 is a diagram illustrating an example of URLLC signal protection processing according to a twenty-eighth embodiment of the present disclosure. The URLLC signal protection processing of the twenty-eighth embodiment assumes a case where the transmitting station of the URLLC signal is a radio station other than a base station, a radio station other than a base station in another neighboring cell is an interfering station, and the transmitting station of the URLLC signal directly transmits the request signal to the another-cell base station 160B. The communication system illustrated in FIG. 51 includes: a first transmitting station 110A that transmits a URLLC signal; a first receiving station 120A that receives a URLLC signal; a sixth transmitting station 110F that transmits an eMBB signal of another cell; a sixth receiving station 120F that receives the eMBB signal from another cell; and an another-cell base station 160B. The first transmitting station 110A is a radio station other than a base station and configured to transmit a URLLC signal to the first receiving station 120A. Furthermore, the sixth transmitting station 110F is a radio station other than a base station and configured to transmit an eMBB signal to the sixth receiving station 120F. For convenience of description, the sixth transmitting station 110F is assumed to be an interfering station in which the eMBB signal interferes with the URLLC signal because of the eMBB signal being transmitted by the sixth transmitting station 110F. The another-cell base station 160B connects the sixth transmitting station 110F and the sixth receiving station 120F in the cell by using an access link. The first transmitting station 110A can directly communicate with the another-cell base station 160B by using an access link.

The sixth transmitting station 110F transmits an eMBB signal to the sixth receiving station 120F (Step S371). At this time, for example, when the URLLC signal is transmitted from the first transmitting station 110A to the first receiving station 120A, the eMBB signal being transmitted is interfering with the URLLC signal, that is, causing a state of signal interference. When the URLLC signal has occurred (Step S372), the first transmitting station 110A transmits a request signal for requesting suppression of transmission power to the another-cell base station 160B before transmitting the URLLC signal (Step S373). When having received the request signal from the first transmitting station 110A, the another-cell base station 160B transmits the request signal to the sixth transmitting station 110F by using the access link (Step S374). When having received the request signal, the sixth transmitting station 110F suppresses the transmission power of the eMBB signal based on the request signal (Step S375). As a result, the first transmitting station 110A can avoid signal interference to the URLLC signal by suppressing the transmission power of the eMBB signal of the sixth transmitting station 110F.

After outputting the request signal, the first transmitting station 110A transmits a URLLC signal to the first receiving station 120A (Step S376). As a result, the first receiving station 120A can receive the URLLC signal by avoiding signal interference of the eMBB signal from the sixth transmitting station 110F.

In the twenty-eighth embodiment, the request signal is transmitted from the first transmitting station 110A of the URLLC signal to the another-cell base station 160B, the another-cell base station 160B transmits the request signal to the sixth transmitting station 110F (interfering station), and then the sixth transmitting station 110F suppresses the transmission power of the eMBB signal in response to the request signal. Subsequently, the first transmitting station 110A transmits a URLLC signal during the transmission power suppression of the eMBB signal. As a result, it is possible to avoid signal interference to the URLLC signal by the eMBB signal. Even in a case where there is an interfering station transmitting an interference signal, it is possible to generate a channel state capable of achieving desired transmission quality of a URLLC signal, leading to achievement of low-latency and high-reliability communication.

When the interfering station has been specified on the first transmitting station 110A side, the processing operations of the first, second, and twenty-eighth embodiments are to be executed. In addition, in a case where a cell having an interfering station is specified on the first transmitting station 110A side, the processing operations of the twenty-fourth, twenty-fifth, twenty-sixth, and twenty-seventh embodiments for transmitting a request signal using a backhaul link are to be executed.

In addition, in a case where even a cell having the interfering station cannot be specified on the first transmitting station 110A side, the processing operations of the twenty-fifth and twenty-sixth embodiments of transmitting the request signal to the own-cell base station that manages the first transmitting station 110 are to be executed. In this case, the own-cell base station can make an operation of inquiring the another-cell base station about the interfering station via the backhaul. When the interfering station cannot be specified, it is conceivable to perform an operation in which the URLLC signal broadcasts the request signal. This, however, leads to a possibility that many radio stations would perform unnecessary transmission power suppression.

Note that there is a technique of inter-cell interference coordination (ICIC) as a technique similar to <6-7. Mode of protecting own-cell URLLC signal from neighboring another-cell eMBB signal >. ICIC is a technology for improving a throughput at a cell edge by controlling an amount of inter-cell interference. The difference between the present embodiment and ICIC lies in information to be exchanged. ICIC exchanges various types of information, namely, relative narrowband Tx power (RNTP) and high interference indication (HII)) regarding radio resources having a possibility of giving a great amount of interference to neighboring cells, and information referred to as overload indication (0I)) providing notification that a specific radio resource has a great amount of interference.

In comparison, representative information different from the case of ICIC among the information exchanged in the present embodiment is URLLC signal priority class information, which is one type of QoS information. Based on the URLLC signal priority class information, ICIC can judge which one of the transmission signal of its own cell and the transmission signal of another cell is to be preferentially protected. This operation cannot be performed only with information exchanged in ICIC.

<6-8. Mode of Protecting URLLC Signal in Case of Transmitting Periodic URLLC Signal>

When the transmitting station of the URLLC signal periodically transmits a URLLC signal, the transmitting station transmits the request signal for periodic URLLC signal protection. At this time, transmission of the request signal can be performed at various timings such as before transmitting the URLLC signal.

Examples of possible transmission timings include: a timing of occurrence of traffic of a periodic URLLC signal; a timing of connection establishment to a control station of a terminal that transmits a periodic URLLC signal; periodic URLLC signal transmission timing; and timings of change in conditions such as transmission interval, a transmission band, a transmission frequency channel, a use radio resource, and a quantity of radio resources used for transmission.

<6-8-1. Configuration and Operation of Twenty-Ninth Embodiment>

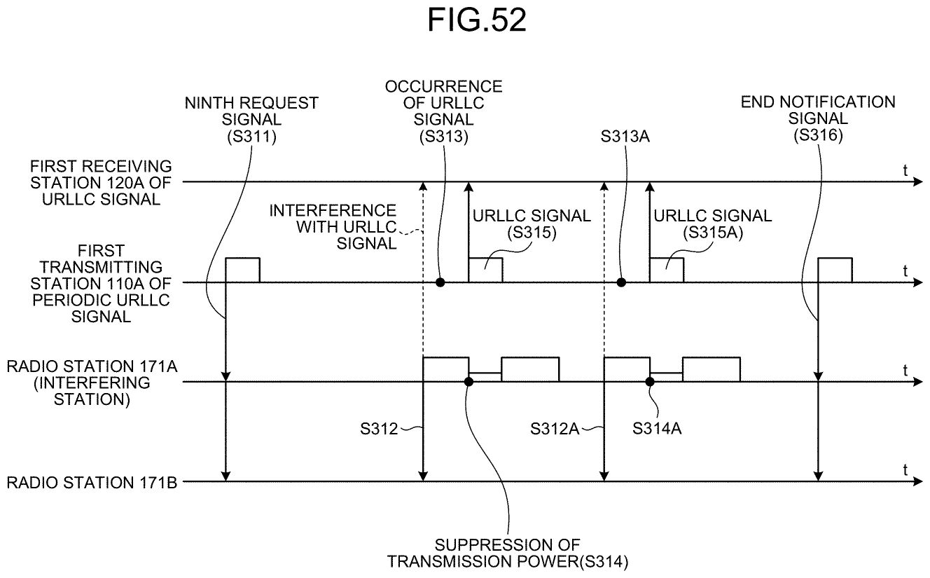

FIG. 52 is a diagram illustrating an example of URLLC signal protection processing according to the twenty-ninth embodiment of the present disclosure. The URLLC signal protection processing of the twenty-ninth embodiment assumes a case where a request signal is transmitted to a radio station at a starting timing of a periodic URLLC signal. The communication system illustrated in FIG. 52 includes: a first transmitting station 110A that transmits a URLLC signal; a first receiving station 120A that receives a URLLC signal; and a plurality of radio stations 171A and 171B that transmit and receive data signals. The first transmitting station 110A periodically transmits a URLLC signal to the first receiving station 120A. For example, during transmission of data signals, the radio station 171A is an interfering station by which the data signals causes signal interference with the URLLC signal.

When transmitting a periodic URLLC signal, the first transmitting station 110A transmits a ninth request signal containing a transmission section and a transmission cycle of the periodic URLLC signal to other stations, namely, the radio stations 171A and 171B (Step S311). Note that the first transmitting station 110A transmits the ninth request signal to the radio stations 171A and 171B by unicast, groupcast, or broadcast. When having received the ninth request signal, the other stations, namely, the radio stations 171A and 171B recognize the transmission section of the data signal for suppressing the transmission power based on the URLLC signal transmission section and the transmission cycle in the ninth request signal.

The radio station 171A transmits a data signal to the radio station 171B (Step S312). At this time, for example, when the URLLC signal is transmitted from the first transmitting station 110A to the first receiving station 120A, the data signal being transmitted is interfering with the URLLC signal, that is, causing a state of signal interference. Therefore, the radio station 171A suppresses the transmission power of the data signal according to the transmission section and the transmission cycle of the URLLC signal during transmission of the data signal (Step S314). The radio station 171A suppresses the transmission power of the data signal in the transmission section of the URLLC signal among the data signals being transmitted. As a result, it is possible to avoid signal interference to the URLLC signal by the data signal. Furthermore, when a periodic URLLC signal has occurred (Step S313), the first transmitting station 110A transmits the URLLC signal to the first receiving station 120A according to the transmission section and the transmission cycle of the URLLC signal (Step S315). That is, the first transmitting station 110A transmits the URLLC signal to the first receiving station 120A during suppression of the transmission power of the data signal.

In addition, the radio station 171A transmits the data signal to the radio station 171B (Step S312A), and suppresses the transmission power of the data signal according to the transmission section and the transmission cycle of the URLLC signal during transmission of the data signal (Step S314A). As a result, it is possible to avoid signal interference to the URLLC signal by the data signal. Subsequently, when a periodic URLLC signal has occurred (Step S313A), the first transmitting station 110A transmits the URLLC signal to the first receiving station 120A according to the transmission section and the transmission cycle of the URLLC signal (Step S315A). That is, the first transmitting station 110A transmits the URLLC signal to the first receiving station 120A during suppression of the transmission power of the data signal.

Next, the first transmitting station 110A transmits an end notification signal for ending the periodic transmission of the URLLC signal to each of the radio stations 171A and 171B (Step S316). Each of the radio stations 171A and 171B can recognize a completion timing of the periodic transmission of the URLLC signal from the first transmitting station 110A according to the end notification signal.

In the twenty-ninth embodiment, when periodically transmitting the URLLC signal to the first receiving station 120A according to the transmission section and the transmission cycle of the URLLC signal, the first transmitting station 110A transmits the ninth request signal to each of the radio stations 171A and 171B. In response to the ninth request signal, each of the radio stations 171A and 171B suppresses the transmission power of the data signal according to the transmission section and the transmission cycle of the URLLC signal. Subsequently, the first transmitting station 110A transmits a URLLC signal during suppression of the transmission power of the data signal. As a result, it is possible to avoid signal interference to the periodic URLLC signal by the data signal. Even in a case where there is an interfering station transmitting an interference signal, it is possible to generate a channel state capable of achieving desired transmission quality of a URLLC signal, leading to achievement of low-latency and high-reliability communication.

Furthermore, instead of transmitting the ninth request signal every transmission of the URLLC signal, the first transmitting station 110A transmits the ninth request signal at the time of starting a periodic URLLC signal, making it possible to reduce the overhead of the ninth request signal.

Each of the radio stations 171A and 171B recognizes a completion timing of the periodic transmission of the URLLC signal from the first transmitting station 110A according to the end notification signal from the first transmitting station 110A. As a result, it is possible to avoid a situation in which the radio stations other than the first transmitting station 110A continue the URLLC signal protection operation even after the end of periodic transmission of the URLLC signal.

<6-8-2. Configuration and Operation of Thirtieth Embodiment>

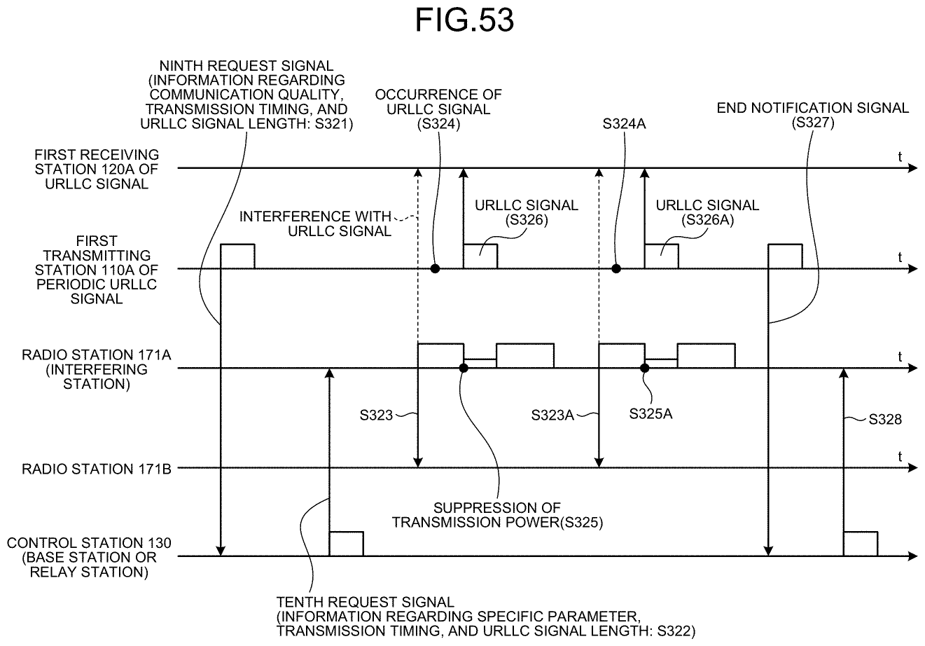

FIG. 53 is a diagram illustrating an example of URLLC signal protection processing according to a thirtieth embodiment of the present disclosure. The URLLC signal protection processing of the thirtieth embodiment assumes a case where a request signal is transmitted to the control station 130 at a starting timing of the periodic URLLC signal. The communication system illustrated in FIG. 53 includes: a first transmitting station 110A that transmits a URLLC signal; a first receiving station 120A that receives a URLLC signal; a plurality of radio stations 171A and 171B that transmit and receive data signals; and a control station 130. The first transmitting station 110A periodically transmits a URLLC signal to the first receiving station 120A. For example, during transmission of data signals, the radio station 171A is an interfering station by which the data signals causes signal interference with the URLLC signal. The control station 130 is, for example, a base station, a relay station, or the like connected to the first receiving station 120A, the first transmitting station 110A, and the plurality of radio stations 171A and 171B using an access link, for example.

When transmitting a periodic URLLC signal, the first transmitting station 110A transmits a ninth request signal containing a transmission section and a transmission cycle of the periodic URLLC signal to the control station 130 (Step S321). The ninth request signal includes information such as communication quality, and a transmission section and a transmission cycle such as a transmission timing, and the length, regarding the periodic URLLC signal.

When having received the ninth request signal, the control station 130 generates the transmission parameter of the data signal based on the communication quality in the ninth request signal such that a stable URLLC signal satisfies the QoS requirement. Note that examples of the transmission parameter of the data signal include information designating transmission power (including a true value of 0), modulation levels, and the coding rate, and/or information designating the beam direction. The control station 130 transmits a tenth request signal containing the transmission parameter of the data signal and the transmission section and the transmission cycle of the URLLC signal to the radio station 171A (Step S322). The control station 130 is assumed to transmit the tenth request signal to the radio station 171A by unicast, groupcast, or broadcast. When having received the tenth request signal, the radio station 171A recognizes the transmission section for suppressing the transmission power according to the transmission section and the transmission cycle of the URLLC signal in the tenth request signal and recognizes the transmission parameter of the data signal during the transmission section.

The radio station 171A transmits a data signal to the radio station 171B (Step S323). At this time, for example, when the URLLC signal is transmitted from the first transmitting station 110A to the first receiving station 120A, the data signal being transmitted is interfering with the URLLC signal, that is, causing a state of signal interference. Therefore, the radio station 171A suppresses the transmission power of the data signal according to the transmission section and the transmission cycle of the URLLC signal during transmission of the data signal (Step S325). The radio station 171A suppresses the transmission power of the data signal in the transmission section of the URLLC signal among the data signals being transmitted. As a result, it is possible to avoid signal interference to the URLLC signal by the data signal. Furthermore, when a periodic URLLC signal has occurred (Step S324), the first transmitting station 110A transmits the URLLC signal to the first receiving station 120A according to the transmission section and the transmission cycle of the URLLC signal (Step S326). That is, the first transmitting station 110A transmits the URLLC signal to the first receiving station 120A during suppression of the transmission power of the data signal.

In addition, the radio station 171A transmits the data signal to the radio station 171B (Step S323A), and suppresses the transmission power of the data signal according to the transmission section and the transmission cycle of the URLLC signal during transmission of the data signal (Step S325A). As a result, it is possible to avoid signal interference to the URLLC signal by the data signal. Subsequently, when a periodic URLLC signal has occurred (Step S324A), the first transmitting station 110A transmits the URLLC signal to the first receiving station 120A according to the transmission section and the transmission cycle of the URLLC signal (Step S326A). That is, the first transmitting station 110A transmits the URLLC signal to the first receiving station 120A during suppression of the transmission power of the data signal.

Subsequently, the first transmitting station 110A transmits, to the control station 130, an end notification signal indicating and end of the periodic transmission of the URLLC signal (Step S327). Furthermore, the control station 130 transmits an end notification signal to the radio station 171A (Step S328). The radio station 171A can recognize a completion timing of the periodic transmission of the URLLC signal from the first transmitting station 110A according to the end notification signal.

In the thirtieth embodiment, when periodically transmitting the URLLC signal to the first receiving station 120A according to the transmission section and the transmission cycle of the URLLC signal, the first transmitting station 110A transmits the ninth request signal to the control station 130. In response to the ninth request signal, the control station 130 transmits the tenth request signal to the radio station (interfering station) 171A. In response to the tenth request signal, the radio station 171A periodically suppresses the transmission power of the signal according to the transmission section and the transmission cycle of the URLLC signal. Subsequently, the first transmitting station 110A transmits a URLLC signal during suppression of the transmission power of the data signal. As a result, it is possible to avoid signal interference to the periodic URLLC signal by the data signal. Even in a case where there is an interfering station transmitting an interference signal, it is possible to generate a channel state capable of achieving desired transmission quality of a URLLC signal, leading to achievement of low-latency and high-reliability communication.

Furthermore, instead of transmitting the ninth request signal every transmission of the URLLC signal, the first transmitting station 110A transmits the ninth request signal at the time of starting a periodic URLLC signal, making it possible to reduce the overhead of the ninth request signal.

Each of the radio stations 171A and 171B recognizes the completion timing of the periodic transmission of the URLLC signal from the first transmitting station 110A according to the end notification signal from the control station 130. As a result, it is possible to avoid a situation in which the radio stations other than the first transmitting station 110A continue the URLLC signal protection operation even after the end of periodic transmission of the URLLC signal.

Although the above description is the case where the control station 130 transmits the tenth request signal to each radio station in response to the ninth request signal from the first transmitting station 110A, the control station 130 may judge the periodic URLLC transmission according to the reception cycle of the URLLC signal from the first transmitting station 110A even without reception of the ninth request signal, and may transmit the tenth request signal to the radio stations 171A and 171B that are subordinate terminals, and alterations are possible in this regard as appropriate.

<6-9. Mode of Setting URLLC Signal and Acknowledgement Signal as Protection Target>

The interfering station suppresses the transmission power of the interference signal according to the transmission section of the URLLC signal and the acknowledgement signal of the URLLC signal. The transmission timing of the acknowledgement signal of the URLLC signal and the length of the acknowledgement signal are calculated from the request signal. The acknowledgement signal of the URLLC signal is transmitted after the fixed time length from the URLLC signal, and thus, the length of the acknowledgement signal of the URLLC signal is determined according to the data length of the URLLC signal.

Furthermore, the data length of the URLLC signal is calculated from the QoS information of URLLC. Alternatively, information regarding the data length itself of the URLLC signal is stored in the request signal. In addition, the request signal also stores information regarding the length of the acknowledgement signal of the URLLC signal.

<6-9-1. Configuration and Operation of Thirty-First Embodiment>

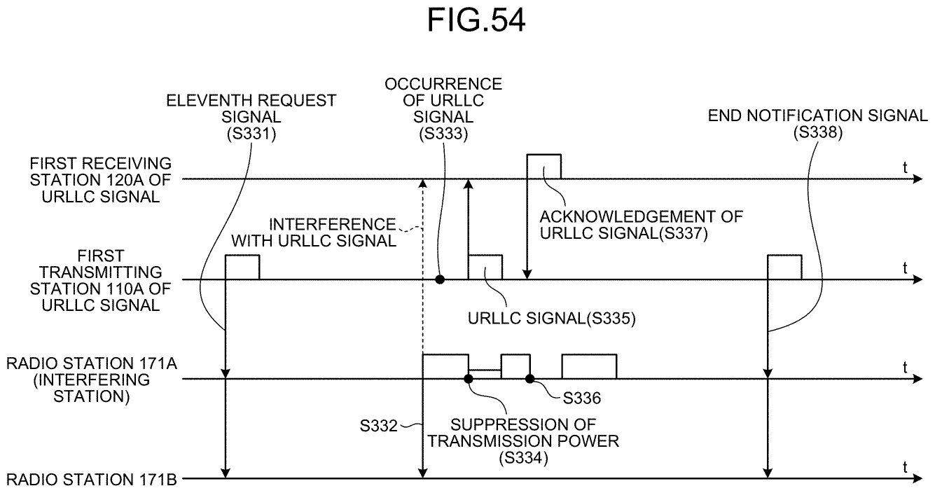

FIG. 54 is a diagram illustrating an example of URLLC signal protection processing according to a thirty-first embodiment of the present disclosure. In URLLC signal protection processing of the thirty-first embodiment assumes a case where the first transmitting station 110A directly transmits a request signal to the interfering station to protect the URLLC signal and the acknowledgement signal of the URLLC signal. The communication system illustrated in FIG. 54 includes: a first transmitting station 110A that transmits a URLLC signal; a first receiving station 120A that receives a URLLC signal; and a plurality of radio stations 171A and 171B that transmit and receive data signals. The first transmitting station 110A transmits a URLLC signal to the first receiving station 120A. For example, during transmission of data signals, the radio station 171A is an interfering station by which the data signals causes signal interference with the URLLC signal.

The first transmitting station 110A transmits an eleventh request signal containing a transmission section of the URLLC signal and the acknowledgement signal of the URLLC signal to each of the radio stations 171A and 171B in advance (Step S331). Note that the first transmitting station 110A transmits the eleventh request signal to the radio stations 171A and 171B by unicast, groupcast, or broadcast. The eleventh request signal includes information such as communication quality, and a transmission section such as a transmission timing, and the length, regarding the URLLC signal and the acknowledgement signal. In response to the eleventh request signal, each of the radio stations 171A and 171B recognizes a transmission section for suppressing the transmission power of the data signal according to the transmission section of the URLLC signal and the acknowledgement signal.

The radio station 171A transmits a data signal to the radio station 171B (Step S332). At this time, for example, when the URLLC signal is transmitted from the first transmitting station 110A to the first receiving station 120A, the data signal being transmitted is interfering with the URLLC signal, that is, causing a state of signal interference. When the URLLC signal has occurred (Step S333), the first transmitting station 110A transmits the URLLC signal to the first receiving station 120A according to the transmission section of the URLLC signal (Step S335). At this time, the radio station 171A suppresses the transmission power of the data signal according to the transmission section of the URLLC signal during transmission of the data signal (Step S334). As a result, it is possible to avoid signal interference to the URLLC signal by the data signal.

Furthermore, when having received the URLLC signal from the first transmitting station 110A, the first receiving station 120A transmits an acknowledgement signal corresponding to the URLLC signal to the first transmitting station 110A (Step S337). At this time, the radio station 171A suppresses the transmission power of the data signal according to the transmission section of the acknowledgement signal of the URLLC signal during transmission of the data signal (Step S336). As a result, it is possible to avoid signal interference to the acknowledgement signal of the URLLC signal due to the data signal.

Next, the first transmitting station 110A transmits an end notification signal for ending the transmission of the URLLC signal to each of the radio stations 171A and 171B (Step S338). Each of the radio stations 171A and 171B can recognize a completion timing of the transmission of the URLLC signal from the first transmitting station 110A according to the end notification signal.

In the thirty-first embodiment, before transmitting the URLLC signal to the first receiving station 120A according to the transmission section of the URLLC signal, the first transmitting station 110A transmits the eleventh request signal to each of the radio stations 171A and 171B. In response to the eleventh request signal, the radio station 171A periodically suppresses the transmission power of the data signal according to the transmission sections of the URLLC signal and the acknowledgement signals. Then, the first transmitting station 110A transmits the URLLC signal and receives the acknowledgement signal of the URLLC signal during the suppression of the transmission power of the data signal. As a result, it is possible to avoid signal interference to the periodic URLLC signal and the acknowledgement signal due to the data signal. Even in a case where there is an interfering station transmitting an interference signal, it is possible to generate a channel state capable of achieving desired transmission quality of a URLLC signal, leading to achievement of low-latency and high-reliability communication.

Furthermore, instead of transmitting the eleventh request signal every transmission of the URLLC signal, the first transmitting station 110A transmits the eleventh request signal at the time of starting a periodic URLLC signal, making it possible to reduce the overhead of the eleventh request signal.

Each of the radio stations 171A and 171B recognizes a completion timing of the transmission of the URLLC signal from the first transmitting station 110A according to the end notification signal from the first transmitting station 110A. As a result, it is possible to avoid a situation in which the radio stations other than the first transmitting station 110A continue the URLLC signal protection operation even after the end of transmission of the URLLC signal.

<6-9-2. Configuration and Operation of Thirty-Second Embodiment>

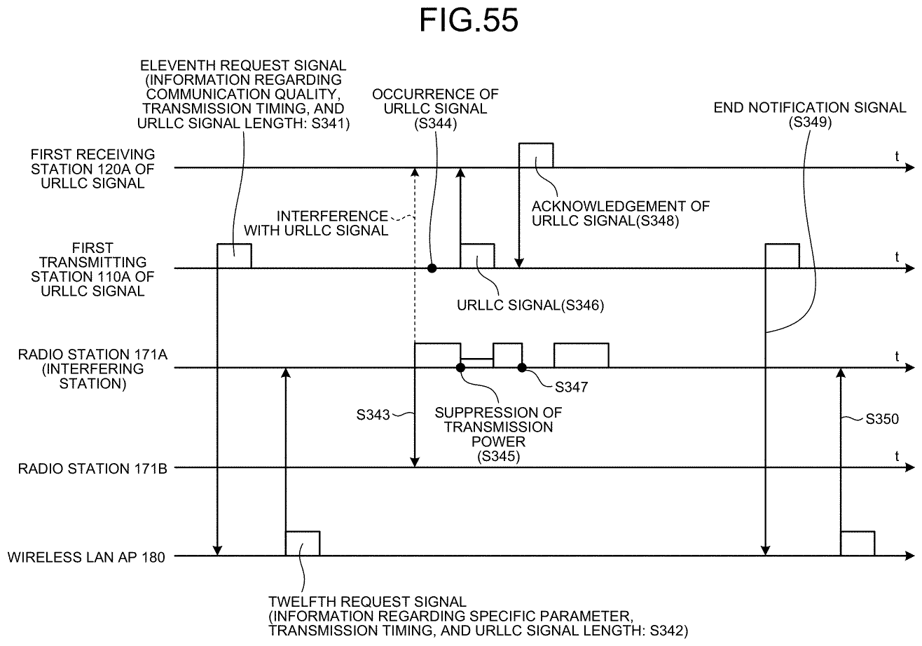

FIG. 55 is a diagram illustrating an example of URLLC signal protection processing according to a thirty-second embodiment of the present disclosure. In URLLC signal protection processing of the thirty-second embodiment assumes a case where the first transmitting station 110A transmits a request signal to the interfering station via an AP of wireless LAN to protect the URLLC signal and the acknowledgement signal of the URLLC signal. The communication system illustrated in FIG. 55 includes: a first transmitting station 110A that transmits a URLLC signal; a first receiving station 120A that receives a URLLC signal; a plurality of radio stations 171A and 171B that transmit and receive data signals; and a wireless access point (AP) 180. The first transmitting station 110A transmits a URLLC signal to the first receiving station 120A. For example, during transmission of data signals, the radio station 171A is an interfering station by which the data signals causes signal interference with the URLLC signal.

The wireless AP 180 is an AP in a wireless local area network (LAN). The wireless AP 180 connects, for example, radio communication between the first transmitting station 110A and the plurality of radio stations 171A and 171B using an access link.

The first transmitting station 110A transmits an eleventh request signal containing a transmission section of the URLLC signal and the acknowledgement signal of the URLLC signal to the wireless AP 180 in advance (Step S341). The eleventh request signal includes information such as communication quality, and a transmission section such as a transmission timing and the like regarding the URLLC signal and the acknowledgement signal. When having received the eleventh request signal, the wireless AP 180 transmits a twelfth request signal containing the transmission sections of the URLLC signal and the acknowledgement signal to the radio station 171A (Step S342).

The radio station 171A transmits a data signal to the radio station 171B (Step S343). At this time, for example, when the URLLC signal is transmitted from the first transmitting station 110A to the first receiving station 120A, the data signal being transmitted is interfering with the URLLC signal, that is, causing a state of signal interference. The radio station 171A recognizes the transmission sections of the URLLC signal and the acknowledgement signal in response to the twelfth request signal. When the URLLC signal has occurred (Step S344), the first transmitting station 110A transmits the URLLC signal to the first receiving station 120A according to the transmission section of the URLLC signal (Step S346). At this time, the radio station 171A suppresses the transmission power of the data signal according to the transmission section of the URLLC signal during transmission of the data signal (Step S345). As a result, it is possible to avoid signal interference to the URLLC signal by the data signal.

Furthermore, when having received the URLLC signal from the first transmitting station 110A, the first receiving station 120A transmits an acknowledgement signal corresponding to the URLLC signal to the first transmitting station 110A (Step S348). At this time, the radio station 171A suppresses the transmission power of the data signal according to the transmission section of the acknowledgement signal of the URLLC signal during transmission of the data signal (Step S347). As a result, it is possible to avoid signal interference to the acknowledgement signal of the URLLC signal due to the data signal.

Next, the first transmitting station 110A transmits an end notification signal indicating the end of the transmission of the URLLC signal to the wireless AP 180 (Step S349). The wireless AP 180 transmits an end notification signal to the radio station 171A (Step S350). The radio stations 171A can recognize a completion timing of the transmission of the URLLC signal from the first transmitting station 110A according to the end notification signal.

In the thirty-second embodiment, before transmitting the URLLC signal to the first receiving station 120A according to the transmission section of the URLLC signal, the first transmitting station 110A transmits the eleventh request signal to the wireless AP 180. In response to the eleventh request signal, the wireless AP 180 transmits the twelfth request signal to the radio station 171A. In response to the twelfth request signal, the radio station 171A suppresses the transmission power of the data signal according to the transmission sections of the URLLC signal and the acknowledgement signals. Then, the first transmitting station 110A transmits the URLLC signal and receives the acknowledgement signal of the URLLC signal during the suppression of the transmission power of the data signal. As a result, it is possible to avoid signal interference to the periodic URLLC signal and the acknowledgement signal due to the data signal. Even in a case where there is an interfering station transmitting an interference signal, it is possible to generate a channel state capable of achieving desired transmission quality of a URLLC signal, leading to achievement of low-latency and high-reliability communication.

Furthermore, instead of transmitting the eleventh and twelfth request signals every transmission of the URLLC signal, the first transmitting station 110A transmits the eleventh and twelfth request signals at the time of starting a periodic URLLC signal, making it possible to reduce the overhead of the eleventh and twelfth request signal.

Each of the radio stations 171A and 171B recognizes a completion timing of the transmission of the URLLC signal from the first transmitting station 110A according to the end notification signal from the first transmitting station 110A via the wireless AP 180. As a result, it is possible to avoid a situation in which the radio stations other than the first transmitting station 110A continue the URLLC signal protection operation even after the end of transmission of the URLLC signal.

<<7. Interference Signal>>

In response to the request signal, the interfering station suppresses transmission power in a part of a communication period of the interference signal in order to protect the URLLC signal against interference. Regarding an interference signal transmitted by the interfering station, a communication period, a signal length, and a data section configuration of the signal are determined on the assumption that suppression of transmission power is to be performed. For example, the signal transmitted by the interfering station stores the following information.

Examples of the information stored in the interference signal transmitted by the interfering station include: information indicating that there is a transmission power suppression portion for protecting the URLLC signal; information providing notification that the MCS is switched in the transmission power suppression portion; information indicating a procedure of dividing the signal before the transmission power suppression timing and restarting, after the URLLC signal and the acknowledgement for the URLLC signal, transmission of the remaining portion of the signal suspended from being transmitted; and information providing notification that zero-padding is to be performed on a portion where transmission power is to be suppressed.

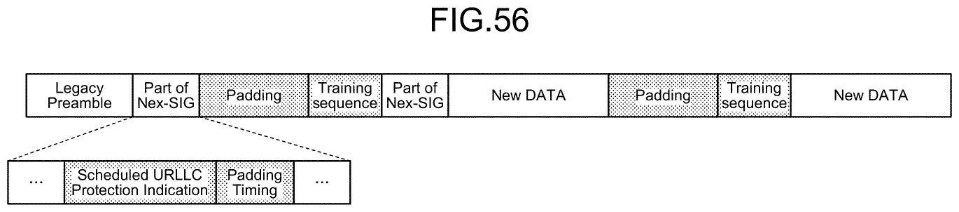

FIG. 56 is a diagram illustrating an example of a configuration of an interference signal in a case where padding is performed in a transmission power suppression portion. FIG. 56 illustrates a frame configuration of an interference signal in a case where zero-padding is performed on a transmission power suppression portion in an assumed WLAN network. In this case, in addition to zero-padding, there will be a training sequence added for time-frequency synchronization. By the training sequence, it is possible to grasp a transmission mode in such as varying transmission power of a signal addressed to its own station for URLLC signal protection performed by the receiving station of the interference signal, zero-padding, and divided transmission of the signal a plurality of times in one communication section, leading to implementation of an appropriate receiving operation.

<<8. Request Signal>>

<8-1. Specific example of request information>

A request signal stores request information. Specific examples of the request information include information indicating a request signal, information designating transmission power (including a true value of 0), a modulation level, and/or information designating the coding rate, information designating the beam direction, information regarding a requested communication quality of a URLLC signal, information regarding a radio resource usable for retransmitting a signal of an interfering station scheduled to be transmitted in advance when transmission is suspended, and ACK or NACK information from a non-interfering station.

Furthermore, the request information may include a transmission timing of the URLLC signal, a length of the URLLC signal, a transmission section used for transmission of the URLLC signal, and QoS information of the URLLC signal. Specifically, the QoS information of the URLLC signal is information such as a desired packet error rate, a desired latency or delay time, and a priority class of the URLLC signal.

The request information may be transmitted as scheduling information. As a specific example, the request information is recognized as the scheduling information of the URLLC signal in a predetermined radio station, while the scheduling information is recognized as request information in other radio stations.

Furthermore, the request information may be transmitted as ACK/NACK. As a specific example, the request information is recognized as ACK/NACK in a predetermined radio station, while ACK/NACK is recognized as request information in other radio stations.

The request information may be sent as channel state information (CSI). As a specific example, the request information is recognized as CSI in a predetermined radio station, while CSI is recognized as the request information in other radio stations.

<8-2. Specific Example of Request Signal Transmission Method>

The request signal is identified using bit information carried by the signal, a signal waveform type, or an orthogonal sequence. Examples of the bit information include information that specifies an index of a table of parameters determined in advance in a standard, specifically, information representing a numerical value of transmission power, and information specifying a relative value based on an RSSI of a received signal.

Examples of waveform include OFDM, Single Carrier, and DFT-spread OFDM. The transmitting station configured to transmit the request signal transmits a request signal by using a waveform different from the type of waveform used for ordinary data signal transmission. In addition, the transmitting station configured to transmit the request signal transmits the request signal using a subcarrier different from a specific subcarrier of the OFDM scheme used for ordinary data signal transmission. In addition, the transmitting station configured to transmit the request signal transmits the request signal using a spacing different from a subcarrier spacing used in ordinary data transmission.

The orthogonal sequence is generated from a pseudo-noise matrix. Specifically, there are an M-sequence, a Gold sequence, a Walsh sequence, a chaotic time series using a Chebyshev polynomial, and the like. At this time, the sequence length to be allocated may be determined according to the priority class of the URLLC signal. For example, when the transmitting station indicates request information for URLLC signal transmission with a high priority class, it is desirable to allocate a sequence with a long sequence length. By allocating a sequence of a long sequence length to request information of URLLC signal transmission with a high priority class, it is possible to increase a probability that the interfering station can detect the request information. This makes it possible to suppress the occurrence of signal interference to the URLLC signal having a high priority class due to a request signal detection failure.

The request signal can be transmitted by unicast, groupcast, or broadcast, for example.

Examples of the situation of transmitting the request signal by unicast include: a case of requesting suppression of transmission power to a predetermined interfering station; a case where a transmitting station configured to transmit the request signal can discriminate the interfering station and where the number of the interfering stations is single or small; a case where the transmitting station transmits the request signal to a control station; a case where the transmitting station transmits the request signal to a neighboring cell; and a case where information of a destination can be stored in the request signal. The case where the transmitting station can discriminate the interfering station is a case where the transmitting station can discriminate the interfering station based on ID information (User ID, AID, Cell ID, SS ID, SSID).

A case of transmitting the request signal by unicast is a case where the destination is identified by information specific to the radio station. As an example, the request signal includes information specific to the radio station. The interfering station to receive the request signal judges whether the request signal is information addressed to its own station based on information specific to the radio station included in the request signal. As an example, the request signal is scrambled by using information specific to the radio station. The interfering station to receive the request signal judges whether the request signal is information addressed to its own station based on the decoding result of the request signal. Examples of the information specific to the radio station include USER ID, AID, C-RNTI, and MAC address. An effect of transmitting the request signal by unicast is that interference control can be performed on a specific interfering station.

Examples of the situation of transmitting the request signal by groupcast include: a case of requesting suppression of transmission power to a predetermined interfering station group; a case where a transmitting station that transmits the request signal can discriminate an interfering station and there are a plurality of interfering stations; a case where candidates that can be interfering stations are grouped for each URLLC signal; a case where information of a plurality of destinations can be stored in the request signal; and a case where information of destinations of a group can be stored in the request signal.

A case of transmitting the request signal by groupcast is a case where the destination can be identified by information specific to the radio station group. As an example, the request signal includes information specific to the radio station group. The interfering station that receives the request signal judges whether the request signal is information addressed to its own station based on the information specific to the radio station group included in the request signal. As an example, the request information is scrambled using information specific to the radio station group. The interfering station to receive the request signal judges whether the request signal is information addressed to its own station based on a decoding result of the request signal. The information specific to the radio station group includes, for example, a group ID allocated at the time of grouping. Effect of transmitting the request signal by the groupcast are that interference control can be performed on a specific interfering station group without giving any influence of the interference control to a radio station other than the interfering station, and that control overheads are smaller than those of unicast in presence of a plurality of interfering stations.

Examples of the situation of transmitting the request signal by broadcast include: a case of requesting suppression of transmission power to all surrounding interfering stations; a case where the URLLC signal cannot be correctly received, and the request signal is transmitted in a form including NACK information as a part of the signal; a case where the transmitting station that transmits the request signal has difficulty in discriminating the interfering station; a case where information of a destination cannot be stored in the request signal; and a case where a destination of the request signal cannot be designated. The case where the destination of the request signal cannot be designated is an assumable case where a radio station of another system is an interfering station, for example.

A case of transmitting the request signal by broadcast is a case where the destination can be identified by information common to the radio stations. As an example, the request signal includes information common to the radio stations. As an example, the request signal is scrambled by using information common to the radio stations. For example, the information common to the radio stations includes Cell ID, BSS ID, broadcast MAC address, and a specific numeric string or character string defined in a standard. Effect of transmitting the request signal by broadcast are that interference control can be performed on all surrounding interfering stations, and that control overheads are smaller than those of unicast and broadcast in presence of a plurality of interfering stations.

<8-3. Request Signal for Communication System that Applies NR>

The request signal in the case of the communication system that applies NR is stored in, for example, downlink control information (DCI), uplink control information (UCI), or sidelink control information (SCI). The request signal requested from the base station to the base station or the terminal is stored in the DCI, for example. The request signal requested from the terminal to the base station is stored in the UCI, for example. The request signal requested from the terminal to the terminal is stored in the SCI, for example.

The DCI is carried in a physical downlink control channel (PDCCH). The UCI is carried on a physical uplink control channel (PUCCH). The SCI is carried in a physical sidelink control channel (PSCCH).

In a case where the request signal is included in the PDCCH and when the request signal is transmitted by groupcast or broadcast, the PDCCH is arranged in a common search space (CSS). In a case where the request signal is included in the PDCCH and when the request signal is transmitted by unicast, the PDCCH is arranged in a UE-specific search space (USS).

The request signal in NR may be control information including only request information or may be control information including information other than the request information. The information other than the request information is, for example, scheduling information of a URLLC signal, ACK/NACK, CSI, or the like.

Examples of the request signal in NR include fields such as Tx Power, MCS, Beam, URLLC Timing, and URLLC QoS. Note that fields other than Tx Power need not be included in URLLC Protection. Note that Tx Power represents information designating transmission power of the interfering station. For example, when transmission is to be suspended, Tx Power is set to “0”. MCS represents information related to a coding rate and a modulation level. Beam represents information designating the direction of the beam of the interfering station. URLLC QoS represents desired QoS information of the URLLC signal. Specifically, the URLLC QoS stores a desired packet error rate, a desired latency or delay time, priority class information regarding the URLLC signal, and the like. The priority class information regarding the URLLC signal is used to determine which URLLC signal is to be protected when URLLC signals are transmitted at the same timing.

<8-4. Request Signal in Case of Communication System that Applies WLAN>

In a wireless local area network (WLAN), signals containing control information are transmitted in the identical frequency band. Examples of the signal containing control information include Association request/response, Reassociation request/response, Probe request/response, beacon, Announcement traffic indication message (ATIM), Disassociation, acknowledgement (ACK), Block ACK request, Block ACK, Power Save (PS) poll, RTS, CTS, Contention Free (CF) End, and Trigger. In the WLAN, it is preferable that a control signal related to the URLLC signal including an acknowledgement signal for the URLLC signal is transmitted by using an identical radio resource.

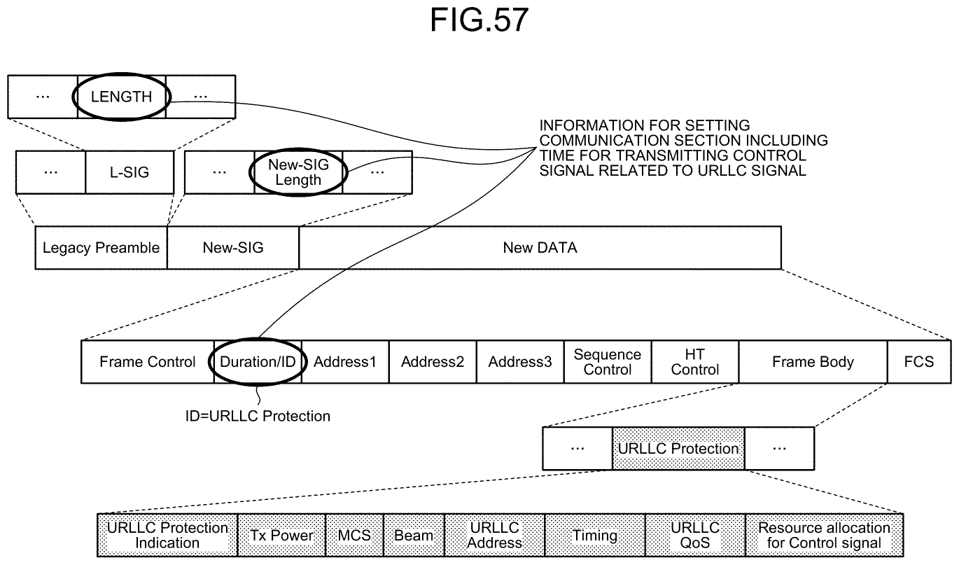

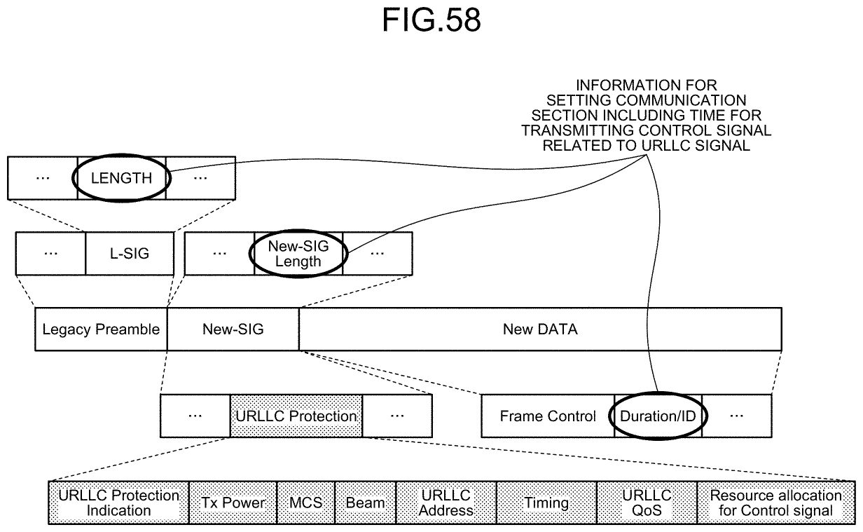

The request signal in the case of the communication system that applies WLAN is stored in a medium access control (MAC) frame or a physical header, for example. FIGS. 57 and 58 are diagrams each illustrating an example of a configuration of a MAC frame of a request signal. In the MAC frame of the request signal illustrated in FIG. 57, URLLC Protection is stored in a Frame Body in NEW DATA. In the MAC frame of the request signal illustrated in FIG. 58, URLLC Protection is stored in the NEW-SIG. URLLC Protection is information requesting suppression of transmission power. The Length, New-SIG Length, and Duration/ID illustrated in FIGS. 57 and 58 are information for setting a communication section including a time for transmitting a control signal related to the URLLC signal. Note that fields other than Tx Power need not be included in URLLC Protection. Tx Power is information designating transmission power of an interfering station. In a case of suspending the transmission, Tx Power is set to “0”. MCS is information related to a coding rate and a modulation level. Beam represents information designating the direction of the beam of the interfering station. URLLC Address is information related to an identifier of a radio station that transmits a URLLC signal. The URLLC Address is, for example, information for specifying the transmitting radio station of the original URLLC signal when the request signal is transmitted via the control station. URLLC Timing is information regarding a transmission timing of the URLLC signal, length of the URLLC signal, and a period used for transmission of the URLLC signal. Based on this information, the interfering station determines a transmission power suppression period and a timing of transmitting a control signal related to the URLLC signal.

URLLC QoS represents desired QoS information of the URLLC signal. Specifically, the URLLC QoS stores a desired packet error rate, a desired latency or delay time, priority class information regarding the URLLC signal, and the like. The priority class information regarding the URLLC signal is used to determine which URLLC signal is to be protected when URLLC signals are transmitted at the same timing. Resource allocation for Control Signal is information for providing notification of a resource, which is another resource for transmitting a control signal related to the URLLC signal.

<<9. Modifications>>

The above-described embodiment is an example, and various modifications and applications are possible.

In addition, for convenience of description, the URLLC signal has been exemplified as the protection target, and the eMBB signal are exemplified as the interference signal. However, the signals are not limited thereto, and the protection target may be any signal that requires low latency which is severer than the interference signal, and alterations are possible in this regard as appropriate.

The processing of suppressing signal interference does not have to be only the suppression of transmission power but may be the suspension of signal transmission, and alterations are possible in this regard as appropriate.

The control device that controls the management device 10, the base station device 20, the relay device 30, or the terminal device 40 of the present embodiment may be implemented by a dedicated computer system or a general-purpose computer system.

For example, a communication program for executing the above-described operations (for example, the transmission and reception processing) is stored in a computer-readable recording medium such as an optical disk, semiconductor memory, a magnetic tape, or a flexible disk and distributed. For example, the program is installed on a computer and the above processing is executed to achieve the configuration of the control device. At this time, the control device may be a device (for example, a personal computer) outside the base station device 20, the relay device 30, or the terminal device 40. Furthermore, the control device may be a device (for example, the control unit 23, the control unit 34, or the control unit 45) inside the base station device 20, the relay device 30, or the terminal device 40.

Furthermore, the communication program may be stored in a disk device included in a server device on a network such as the Internet so as to be able to be downloaded to a computer, for example. Furthermore, the functions described above may be realized by using operating system (OS) and application software in cooperation. In this case, the sections other than the OS may be stored in a medium for distribution, or the sections other than the OS may be stored in a server device so as to be downloaded to a computer, for example.

Furthermore, among individual processing described in the above embodiments, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of components of each device is provided as a functional and conceptional illustration and thus does not necessarily need to be physically configured as illustrated. That is, the specific form of distribution/integration of each of the devices is not limited to those illustrated in the drawings, and all or a part thereof may be functionally or physically distributed or integrated into arbitrary units according to various loads and use conditions.

Furthermore, the above-described embodiments can be appropriately combined within a range implementable without contradiction of processing. Furthermore, the order of individual steps illustrated in the flowchart or the sequence diagram of the present embodiment can be altered as appropriate.

Furthermore, for example, the present embodiment can be implemented as any configuration constituting a device or a system, for example, a processor as a large scale integration (LSI) or the like, a module using a plurality of processors or the like, a unit using a plurality of modules or the like, and a set obtained by further adding other functions to the unit, or the like (that is, a configuration of a part of the device).

In the present embodiment, a system represents a set of a plurality of components (devices, modules (components), or the like), and whether all the components are in the same housing would not be a big issue. Therefore, a plurality of devices housed in separate housings and connected via a network, and one device in which a plurality of modules are housed in one housing, are both systems.

Furthermore, for example, the present embodiment can adopt a configuration of cloud computing in which one function is cooperatively shared and processed by a plurality of devices via a network.

<<10. Conclusion>>

As described above, according to an embodiment of the present disclosure, when transmitting the second signal (for example, URLLC) requiring low latency severer than the first signal (for example, eMBB), the communication device notifies another communication device that transmits the first signal of a request signal containing information requesting suppression of transmission power of the first signal.

When transmitting the second signal, the communication device notifies another communication device (for example, an interfering station) that transmits the first signal of a request signal containing information requesting suppression of transmission power of the first signal. The another communication device suppresses the transmission power of the first signal in response to the request signal. This avoids the signal interference to the second signal from the first signal. Even in a case where there is an interfering station transmitting the first signal (interference signal), it is possible to generate a channel state capable of achieving desired transmission quality of a URLLC signal, leading to achievement of low-latency and high-reliability communication.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technology can also have the following configurations.

(1)

A communication device including:

a transmission unit that transmits a second signal requiring low latency severer than a first signal; and

a notification unit that notifies another communication device that transmits the first signal of a request signal containing information requesting suppression of transmission power of the first signal, the notification being made when the transmission unit transmits the second signal.

(2)

The communication device according to (1), further including

a detection unit that detects interference from the first signal toward the second signal,

wherein the notification unit

notifies the another communication device of the request signal when the detection unit has detected interference from the first signal toward the second signal.

(3)

The communication device according to (1),

wherein the notification unit

notifies the another communication device of the request signal containing information indicating information regarding communication quality related to the first signal.

(4)

The communication device according to (1),

wherein the notification unit

notifies the another communication device of the request signal containing information regarding a radio resource usable for retransmitting the first signal when the transmission power is suppressed.

(5)

The communication device according to (1),

wherein the information requesting suppression of transmission power of the first signal is

identified by bit information carried by the signal.

(6)

The communication device according to (1),

wherein the information requesting suppression of transmission power of the first signal is

identified in a signal format different from a signal format of a data signal.

(7)

The communication device according to (1),

wherein the information requesting suppression of transmission power of the first signal is

identified in an orthogonal sequence different from an orthogonal sequence of a data signal.

(8)

The communication device according to (1),

wherein the information requesting suppression of transmission power of the first signal is

information of setting a communication section including a transmission time related to a request for suppressing the transmission power for the another communication device and related to control of the second signal.

(9)

The communication device according to (8),

wherein the communication section includes a transmission section used for transmitting the second signal and a transmission section used for transmitting an acknowledgement signal corresponding to the second signal.

(10)

The communication device according to (8),

wherein the communication section includes

a transmission section used for transmitting an acknowledgement signal corresponding to the first signal transmitted by the another communication device having the transmission power suppressed.

(11)

The communication device according to (8),

wherein the communication section includes

a transmission section of a control signal transmitted by the another communication device having the transmission power suppressed.

(12)

The communication device according to (1),

wherein the information requesting suppression of transmission power of the first signal includes

information regarding a transmission timing and a transmission cycle of the second signal.

(13)

The communication device according to (1),

wherein, when the another communication device has received the request signal, the another communication device

changes and sets a transmission parameter of the first signal so as to ensure a predetermined communication quality of the second signal.

(14)

The communication device according to (13),

wherein the notification unit notifies the control station of the request signal, and

when the control station has received the request signal, the notification unit changes a transmission parameter of the first signal so as to ensure the predetermined communication quality of the second signal, and sets the changed transmission parameter in the another communication device.

(15)

The communication device according to (1),

wherein the notification unit transmits, to the another communication device, a signal providing notification of an end of transmission of the second signal that is periodically transmitted.

(16)

A communication device including:

a transmission unit that transmits a first signal; and

a control unit that suppresses transmission power of the first signal when having received a request signal containing information requesting suppression of transmission power of the first signal from another communication device that transmits a second signal requiring low latency severer than the first signal.

(17)

The communication device according to (16),

wherein the first signal includes

information indicating presence of a portion suppressing the transmission power.

(18)

The communication device according to (16),

wherein the first signal includes

information providing notification of switching of a Modulation and Coding Scheme (MCS) in a portion suppressing the transmission power.

(19)

The communication device according to (16),

wherein the first signal includes

information indicating suspension of transmission of the first signal before a timing of suppressing the transmission power, and indicating transmission of a remaining portion of the first signal that has been suspended in transmission, the transmission of the remaining portion of the first signal being performed after transmission of the second signal and an acknowledgement for the second signal.

(20)

The communication device according to (16),

wherein the first signal includes

information indicating that zero-padding is to be performed on a portion where the transmission power is to be suppressed.

(21)

A communication method executed by a communication device, the communication method including processing including:

transmitting a second signal requiring low latency severer than a first signal; and

notifying another communication device that transmits the first signal of a request signal containing information requesting suppression of transmission power of the first signal, the notification being made when the second signal is transmitted.

(22)

A communication program for causing a computer included in a communication device to function as:

a transmission unit that transmits a second signal requiring low latency severer than a first signal; and

a notification unit that notifies another communication device that transmits the first signal of a request signal containing information requesting suppression of transmission power of the first signal, the notification being made when the transmission unit transmits the second signal.

### REFERENCE SIGNS LIST

1 COMMUNICATION SYSTEM
10 MANAGEMENT DEVICE
20 BASE STATION DEVICE
30 RELAY DEVICE
40 TERMINAL DEVICE
231, 341, 451 TRANSMISSION UNIT
232, 342, 452 NOTIFICATION UNIT
233, 343, 453 DETECTION UNIT

1. A communication device including:
a transmission unit that transmits a second signal requiring low latency severer than a first signal; and
a notification unit that notifies another communication device that transmits the first signal of a request signal containing information requesting suppression of transmission power of the first signal, the notification being made when the transmission unit transmits the second signal.

2. The communication device according to claim 1, further including
a detection unit that detects interference from the first signal toward the second signal,
wherein the notification unit
notifies the another communication device of the request signal when the detection unit has detected interference from the first signal toward the second signal.

3. The communication device according to claim 1,
wherein the notification unit
notifies the another communication device of the request signal containing information indicating information regarding communication quality related to the first signal.

4. The communication device according to claim 1,
wherein the notification unit
notifies the another communication device of the request signal containing information regarding a radio resource usable for retransmitting the first signal when the transmission power is suppressed.

5. The communication device according to claim 1,
wherein the information requesting suppression of transmission power of the first signal is
identified by bit information carried by the signal.

6. The communication device according to claim 1,
wherein the information requesting suppression of transmission power of the first signal is
identified in a signal format different from a signal format of a data signal.

7. The communication device according to claim 1,
wherein the information requesting suppression of transmission power of the first signal is
identified in an orthogonal sequence different from an orthogonal sequence of a data signal.

8. The communication device according to claim 1,
wherein the information requesting suppression of transmission power of the first signal is
information of setting a communication section including a transmission time related to a request for suppressing the transmission power for the another communication device and related to control of the second signal.

9. The communication device according to claim 8,
wherein the communication section includes
a transmission section used for transmitting the second signal and a transmission section used for transmitting an acknowledgement signal corresponding to the second signal.

10. The communication device according to claim 8,
wherein the communication section includes
a transmission section used for transmitting an acknowledgement signal corresponding to the first signal transmitted by the another communication device having the transmission power suppressed.

11. The communication device according to claim 8,
wherein the communication section includes
a transmission section of a control signal transmitted by the another communication device having the transmission power suppressed.

12. The communication device according to claim 1,
wherein the information requesting suppression of transmission power of the first signal includes
information regarding a transmission timing and a transmission cycle of the second signal.

13. The communication device according to claim 1,
wherein, when the another communication device has received the request signal, the another communication device
changes and sets a transmission parameter of the first signal so as to ensure a predetermined communication quality of the second signal.

14. The communication device according to claim 13,
wherein the notification unit
notifies the control station of the request signal, and
when the control station has received the request signal, the notification unit changes a transmission parameter of the first signal so as to ensure the predetermined communication quality of the second signal, and sets the changed transmission parameter in the another communication device.

15. The communication device according to claim 1,
wherein the notification unit
transmits, to the another communication device, a signal providing notification of an end of transmission of the second signal that is periodically transmitted.

16. A communication device including:
a transmission unit that transmits a first signal; and
a control unit that suppresses transmission power of the first signal when having received a request signal containing information requesting suppression of transmission power of the first signal from another communication device that transmits a second signal requiring low latency severer than the first signal.

17. The communication device according to claim 16,
wherein the first signal includes
information indicating presence of a portion suppressing the transmission power.

18. The communication device according to claim 16,
wherein the first signal includes
information providing notification of switching of a Modulation and Coding Scheme (MCS) in a portion suppressing the transmission power.

19. The communication device according to claim 16,
wherein the first signal includes
information indicating suspension of transmission of the first signal before a timing of suppressing the transmission power, and indicating transmission of a remaining portion of the first signal that has been suspended in transmission, the transmission of the remaining portion of the first signal being performed after transmission of the second signal and an acknowledgement for the second signal.

20. The communication device according to claim 16,
wherein the first signal includes
information indicating that zero-padding is to be performed on a portion where the transmission power is to be suppressed.

21. A communication method executed by a communication device, the communication method including processing including:
transmitting a second signal requiring low latency severer than a first signal; and
notifying another communication device that transmits the first signal of a request signal containing information requesting suppression of transmission power of the first signal, the notification being made when the second signal is transmitted.

22. A communication program for causing a computer included in a communication device to function as:
a transmission unit that transmits a second signal requiring low latency severer than a first signal; and
a notification unit that notifies another communication device that transmits the first signal of a request signal containing information requesting suppression of transmission power of the first signal, the notification being made when the transmission unit transmits the second signal.
